(19) United States
(12) Patent Application Publication
(10) Pub. No.: US 2005/0102358 A1
(43) Pub. Date: May 12, 2005

(54) Web page monitoring and collaboration system

(76) Inventors: Stuart A. Gold, Paradise Valley, AZ (US); Bruce F. Damer, Boulder Creek, CA (US)

Correspondence Address: STONEMAN LAW OFFICES, LTD, 3113 NORTH 3RD STREET, PHOENIX, AZ, 85012, US

(21) Appl. No.: 10/985,392

(22) Filed: Nov. 9, 2004

Related U.S. Application Data
(60) Provisional application No. 60/519,008, filed on Nov. 10, 2003.
(60) Provisional application No. 60/617,262, filed on Oct. 7, 2004.

(51) Int. Cl. G06F 15/16

(52) U.S. Cl. 709/204

(57) ABSTRACT

This invention relates to providing a system for improved methods of promoting, forming and managing Internet-based communities on the Internet through and within standard web pages without requiring the installation of additional software on a user's computer or on web sites where the system is implemented by using the latest software tools, presentation techniques and Internet communication methods. Additionally, this invention provides real time monitoring of user counts to all visitors and web page owners when a page with the embedded URL is accessed. In particular, this invention permits web page visitors to initiate and participate in anonymous ad hoc chat sessions initiated from a selected web page. Additionally, this invention provides a web-based location which permits Internet users to join and participate in Internet-based communities and the related activities such as messaging other members, participating in member chat sessions and web resource sharing without the need to install software.

### CROSS-REFERENCE TO RELATED APPLICATIONS

The present application is related to and claims priority from prior provisional applications Ser. No. 60/519,008, filed Nov. 10, 2003, entitled “WEB PAGE MONITORING SYSTEM”, and Ser. No. 60/617,262, filed Oct. 07, 2004, entitled “WEB PAGE MONITORING AND COLLABORATION SYSTEM”, the contents of both of which are incorporated herein by this reference and are not admitted to be prior art with respect to the present invention by the mention in this cross-reference section.

### BACKGROUND

This invention relates to a system for providing methods for monitoring web page visits by users, communicating with and among users visiting a web page and for collaboration directly from a web page. The present invention also relates to providing a system for improved methods of promoting, forming and managing Internet-based virtual communities on the Internet without requiring installation of additional software on a user's computer or on web sites where the system is implemented by using the latest software tools, presentation techniques and Internet communication methods.

Currently, common use of the Internet is limited to information dissemination in the form of web pages, communication in the form of email, chat rooms and instant messaging and collaboration in the form of desktop and document sharing. A community, which can be defined as a group of people that share a common interest or goal, is currently achieved on the Internet mainly through the use of email lists, chat rooms and instant messaging. Today, a web site itself cannot generally be thought of as a medium for encouraging or maintaining a community, but is commonly employed for the dissemination of information only. Just as with other conventional forms of publishing such as print media, television and radio, the viewers, for the most part, are unaware of other people viewing the same piece of information at or around the same time. For example, a news program on television may have a million viewers all seeing and hearing the same information but will be completely unaware of each other. It cannot be said that a community has formed around the news feed or content of the program as the viewers have no awareness of each other or means to communicate. The same can be said for a web site or page where any number of people could be visiting at or around the same time.

The explosive diffusion of the Internet into countries such as the United States has been accompanied by the proliferation of Internet-based virtual communities. The nature of those communities and communications are rather diverse. Common examples of Internet-based communities include usenets, chat rooms and instant messaging.

Today, except for limited instances, Internet-based virtual communities rely on specific software being installed on each user's computer to provide access, communication and collaboration. Additionally, as the need for security and computer virus protection has increased on the Internet, opportunities for participation in Internet-based virtual communities have tended to become restricted.

The promise of an Internet-based virtual community which does not rely on installed software is that it can be accessed from any browser-equipped computer in the world, without installing anything or being concerned with firewalls or other network access issues.

Even though many Internet-based virtual communities of users are organized around a common interest or issue, they rely on a range of software products and tools to maintain the community. For example, a central web site may offer a variety of chat rooms for members with different interests, but little is provided to help organize and sustain the various communities. If the tools, such as member lists, are not maintained externally by the users, there is little opportunity to organize each Internet-based community beyond accessing the appropriate chat room at a set time each day.

Often, the need to communicate or collaborate is required at a point in time and regarding specific information provided by a web page. Visitors to that web page have no tools immediately available to provide them the opportunity to communicate or collaborate with others.

Thus, a great need exists for a system capable of improving methods of access, promoting, forming and managing Internet-based communities on the Internet.

### OBJECTS AND FEATURES OF THE INVENTION

A primary object and feature of the present invention is to provide a system to solve the above-mentioned needs. A primary object and feature of the present invention is the incorporation into a standard web page the means to indicate how many other visitors are currently viewing that web page or web site to all current visitors to that page or web site of which it is a part.

Additionally a primary object and feature of the present invention is to provide the means for each visitor to join a chat room with the other visitors and invoke other communication options that may be available including voice chat, streaming video and three-dimensional environments and any other Internet-based virtual communication technologies.

Another primary object and feature of the present invention is to enable a community to form around and within a standard web site or page. This is achieved by combining standard community-building functions with the functions of a standard web page being otherwise used for informational purposes only.

Further, it is a primary object and feature of the present invention to facilitate the fusion of community, communication and collaboration functions with informational content of a web page and therefore eliminate the need to navigate to another URL or download specific software in order to take advantage of those functions.

An additional primary object and feature of the present invention is to provide a method of linking specific information contained in a web page with particular interest areas and groups and consequently with specific visitor dialogue using text chat or any other communication medium encompassed by this system.

It is a further object and feature of the present invention to provide such a system to permit Internet-based virtual community members access to the Internet-based communities of interest without the installation of specialized software other than a web browser.

A further primary object and feature of the present invention is to provide such a system that permits presenting the number of visitors to selected pages of a web site and to support creation and participation in ad hoc, anonymous chat discussions by visitors using only a web browser.

It is a further object and feature of the present invention to provide a means for monitoring in real-time the number of visitors to selected pages of a web site by the operator of the web site. Additionally, it is an object and feature of the present invention to permit web site owners to create, monitor and participate in ad hoc anonymous chat discussions with the visitors using only a web browser.

It is still another object and feature of the present invention to provide a means for presenting all functional aspects of the present invention to web page visitors with on-screen tabs associated with the selected web page with insertion of a single reference line into the web page code.

It is yet another object and feature of the present invention to provide a means for controlling the behavior and content of the on-screen tabs through references to values and rules stored in a database.

Other objects and features of this invention will become apparent with reference to the following descriptions.

### SUMMARY OF THE INVENTION

In accordance with a preferred embodiment hereof, this invention provides an Internet system, relating to assisting participation in at least one Internet-based chat session between at least two users visiting at least one monitored web page of at least one monitored web site, comprising the steps of: embedding into such at least one monitored web page at least one universal resource locator address of at least one monitoring web site server; displaying at least one visual overlay web page from such at least one monitoring web site server on top of such at least one monitored web page; wherein such at least one visual overlay web page comprises at least one universal resource locator address of at least one Internet-based chat session; communicating to such at least one monitoring web site server from such at least one visual overlay web page presence of such at least one user visiting such at least one monitored web page; permitting each of such users visiting such at least one monitored web page to participate in such at least one Internet-based chat session; and communicating to such at least one monitoring web site server participation of each of such visiting users in such at least one Internet-based chat session. Moreover, it provides such an internet system wherein such at least one visual overlay web page further comprises at least one first count of such users visiting such at least one monitored web page. Additionally, it provides such a Internet system wherein such at least one visual overlay web page further comprises at least one second count of at least one subset (of such visiting users) participating in at such least one Internet-based chat session. Also, it provides such a Internet system wherein such at least one visual overlay web page further comprises at least one second count of at least one subset (of such visiting users) participating in at such least one Internet-based chat session. In addition, it provides such a Internet system further comprising the step of: communicating to such at least one visual overlay web page from such at least one monitoring web site server comprising such at least one first count of such users visiting such at least one monitored web page, and such at least one second count of at least one subset (of such visiting users) participating in at such least one Internet-based chat session. And, it provides such a Internet system, wherein the step of communicating to such at least one visual overlay web page from such at least one monitoring web site server further comprises at least one third count of such users visiting such at least one monitored web site. Further, it provides such a Internet system wherein the step of permitting each of such visiting users of such at least one monitored web page to participate in such at least one Internet-based chat session comprises the steps of: permitting each of such visiting users of such at least one monitored web page to activate such at least one Internet-based chat session; and permitting each of such visiting users of such at least one monitored web page not already joined in to join such at least one active Internet-based chat session. Even further, it provides such a Internet system further comprising the steps of: displaying at least one monitoring web page; and requiring at least one user-manger visiting such at least one monitoring web page to login as user-manager; permitting such at least one user-manager visiting such at least one monitoring web page to participate in such at least one Internet-based chat session. Moreover, it provides such a Internet system wherein such at least one monitoring web page is displayed from such at least one monitoring web site. Additionally, it provides such a Internet system wherein the step of permitting at least one user-manager visiting such at least one monitoring web page to participate in such at least one Internet-based chat session comprises the steps of: permitting such at least one user-manager visiting such at least one monitoring web page to activate such at least one Internet-based chat session; and permitting such at least one user-manager visiting such at least one monitoring web page to join such at least one active Internet-based chat session. Also, it provides such a Internet system further comprising the steps of: permitting each such at least one user joined in such at least one active Internet-based chat session to select text-based communications; and permitting each such at least one user-manager joined in such at least one active Internet-based chat session to select text-based communications. In addition, it provides such a Internet system further comprising the steps of: permitting each such at least one user joined in such at least one active Internet-based chat session to select voice-based communications; and permitting each such at least one user-manager joined in such least one active Internet-based chat session to select voice-based communications. And, it provides such a Internet system further comprising the steps of: accumulating a plurality of such communicated first counts of such users visiting such at least one monitored web page; and accumulating a plurality of such communicated second counts of such users participating in at such least one Internet-based chat session. Further, it provides such a Internet system wherein the step of accumulating a plurality of such communicated first counts of such users visiting such at least one monitored web page comprises the step of accumulating a plurality of all such communicated first counts of all such users visiting each such at least one monitored web page as such at least one third count of such users visiting such at least one monitored web site. Even further, it provides such a Internet system further comprising the steps of: automatically transmitting to such at least one monitoring web site server universal resource locator address of each such monitored web page of such at least one monitored web site containing such at least one universal resource locator address of such at least one monitoring web site server; preparing at least one hierarchical index of all such monitored web pages containing such at least one universal resource locator address of such at least one monitoring web site server; and presenting such at least one hierarchical index in such at least one visual overlay web page to such at least one user visiting such at least one monitored web page containing such at least one universal resource locator address of such at least one monitoring web site server. Moreover, it provides such a Internet system, wherein such at least one visual overlay web page further comprises: such at least one third count of such users visiting such at least one monitored web site; at least one universal resource locator address of at least one Internet-based chat session activated by such at least one user-manager; and at least one universal resource locator address of at least one web page of such at least one monitored web site. Additionally, it provides such a Internet system wherein such at least one Internet-based chat session activated by such at least one user-manager comprises at least one Internet-based chat session including at least one user visiting such at least one monitored web page. Also, it provides such a Internet system wherein such at least one visual overlay web page comprises at least one plurality of visual versions of at least one window each such visual version having different versions of content. In addition, it provides such a Internet system wherein such content comprises: at least one type of information; and at least one universal resource locator address of at least one other web page. And, it provides such a Internet system comprising the steps of: permitting selection of at least one such visual version of such at least one window within such at least one visual overlay web page for display on top of such at least one monitored web page; permitting selection of content to be displayed within each visual version of such at least one window within such at least one visual overlay web page to be displayed on top of such at least one monitored web page; permitting storing such selections in at least one data base on such at least one monitoring website server; obtaining such stored selections from such at least one data base related to displaying such selected content within each such visual version of such at least one window within such at least one visual overlay web page to be displayed on top of such at least one monitored web page. Further, it provides such a Internet system wherein such at least one type of information comprises at least two members selected from the set comprising: at least one first count of such users visiting such at least one monitored web page; at least one second count of at least one subset (of such users) engaged in at such least one Internet-based chat session; at least one third count of such users visiting such at least one monitored web site; and at least one hierarchical listing of such at least one monitored web page of such at least one monitored web site. Even further, it provides such a Internet system wherein such at least one at least one universal resource locator address of at least one other web page comprises at least two members selected from the set comprising: at least one universal resource locator address of least one other monitoring web page of such at least one monitoring web site; at least one universal resource locator address of such least one Internet-based chat session; at least one universal resource locator address of such least one Internet-based chat session activated by such at least one user-manager; and at least universal resource locator address of at least one archive web page containing text of at least one previous Internet-based chat session. Moreover, it provides such a Internet system further comprising the steps of: permitting selection of behaviors relating to each such at least one visual version of such at least one window within such at least one visual overlay web page; wherein such behaviors comprise at least four members selected from the set comprising momentarily expanding such at least one visual version of such at least one window within such at least one visual overlay page, permanently expanding such at least one visual version of such at least one window within such at least one visual overlay web page, minimizing such at least one visual version of such at least one window within such at least one visual overlay web page, placing such at least one visual version of such at least one window within such at least one visual overlay web page at a location within such at least one monitored web page, modifying text content of such at least one visual version of such at least one window within such at least one visual overlay web page, making such at least one visual version of such at least one window within such at least one visual overlay web page visible to such at least one user, making such at least one visual version of such at least one window within such at least one visual overlay web page invisible to such at least one user, producing a sound, changing at least one image within such at least one visual version of such at least one window within such at least one visual overlay web page, sending at least one message to such at least one user, sending at least one email to such at least one user, and sending at least one instant message to such at least one user. permitting storing such behavior selections in at least one data base on such at least one monitoring web site server; obtaining such stored behavior selections from such at least one data base related to performing such selected behaviors within such at least one visual version of such at least one window within at least one visual overlay web page displayed on top of such at least one monitored web page. Additionally, it provides such a Internet system further comprising the steps of: assisting registration on such at least one monitoring web site server of user profile data relating to such at least one of user visiting such at least one monitored web page to provide at least one registered user to provide at least one Internet-based virtual community; providing a plurality of Internet-based virtual community communication functions; wherein such plurality of Internet-based virtual community communication functions comprises reporting, in real time, to a such at least one registered user that at least one other registered user is logged in to such Internet system, permitting messaging between a plurality of such registered users, permitting conducting at least one virtual meeting between a plurality of such registered users, permitting creation of at least one personal directory of selected registered users by such at least one registered user, providing at least one directory of such registered users, and assisting recording of at least one universal resource locator address of at least one other web site by such at least one registered user; and assisting management of such at least one Internet-based virtual community by such at least one user-manager. Also, it provides such a Internet system further comprising the steps of: permitting such at least one user visiting such at least one monitored web page to input at least one message relating to such at least one monitored web page; permitting such at least one user visiting such at least one monitored web page to request information from such at least one user-manager of such at least one monitored web site; permitting such at least one user visiting such at least one monitored web page to view such at least one message left by at least one other user relating to such at least one monitored web page; permitting such at least one user visiting such at least one monitored web page to view at least one universal resource locator address inputted during at least one Internet-based chat session; and permitting such at least one user visiting such at least one monitored web page to view saved text of at least one Internet-based chat session. In addition, it provides such a Internet system according Claim 1 in which: no application software relating to such Internet system is required to be permanently resident on the computer of such at least one user; and no application software relating to such Internet system is required to be permanently resident on the computer of such at least one user-manager.

In accordance with another preferred embodiment hereof, this invention provides a computer system, relating to an Internet system, relating to assisting participation in at least one Internet-based chat session between at least two users visiting at least one monitored web page of at least one monitored web site, comprising: computer interface means relating to displaying at least one visual overlay web page from such at least one monitoring web site server on top of such at least one monitored web page; wherein such at least one visual overlay web page comprises at least one universal resource locator address of at least one Internet-based chat session; computer communication means relating to communicating to such at least one monitoring web site server from such at least one visual overlay web page presence of such at least one user visiting such at least one monitored web page; computer processor means relating to permitting each of such users visiting such at least one monitored web page to participate in such at least one Internet-based chat session; and computer communication means relating to communicating to such at least one monitoring web site server participation of each of such visiting users in such at least one Internet-based chat session. And, it provides such a computer system wherein such at least one visual overlay web page further comprises at least one first count of such users visiting such at least one monitored web page. Further, it provides such a computer system wherein such at least one visual overlay web page further comprises at least one second count of at least one subset (of such visiting users) participating in at such least one Internet-based chat session. Even further, it provides such a computer system wherein such at least one visual overlay web page further comprises at least one second count of at least one subset (of such visiting users) participating in at such least one Internet-based chat session. Moreover, it provides such a computer system further comprising: computer communication means relating to communicating to such at least one visual overlay web page from such at least one monitoring web site server comprising such at least one first count of such users visiting such at least one monitored web page, and such at least one second count of at least one subset (of such visiting users) participating in at such least one Internet-based chat session. Additionally, it provides such a computer system, wherein computer communication means relating to communicating to such at least one visual overlay web page from such at least one monitoring web site server further comprises at least one third count of such users visiting such at least one monitored web site. Also, it provides such a computer system wherein computer processor means relating to permitting each of such visiting users of such at least one monitored web page to participate in such at least one Internet-based chat session comprising: computer processor means relating to permitting each of such visiting users of such at least one monitored web page to activate such at least one Internet-based chat session; and computer processor means relating to permitting each of such visiting users of such at least one monitored web page not already joined in to join such at least one active Internet-based chat session. In addition, it provides such a computer system further comprising: computer interface means relating to displaying at least one monitoring web page; and computer processor means relating to requiring at least one user-manger visiting such at least one monitoring web page to login as user-manager; computer processor means relating to permitting such at least one user-manager visiting such at least one monitoring web page to participate in such at least one Internet-based chat session. And, it provides such a computer system wherein such at least one monitoring web page is displayed from such at least one monitoring web site. Further, it provides such a computer system wherein computer processor means relating to permitting at least one user-manager visiting such at least one monitoring web page to participate in such at least one Internet-based chat session further comprising: computer processor means relating to permitting such at least one user-manager visiting such at least one monitoring web page to activate such at least one Internet-based chat session; and computer processor means relating to permitting such at least one user-manager visiting such at least one monitoring web page to join such at least one active Internet-based chat session. Even further, it provides such a computer system further comprising: computer processor means relating to permitting each such at least one user joined in such at least one active Internet-based chat session to select text-based communications; and computer processor means relating to permitting each such at least one user-manager joined in such least one active Internet-based chat session to select text-based communications. Moreover, it provides such a computer system further comprising: computer processor means relating to permitting each such at least one user joined in such at least one active Internet-based chat session to select voice-based communications; and computer processor means relating to permitting each such at least one user-manager joined in such least one active Internet-based chat session to select voice-based communications. Additionally, it provides such a computer system further comprising: computer processor means relating to accumulating a plurality of such communicated first counts of such users visiting such at least one monitored web page; and computer processor means relating to accumulating a plurality of such communicated second counts of such users participating in at such least one Internet-based chat session. Also, it provides such a computer system wherein computer processor means relating to accumulating a plurality of such communicated first counts of such users visiting such at least one monitored web page comprises computer processor means relating to accumulating a plurality of all such communicated first counts of all such users visiting each such at least one monitored web page as such at least one third count of such users visiting such at least one monitored web site. In addition, it provides such a computer system further comprising: computer processor means relating to automatically transmitting to such at least one monitoring web site server universal resource locator address of each such monitored web page of such at least one monitored web site containing such at least one universal resource locator address of such at least one monitoring web site server; computer processor means relating to preparing at least one hierarchical index of all such monitored web pages containing such at least one universal resource locator address of such at least one monitoring web site server; and computer interface means relating to presenting such at least one hierarchical index in such at least one visual overlay web page to such at least one user visiting such at least one monitored web page containing such at least one universal resource locator address of such at least one monitoring web site server. And, it provides such a computer system, wherein such at least one visual overlay web page further comprises: such at least one third count of such users visiting such at least one monitored web site; at least one universal resource locator address of at least one Internet-based chat session activated by such at least one user-manager; and at least one universal resource locator address of at least one web page of such at least one monitored web site. Further, it provides such a computer system wherein such at least one Internet-based chat session activated by such at least one user-manager comprises such at least one Internet-based chat session including at least one user visiting such at least one monitored web page. Even further, it provides such a computer system wherein such at least one visual overlay web page comprises at least one plurality of visual versions of at least one window each such visual version having different versions of content. Moreover, it provides such a computer system wherein such content comprises: at least one type of information; and at least one universal resource locator address of at least one other web page. Additionally, it provides such a computer system comprising: computer processor means relating to permitting selection of at least one such visual version of such at least one window within such at least one visual overlay web page for display on top of such at least one monitored web page; computer processor means relating to permitting selection of content to be displayed within each visual version of such at least one window within such at least one visual overlay web page to be displayed on top of such at least one monitored web page; computer storage means relating to storing such selections in at least one data base on such at least one monitoring website server; computer processor means relating to obtaining such stored selections from such at least one data base related to displaying such selected content within each such visual version of such at least one window within such at least one visual overlay web page to be displayed on top of such at least one monitored web page. Also, it provides such a computer system wherein such at least one type of information comprises at least two members selected from the set comprising: at least one first count of such users visiting such at least one monitored web page; at least one second count of at least one subset (of such users) engaged in at such least one Internet-based chat session; at least one third count of such users visiting such at least one monitored web site; and at least one hierarchical listing of such at least one monitored web page of such at least one monitored web site. In addition, it provides such a computer system wherein such at least one at least one universal resource locator address of at least one other web page comprises at least two members selected from the set comprising: at least one universal resource locator address of least one other monitoring web page of such at least one monitoring web site; at least one universal resource locator address of such least one Internet-based chat session; at least one universal resource locator address of such least one Internet-based chat session activated by such at least one user-manager; and at least universal resource locator address of at least one archive web page containing text of at least one previous Internet-based chat session. And, it provides such a computer system further comprising the steps of: computer processor means relating to permitting selection of behaviors relating to each such at least one visual version of such at least one window within such at least one visual overlay web page; wherein such content comprises at least four members selected from the set comprising momentarily expanding such at least one visual version of such at least one window within such at least one visual overlay page, permanently expanding such at least one visual version of such at least one window within such at least one visual overlay web page, minimizing such at least one visual version of such at least one window within such at least one visual overlay web page, placing such at least one visual version of such at least one window within such at least one visual overlay web page at a location within such at least one monitored web page, modifying text content of such at least one visual version of such at least one window within such at least one visual overlay web page, making such at least one visual version of such at least one window within such at least one visual overlay web page visible to such at least one user, making such at least one visual version of such at least one window within such at least one visual overlay web page invisible to such at least one user, producing a sound, changing at least one image within such at least one visual version of such at least one window within such at least one visual overlay web page, sending at least one message to such at least one user, sending at least one email to such at least one user, and sending at least one instant message to such at least one user; computer processor means relating to permitting storing such behavior selections in at least one data base on such at least one monitoring website server; computer processor means relating to obtaining such stored behavior selections from such at least one data base related to performing such selected behaviors within such at least one visual version of such at least one window within at least one visual overlay web page displayed on top of such at least one monitored web page. Further, it provides such a computer system further comprising the steps of: computer processor means relating to assisting registration of user profile data relating to such at least one of user visiting such at least one monitored web page to provide at least one registered user to provide at least one Internet-based virtual community; computer processor means relating to providing a plurality of Internet-based virtual community communication functions; wherein such plurality of Internet-based virtual community communication functions comprises computer processor means relating to reporting, in real time, to a such at least one registered user that at least one other registered user is logged in to such Internet system, computer processor means relating to permitting messaging between a plurality of such registered users, computer processor means relating to permitting conducting at least one virtual meeting between a plurality of such registered users, computer processor means relating to permitting creation of at least one personal directory of selected registered users by such at least one registered user, computer processor means relating to providing at least one directory of such registered users, and computer processor means relating to assisting recording of at least one universal resource locator address of at least one other web site by such at least one registered user; and computer processor means relating to assisting management of such at least one Internet-based virtual community by such at least one user-manager. Even further, it provides such a computer system further comprising: computer processor means relating to permitting such at least one user visiting such at least one monitored web page to input at least one message relating to such at least one monitored web page; computer processor means relating to permitting such at least one user visiting such at least one monitored web page to request information from such at least one user-manager of such at least one monitored web site; computer processor means relating to permitting such at least one user visiting such at least one monitored web page to view such at least one message left by at least one other user relating to such at least one monitored web page; computer processor means relating to permitting such at least one user visiting such at least one monitored web page to view at least one universal resource locator address inputted during at least one Internet-based chat session; and computer processor means relating to permitting such at least one user visiting such at least one monitored web page to view saved text of at least one Internet-based chat session. Moreover, it provides such a computer system according Claim 27 in which: no application software relating to such Internet system is required to be permanently resident on the computer of such at least one user; and no application software relating to such Internet system is required to be permanently resident on the computer of such at least one user-manager.

In accordance with another preferred embodiment hereof, this invention provides an Internet system, relating to assisting at least one plurality of users having at least one common interest to provide at least one Internet-based virtual community, comprising the steps of: assisting registration of user profile data relating to at least one of such plurality of users to provide at least one registered user; providing at least one plurality of Internet-based virtual community communication functions; wherein such at least one plurality of Internet-based virtual community communication functions comprises reporting, in real time, to a such at least one registered user that at least one other registered user is logged in to such Internet system, facilitating conducting at least one Internet-based chat session between a plurality of such registered users, facilitating messaging between a plurality of such registered users, facilitating conducting at least one virtual meeting between a plurality of such registered users, assisting recording at least one web site universal resource locator address by such at least one registered user, providing at least one directory of such registered users, and providing at least one Internet-based virtual community hierarchical control structure; assisting establishing at least one subject hierarchy, using such at least one Internet-based virtual community hierarchical control structure, relating to such at least one Internet-based virtual community by at least one registered user; and assisting management of such at least one Internet-based virtual community by at least one registered user. Additionally, it provides such a Internet system, wherein the step of assisting management of such at least one Internet-based virtual community by at least one registered user comprises the steps of: assigning at least one role of a plurality of user roles to each such at least one registered user within such at least one Internet-based virtual community; wherein such plurality of user roles comprises at least one member role in which such at least one registered user may utilize all such Internet-based virtual community communication functions, and at least one caretaker role in which such at least one registered user may manage changes within such at least one Internet-based virtual community wherein such at least one caretaker role comprises approving addition of at least one sub-community, within such at least one Internet-based virtual community, and approving addition of at least one web site universal resource locator address within such at least one Internet-based virtual community. Also, it provides such a Internet system further comprising the step of facilitating participation, as a guest, in at least one other such Internet-based virtual community by such at least one registered user. In addition, it provides such a Internet system further comprising the step of facilitating creation of at least one personal directory of selected registered users by such at least one registered user. And, it provides such a Internet system further comprising the step of facilitating optionally recording the content of at least one such at least one virtual meeting. Further, it provides such a Internet system, wherein the step of facilitating conducting such at least one virtual meeting between such plurality of such registered users comprises the steps of; permitting designation of such at least one virtual meeting as closed to uninvited other such registered users; permitting invitation of at least one other such registered user to such at least one closed virtual meeting by such at least one registered user; permitting such at least one invited registered user to join such at least one closed virtual meeting; and facilitating conducting such at least one closed virtual meeting between a plurality of invited such registered users. Even further, it provides such a Internet system further comprising the steps of: permitting designation of at least one such virtual meeting as open to uninvited other such registered users; permitting such uninvited other registered users to join such at least one open virtual meeting without invitation; permitting invitation of at least one other such uninvited registered user to such at least one open virtual meeting by such at least one uninvited registered user; permitting such at least one other uninvited registered user to join such at least one open virtual meeting; and facilitating conducting such at least one open virtual meeting between a plurality of uninvited such registered users. Moreover, it provides such a Internet system further comprising the steps of; inserting into at least one monitored web page at least one universal resource locator address of at least one monitoring web site server; displaying at least one web page frame from such at least one monitoring web site server on such at least one monitored web page; wherein such at least one web page frame comprises at least one first count of at least two users visiting such at least one monitored web page, at least one second count of at least one subset (of such at least two users) engaged in at such least one Internet-based chat session, and at least one universal resource locator address of such least one Internet-based chat session; communicating to such at least one monitoring web site server from such at least one web page frame presence of such at least one user on such at least one monitored web page; communicating to such at least one web page frame from such at least one monitoring web site server such at least one first count of such at least two users visiting such at least one monitored web page, and such at least one second count of at least one subset (of such at least two users) engaged in such at least one Internet-based chat session; permitting each of such at least two users of such at least one monitored web page to activate such at least one Internet-based chat session; permitting each of such at least two users of such at least one monitored web page not already joined in to join such at least one active Internet-based chat session; and permitting recording of at least one universal resource locator address of such at least one monitoring web site server as at least one resource in such at least one Internet-based virtual community. Additionally, it provides such a Internet system further comprising the steps of: displaying such at least one monitoring web page frame on such at least one monitored web page; permitting such at least one user of such at least one monitoring web site to activate such at least one Internet-based chat session; and permitting such at least one user of such at least one monitoring web site to join such at least one active Internet-based chat session. Also, it provides such a Internet system further comprising the steps of: permitting each such at least one user of such at least one monitored web page joined in such at least one active Internet-based chat session to select text-based communications; and permitting each such at least one user-manager of such at least one monitoring site joined in such at least one active Internet-based chat session to select text-based communications. In addition, it provides such a Internet system further comprising the steps of: permitting each such at least one user of such at least one monitored web page joined in such least one active Internet-based chat session to select voice-based communications; and permitting each such at least one user-manager of such at least one monitoring site joined in at such least one active Internet-based chat session to select voice-based communications. And, it provides such a Internet system further comprising the steps of: accumulating a plurality of such communicated first counts of users visiting such at least one monitored web page; and accumulating a plurality of such communicated second counts of such users engaged in at such least one Internet-based chat session. Further, it provides such a Internet system further comprising the steps of; automatically transmitting to such at least one monitoring web site server universal resource locator address of each such web page of such at least one monitored web site containing such at least one site universal resource locator address of such at least one monitoring web site server; preparing at least one hierarchical index of all web pages containing such at least one site universal resource locator address of such at least one monitored web site; and presenting such at least one hierarchical index in such at least one web page frame to such at least one user visiting such at least one web pages containing such at least one site universal resource locator address of such at least one monitoring web site server. Even further, it provides such a Internet system further comprising the steps of: assisting use of avatars to identify each such at least one registered user; assisting use of avatars to identify each such at least one user of such at least one monitored web site; assisting use of images to identify each such at least one registered user, assisting use of images to identify each such at least one user of such at least one monitored web site; assisting use of three-dimensional images to identify each such at least one registered user, assisting use of three-dimensional images to identify each such at least one user of such at least one monitoring web site; and assisting combining such at least one virtual meeting with at least one three-dimensional interactive stage set.

In accordance with another preferred embodiment hereof, this invention provides an Internet system relating to assisting at least one plurality of users having at least one common interest to provide at least one Internet-based virtual community, comprising: computer interface means relating to assisting registration of user profile data relating to at least one of such plurality of users to provide at least one registered user; computer processor means relating to providing at least one plurality of Internet-based virtual community communication functions; wherein such at least one plurality of Internet-based virtual community communication functions comprises: computer processor means relating to reporting, in real time, to a such at least one registered user that at least one other registered user is logged in to such Internet system, computer processor means relating to facilitating messaging between a plurality of such registered users, computer processor means relating to facilitating conducting at least one virtual meeting between a plurality of such registered users, computer storage means relating to assisting recording at least one web site universal resource locator address by such at least one registered user, computer processor means relating to providing at least one directory of such registered users, and computer processor means relating to providing at least one virtual community hierarchical control structure; computer processor means relating to assisting establishing at least one subject hierarchy, using such at least one Internet-based virtual community hierarchical control structure, relating to such at least one Internet-based virtual community by at least one registered user; and computer processor means relating to assisting management of such at least one Internet-based virtual community by at least one registered user. Moreover, it provides such a Internet system, wherein computer processor means relating to assisting management of such at least one Internet-based virtual community by at least one registered user comprises: computer processor means relating to assigning at least one role of a plurality of user roles to each such at least one registered user within such at least one Internet-based virtual community; wherein such plurality of user roles comprises: at least one member role in which such at least one registered user may utilize all such Internet-based virtual community communication functions, and at least one caretaker role in which such at least one registered user may manage changes within such at least one Internet-based virtual community wherein such at least one caretaker role comprises; approving addition of at least one sub-community, within such at least one Internet-based virtual community, and approving addition of at least one web site universal resource locator address, within such at least one Internet-based virtual community. Additionally, it provides such a Internet system further comprising computer processor means relating to facilitating participation, as a guest, in at least one other such Internet-based virtual community by such at least one registered user. Also, it provides such a Internet system further comprising computer processor means relating to facilitating creation of at least one personal directory of selected registered users by such at least one registered user. In addition, it provides such a Internet system further comprising computer database means relating to facilitating optionally recording the content of at least one of such at least one virtual meeting. And, it provides such a Internet system, wherein computer processor means relating to facilitating conducting such at least one virtual meeting between such plurality of such registered users further comprising; computer processor means relating to permitting designation of such at least one virtual meeting as closed to uninvited other such registered users; computer processor means relating to permitting invitation of at least one other such registered user to such at least one closed virtual meeting by such at least one registered user; computer processor means relating to permitting such at least one invited registered user to join such at least one closed virtual meeting; and computer processor means relating to facilitating conducting such at least one closed virtual meeting between a plurality of invited such registered users. Further, it provides such a Internet system further comprising; computer processor means relating to permitting designation of at least one such virtual meeting as open to uninvited other such registered users; computer processor means relating to permitting such other uninvited registered users to join such at least one open virtual meeting without invitation; computer processor means relating to permitting invitation of at least one other such uninvited registered user to such at least one open virtual meeting by such at least one uninvited registered user; and computer processor means relating to permitting such at least one other uninvited registered user to join such at least one open virtual meeting. Even further, it provides such a Internet system further comprising; computer processor means relating to inserting into at least one monitored web page at least one universal resource locator address of at least one monitoring web site server; computer interface means relating to displaying at least one web page frame from such at least one monitoring web site server on such at least one monitored web page; wherein such at least one web page frame comprises at least one first count of at least two users visiting such at least one monitored web page, at least one second count of at least one subset (of such at least two users) engaged in at such least one Internet-based chat session, and at least one universal resource locator address of such least one Internet-based chat session; computer communication means relating to communicating to such at least one monitoring web site server from such at least one web page frame presence of such at least one user on such at least one monitored web page; computer communication means relating to communicating to such at least one web page frame from such at least one monitoring web site server such at least one first count of such at least two users visiting such at least one monitored web page, and such at least one second count of at least one subset (of such at least two users) engaged in such at least one Internet-based chat session; computer processor means relating to permitting each of such at least two users of such at least one monitored web page to activate such at least one Internet-based chat session; computer processor means relating to permitting each of such at least two users of such at least one monitored web page not already joined in to join such at least one active Internet-based chat session; and computer database means relating to permitting recording of at least one universal resource locator address of such at least one monitoring web site server as at least one resource in such at least one Internet-based virtual community. Moreover, it provides such a Internet system further comprising: computer interface means relating to displaying such at least one monitoring web page frame on such at least one monitored web page; computer processor means relating to permitting such at least one user of such at least one monitoring web site server to activate such at least one Internet-based chat session; and computer processor means relating to permitting such at least one user of such at least one monitoring web site to join such at least one active Internet-based chat session. Additionally, it provides such a Internet system further comprising: computer processor means relating to permitting each such at least one user of such at least one monitored web page joined in such at least one active Internet-based chat session to select text-based communications; and computer processor means relating to permitting each such user of such at least one monitoring site joined in such at least one active Internet-based chat session to select text-based communications. Also, it provides such a Internet system further comprising: computer processor means relating to permitting each such at least one user of such at least one monitored web page joined in such least one active Internet-based chat session to select voice-based communications; and computer processor means relating to permitting each such at least one user of such at least one user-manager engaged in at such least one active Internet-based chat session to select voice-based communications. In addition, it provides such a Internet system further comprising: computer storage means relating to accumulating a plurality of such communicated counts of users visiting such at least one monitored web page; and computer storage means relating to accumulating a plurality of such communicated counts of such users engaged in at such least one Internet-based chat session. And, it provides such a Internet system further comprising; computer transmission means relating to automatically transmitting to such at least one monitoring web site server universal resource locator address of each such web page of such at least one monitored web site containing such at least one universal resource locator address of such at least one monitoring web site server; computer processor means relating to preparing at least one hierarchical index of all web pages containing such at least one universal resource locator address of such at least one monitored web site; and computer interface means relating to presenting such at least one hierarchical index in such at least one web page frame to such at least one user visiting such at least one web page containing such at least one universal resource locator address of such at least one monitoring web site. Further, it provides such a Internet system further comprising: computer interface means relating to assisting use of avatars to identify each such at least one registered user; computer interface means relating to assisting use of avatars to identify each such at least one user of such at least one monitored web site; computer interface means relating to assisting use of images to identify each such at least one registered user, computer interface means relating to assisting use of images to identify each such at least one user of such at least one monitored web site; computer interface means relating to assisting use of three dimensional images to identify each such at least one registered user, computer interface means relating to assisting use of three dimensional images to identify each such at least one user of such at least one monitored web site; and computer interface means relating to assisting combining such at least one virtual meeting with at least one three-dimensional interactive stage set.

In accordance with another preferred embodiment hereof, this invention provides an Internet system relating to assisting reporting at least one visit to at least one monitored web page of at least one monitored web site by at least one user comprising the steps of: inserting into such at least one monitored web page at least one universal resource locator address of at least one monitoring web site server; displaying at least one visual overlay web page from such at least one monitoring web site server on top of such at least one monitored web page; wherein such at least one visual overlay web page comprises at least one count of users visiting such at least one monitored web page; communicating to such at least one monitoring web site server from such at least one visual overlay web page presence of such at least one user visiting such at least one monitored web page; communicating to such at least one visual overlay web page such at least one count of users visiting such at least one monitored web page from such at least one monitoring web site server; and accumulating such communicated user counts.

In accordance with another preferred embodiment hereof, this invention provides an Internet system relating to assisting reporting at least one visit to at least one monitored web page of at least one monitored web site by at least one user comprising: computer processor means relating to inserting into such at least one monitored web page at least one universal resource locator address of at least one monitoring web site server; computer interface means relating to displaying at least one visual overlay web page from such at least one monitoring web site server on top of such at least one monitored web page; wherein such at least one visual overlay web page comprises at least one count of users visiting such at least one monitored web page; computer communication means relating to communicating to such at least one monitoring web site server from such at least one visual overlay web page presence of such at least one user visiting such at least one monitored web page; computer communication means relating to communicating to such at least one visual overlay web page such at least one count of users visiting such at least one monitored web page from such at least one monitoring web site server; and computer database means relating to accumulating such communicated user counts.

In accordance with another preferred embodiment hereof, this invention provides a computer-based display system relating to presenting information to at least one user of at least one monitored web page comprising the steps of: overlaying such at least one monitored web page with at least one visual overlay web page comprising at least one quantity of windows; linking each such visual overlay web page with such at least one monitored web page; displaying content within each such window within such at least one visual overlay web page; displaying at least one universal resource locator address within such at least one window within such at least one visual overlay web page; and permitting manipulation of each such at least one window within such at least one visual overlay web page by such at least one user. Even further, it provides such a computer-based display system further comprising the steps of: permitting definition of at least one behavior rule relating to such at least one window within such at least one visual overlay web page by at least one user-manger; wherein such at least one behavior rule comprises at least one default behavior of such at least one visual overlay web page, at least one behavior related to at least one variable, and at least one user-selectable behavior of such at least one visual overlay web page, permitting selection of such at least one behavior rule relating to such at least one visual overlay web page; storing such at least one behavior rule relating to such at least one visual overlay web page in at least one database on at least one monitoring web site server; permitting definition of at least one content rule relating to such at least one visual overlay web page by such at least one user-manager; and storing such at least one content rule relating to such at least one visual overlay webpage in such at least one database on at least one monitoring web site server. Even further, it provides such a computer-based display system wherein such at least one content rule relating to such at least one visual overlay page comprises at least three members selected from the set comprising: at least one first count of such users visiting such at least one monitored web page; at least one second count of at least one subset (of such users) engaged in at least one Internet-based chat session; at least one third count of such users visiting such at least one monitored web site, at least one hierarchical listing of such at least one monitored web page of such at least one monitored web site; at least one universal resource locator address of least one monitoring web page of such at least one monitoring web site; at least one universal resource locator address of such least one Internet-based chat session; at least one universal resource locator address of such least-one Internet-based chat session activated by such at least one user-manager; and at least universal resource locator address of at least one archive web page containing text of at least one previous Internet-based chat session. Even further, it provides such a computer-based display system wherein such behavior rules comprises at least five members selected from the set comprising: momentarily expanding such at least one visual version of such at least one window within such at least one visual overlay page; permanently expanding such at least one visual version of such at least one window within such at least one visual overlay web page; minimizing such at least one visual version of such at least one window within such at least one visual overlay web page; placing such at least one visual version of such at least one window within such at least one visual overlay web page at a location within such at least one monitored web page; modifying text content of such at least one visual version of such at least one window within such at least one visual overlay web page; making such at least one visual version of such at least one window within such at least one visual overlay web page visible to such at least one user; making such at least one visual version of such at least one window within such at least one visual overlay web page invisible to such at least one user; producing a sound; changing at least one image within such at least one visual version of such at least one window within such at least one visual overlay web page; sending at least one message to such at least one user; sending at least one email to such at least one user; and sending at least one instant message to such at least one user. Even further, it provides such a computer-based display system wherein such at least one variable comprises at least one member selected from the set comprising: elapsed time such at least one user has visited such at least one monitored web page; elapsed time such at least one user has visited such at least one monitored web site; count of previous visits to such at least one monitored web page by such at least one user; count of previous visits to such at least one monitored web site by such at least one user; count of such users visiting such at least one monitored web page; count of such users visiting such at least one monitored web site; count of such users participating in such at least one Internet-based chat session; universal resource locator address last such at least one monitored web page visited by such at least one user; current time and date; recognition of such at least one user visiting such at least one monitored web page as anonymous; recognition of such at least one user visiting such at least one monitored web page as not anonymous; recognition that such at least one user-manager is visiting monitored such at least one monitored web page; participation by such at least one user-manager in such at least one Internet-based chat session; count of messages posted to such at least one monitored web site. Even further, it provides such a computer-based display computer-based display system, wherein the step of permitting user manipulation of such at least one window within such at least one visual overlay page comprises the steps of: permitting expansion of such at least one window within such at least one visual overlay web page by such at least one user; permitting minimization of such at least one window within such at least one visual overlay web page by such at least one user; and permitting placement of such at least one window within such at least one visual overlay web page at a location within such at least one monitored web page by such at least one user. Even further, it provides such a computer-based display system further comprising the steps of: permitting such at least one user-manger to selectively apply such at least one behavior rule to such at least one window within such at least one visual overlay web page; permitting storing such at least one behavior rule selection in such at least one data base on such on at least one monitoring web site server; permitting such at least one user-manger to selectively apply such at least one content rule to such at least one window within such at least one visual overlay web page; and permitting storing such at least one content rule selection in such at least one data base on such on at least one monitoring web site server.

In accordance with another preferred embodiment hereof, this invention provides a method, relating to assisting participation in Internet-based communication between at least two visitors to at least one monitored web page of at least one monitored web site, comprising the steps of: operating at least one monitoring web site server adapted to permit Internet-based chat between such at least two visitors to such at least one monitored web page of such at least one monitored web site; receiving payment from at least one operator of such at least one monitored web site by at least one monitoring web site operator; embedding, in such at least one monitored web page, at least one universal resource locator reference to monitoring software operating on such at least one monitoring web site server by such at least one operator of such at least one monitored web site; monitoring such at least one monitored web page for presence of such at least one visitor by such monitoring software; overlaying at least one monitoring web page sent from such monitoring software on such on at least one monitoring web site server on top of such at least one monitored web page when the presence of at least one visitor is detected; permitting Internet-based communication between such at least two visitors to such at least one monitored web page using at least one Internet-based communication tool operating on such at least one monitoring web site server; and wherein such at least one Internet-based communication tool comprises Internet-based chat. Even further, it provides such a method wherein such at least one Internet-based communication tool comprises Internet-based messaging. Even further, it provides such a method wherein such at least one Internet-based communication tool comprises Email. Even further, it provides such a method wherein such at least one visitor comprises at least one user-manager of such at least one monitored web site.

### DEFINITIONS, ACRONYMS AND CROSS-REFERENCES

The following terms and acronyms are explained below as background and are used throughout the detailed description:

Chat/Chat Room. Any system that allows any number of users to have a typed (and/or voice-based), real-time, on-line conversation, either by all users logging into the same computer, or more commonly nowadays, via a network. Using special software, Internet users can enter chat areas or “virtual spaces,” where they can communicate in real time.

Client-Server. A model of interaction in a distributed system in which a program at one site sends a request to a program at another site and waits for a response. The requesting program is called the “client,” and the program that responds to the request is called the “server.” In the context of the World Wide Web, the client is typically a “Web browser” that runs on a user's computer; the program that responds to Web browser requests at a Web site is commonly referred to as a “Web server.”

Database. One or more large structured sets of persistent data maintained upon a computer system organized and structured according to a software system defining rules for organization as well responding to queries to read, write or modify data as well as provide statistical information regarding the contained data. As used herein for purposes of discussion, a database may be either a single unified system or a distributed system wherein certain database elements are located upon different systems, acting in harmony to appear as one unified database.

Domain Name System (DNS). An Internet service that translates domain names (which are alphabetic identifiers) into IP addresses (which are numeric identifiers for machines on a TCP/IP network).

Email. A system for sending and receiving messages electronically over a computer network, as between personal computers.

Extensible Markup Language (XML). XML describes a class of data objects known as XML documents and partially describes the behavior of computer programs which process these documents. More specifically, XML is a restricted form of the Standard Generalized Markup Language (also known as SGML). XML documents are made up of storage units defined as entities which in turn comprise either parsed or unparsed data in the form of characters or simply a character. XML is designed and intended to improve the functionality of the Internet by providing more flexible and adaptive forms of information. XML can be used to store any kind of structured information and in such encapsulated form, pass it between different computer systems which would otherwise be unable to communicate.

Hypertext Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other websites and other Web documents (commonly referred to as “hyperlinks”). For more information on HTML, see Ian S. Graham, The HTML Source Book, John Wiley and Sons, Inc., 1995 (ISBN 0471-11894-4).

Hypertext Transport Protocol (HTTP). The standard World Wide Web client-server protocol used for the exchange of information (such as HTML documents and client requests for such documents) between a Web browser and a Web server. HTTP includes a number of different types of messages that can be sent from the client to the server to request different types of server actions. For example, a “GET” message, which has the format GET, causes the server to return the document or file located at the specified Universal Resource Locator (URL).

HTTPS. HTTP over SSL (Secure Sockets Layer) can be best understood as a secure form of HTTP communication. Specifically, SSL is a protocol utilized for the authentication and encryption of HTTP traffic. In operation, the server and client exchange a set of encryption keys that are used to create a unique encryption key used to encrypt all data exchanged during the session.

Inline FRAME. A floating frame, with content just like an ordinary frame, included in the HTML 4 standard. Inline Frames are useful for maintaining a frame of information on the user's display at all time even when the underlying content is scrolled up or down.

Instant Messaging. Abbreviated IM, a type of communications service that enables you to create a kind of private chat room with another individual in order to communicate in real time over the Internet, analogous to a telephone conversation but using text-based, not voice-based, communication. Typically, the instant messaging system alerts you whenever somebody on your private list is online. You can then initiate a chat session with that particular individual.

Internet. A collection of interconnected (public and/or private) networks that are linked together by a set of standard protocols to form a distributed network. While this term is intended to refer to what is now commonly known as the Internet, it is also intended to encompass variations that may be made in the future, including changes and additions to existing standard protocols.

Internet-based Virtual Community. A group whose members, with common interests, are connected by means of information technologies, typically the Internet. Similar terms include online community and mediated community. Internet-based virtual community is loosely used and interpreted to indicate a variety of social groups connected in some ways by the Internet. The technologies include Usenet, MUDs (Multi-User Dungeon), IRC (Internet Relay Chat), chat rooms and electronic mailing lists.

LAN. A Local Area Network of computer systems, typically within a building or office, permitting networking, the associated sharing of resources and files, such as application software, printers and client information, in an inter-office setting.

PHP. A server-side, cross-platform, HTML-embedded scripting language used to create dynamic web pages. PHP is Open Source software.

Structured Query Language (SQL). SQL is a standard language used to communicate with relational database management systems (such as Oracle, Sybase, Microsoft SQL Server, Access, etc.) for the purpose of performing tasks such as data insertion, deletion, update, and general query for the return of data.

The Simple ObjectAccess Protocol (SOAP). SOAP is a lightweight XML/HTTP-based protocol for the exchange of information in a decentralized distributed platform-independent environment. Fundamentally, SOAP consists of three parts. The first is an envelope that defines a framework for describing what is contained in the message and how it should be processed. The second is a set of encoding rules for expressing instances of application-defined data types. The third is a normalized convention for representing remote procedure calls and responses.

Transmission Control Protocol/Internet Protocol (TCP/IP). A standard Internet protocol (or set of protocols) which specifies how two computers exchange data over the Internet. TCP/IP handles issues such as packetization, packet addressing, and handshaking and error correction. For more information on TCP/IP, see Volumes I, II and III of Comer and Stevens, Internetworking with TCP/IP, Prentice Hall, Inc., ISBNs 0-13-468505-9 (vol. 1), 0-13-125527-4 (vol. 11), and 0-13-474222-2 (vol. III).

Uniform Resource Locator (URL). A unique address which fully specifies the location of a file or other resource on the Internet. The general format of a URL is protocol://machine address:port/path/filename. The port specification is optional, and, if not entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

WAN. A Wide Area Network, such as the Internet.

World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the Hypertext Transfer Protocol (HTTP), and the electronic pages are encoded using the Hypertext Markup Language (HTML). However, the terms “World Wide Web” and “Web” are intended to encompass future markup languages and transport protocols that may be used in place of or in addition to the Hypertext Markup Language (HTML) and the Hypertext Transfer Protocol (HTTP).

### BRIEF DESCRIPTION OF THE DRAWINGS

FIG. 1 shows a diagrammatical overview of the Internet communications used in the instant system according to a preferred embodiment of the present invention.

FIG. 2 shows a simplified functional diagrammatical overview of the relationship among the web site servers and users of the instant system according to a preferred embodiment of the present invention.

FIG. 3 shows a diagrammatical overview of relationship of the instant system and members and non-members of multiple Internet-based communities according to a preferred embodiment of the present invention.

FIG. 4 shows a diagrammatical overview of the set up, management and usage of the instant system for Internet-based virtual communities according to a preferred embodiment of the present invention.

FIG. 5 shows a diagrammatical overview of the usage and set up of web activity monitoring and ad hoc chat usage using the instant system according to a preferred embodiment of the present invention.

FIG. 6A shows a diagrammatical overview of the embedded web page monitoring method according to a preferred embodiment of the present invention.

FIG. 6B shows a schematic overview of the web site monitoring logic according to a preferred embodiment of the present invention.

FIG. 7 shows a diagrammatical view of the preferred Home Page & Login screen according to a preferred embodiment of the present invention.

FIG. 8 shows a diagrammatical view of the preferred Member Home Page screen after logging in according to a preferred embodiment of the present invention.

FIG. 9 shows a diagrammatical view of the preferred Help Start screen according to a preferred embodiment of the present invention.

FIG. 10 shows a diagrammatical view of the preferred Communities screen according to a preferred embodiment of the present invention.

FIG. 11 shows a diagrammatical view of the preferred Add Community screen according to a preferred embodiment of the present invention.

FIG. 12 shows a diagrammatical view of the preferred Add Community Folder screen according to a preferred embodiment of the present invention.

FIG. 13 shows a diagrammatical view of the preferred Members screen according to a preferred embodiment of the present invention.

FIG. 14 shows a diagrammatical view of the preferred Member Profile screen according to a preferred embodiment of the present invention.

FIG. 15 shows a diagrammatical view of the preferred Other Member's Profile screen according to a preferred embodiment of the present invention.

FIG. 16 shows a diagrammatical view of the preferred Meetings screen according to a preferred embodiment of the present invention.

FIG. 17 shows a diagrammatical view of the preferred Meetings Detail screen according to a preferred embodiment of the present invention.

FIG. 18 shows a diagrammatical view of the preferred Meetings Detail 2 screen according to a preferred embodiment of the present invention.

FIG. 19 shows a diagrammatical view of the preferred Meeting Invitation screen according to a preferred embodiment of the present invention.

FIG. 20 shows a diagrammatical view of the preferred Meeting Invitees—Add/Remove screen according to a preferred embodiment of the present invention.

FIG. 21 shows a diagrammatical view of the preferred Resources screen according to a preferred embodiment of the present invention.

FIG. 22 shows a diagrammatical view of the preferred Resources—Configure URL screen according to a preferred embodiment of the present invention.

FIG. 23 shows a diagrammatical view of the preferred Resources—Configure Folder screen according to a preferred embodiment of the present invention.

FIG. 24 shows a diagrammatical view of the preferred Resources—Add Folder screen according to a preferred embodiment of the present invention.

FIG. 25 shows a diagrammatical view of the preferred Resources—Add URL to Folder screen according to a preferred embodiment of the present invention.

FIG. 26 shows a diagrammatical view of the preferred Resources—Embed Code screen according to a preferred embodiment of the present invention.

FIG. 27 shows a diagrammatical view of the preferred Joining others on a resource screen according to a preferred embodiment of the present invention.

FIG. 28 shows a diagrammatical view of the preferred Monitoring Web Site visitors screen according to a preferred embodiment of the present invention.

FIG. 29 shows a diagrammatical view of the preferred Messages screen according to a preferred embodiment of the present invention.

FIG. 30 shows a diagrammatical view of the preferred Messages Detail screen according to a preferred embodiment of the present invention.

FIG. 31 shows a diagrammatical view of the preferred Messages Detail 2 screen according to a preferred embodiment of the present invention.

FIG. 32 shows a diagrammatical view of the preferred floating embedded screen according to a preferred embodiment of the present invention.

FIG. 33 shows a diagrammatical view of the preferred text chat screen according to a preferred embodiment of the present invention.

FIG. 34 shows a diagrammatical view of the preferred Guest Name Change screen according to a preferred embodiment of the present invention.

FIG. 35 shows a diagrammatical view of the preferred web site URL reference code according to a preferred embodiment of the present invention.

FIG. 36 shows a diagrammatical view of the example preferred embed code according to a preferred embodiment of the present invention.

FIG. 37 shows a diagrammatical view of the preferred index according to a preferred embodiment of the present invention.

FIG. 38 shows a diagrammatical view of the preferred embed code according to a preferred embodiment of the present invention.

FIG. 39 shows a diagrammatical view of the preferred sample welcome email according to a preferred embodiment of the present invention.

FIG. 40 shows a diagrammatical overview of the usage and set up of web activity monitoring and ad hoc chat usage using the instant system according to an alternate preferred embodiment of the present invention.

FIG. 41 shows a diagrammatical view of the preferred embedded tabs screen demonstrating six tabs available to a web site visitor according to an alternate preferred embodiment of the present invention.

FIG. 42 shows a diagrammatical view of the preferred embedded tabs screen with each tab fully displayed according to an alternate preferred embodiment of the present invention.

FIG. 43 shows a diagrammatical view of the preferred embedded tabs screen with selected tabs placed at user's discretion according to an alternate preferred embodiment of the present invention.

FIG. 44 shows a diagrammatical view of the preferred embedded tabs screen with tabs placed at user's discretion and an active chat room dialog, after a user's request to chat with other web page or web site visitors according to an alternate preferred embodiment of the present invention.

FIG. 45 shows a diagrammatical view of the preferred embedded tabs screen with a selected Blobber Tab exposed and the membership registration dialog open according to an alternate preferred embodiment of the present invention.

FIG. 46 shows a diagrammatical view of the preferred embedded tabs screen with the message tab exposed with the option selected to display messages, left by other visitors, which are related to the underlying web page according to an alternate preferred embodiment of the present invention.

FIG. 47 shows a diagrammatical view of the preferred embedded tabs screen with people tab exposed with the option selected to display a membership directory of the virtual community associated with the underlying web site according to an alternate preferred embodiment of the present invention.

FIG. 48 shows a diagrammatical view of an example of a management screen for maintaining the behaviors and contents of each of the embedded tabs associated with a selected web page or web site according to an alternate preferred embodiment of the present invention.

### DETAILED DESCRIPTION OF THE BEST MODES AND PREFERRED EMBODIMENTS OF THE INVENTION

With the intention of enabling the present invention to be more readily understood by those skilled in the art, while at the same time disclosing the advantages that are afforded by the present invention, the following description is subdivided to provide an overview of the primary components giving rise to a preferred embodiment of the present invention (Internet-based Community, Web Site Monitoring, and Embed Processes). Within each subsection of this description reference is made by title to other system components when and as necessary to assist in understanding system inter-relationships.

Following the description of each sub-component and an identification of the pathways of communication between components, a description of the interaction of the components in functional application as taught by the present invention is provided.

A fundamental principle as taught by the present invention rests upon the premise that the Internet provides one of the best means for bringing people with similar interests together. The Internet-based communities that come together using the Internet, while largely self-organizing, can also benefit from access to tools and methods to facilitate communication and sharing.

Communication through the content—it is also recognized that there is often a need to share information with others at a particular point in time, such as when visiting a web page. In this context, indicating the number of other visitors in real-time and providing the opportunity to chat with the web site owner or another visitor on an ad hoc basis without log in or disclosure of personal information eliminates many barriers.

In the accompanying drawings, well-known structures and devices are shown in block diagram form in order to provide an understanding of the interrelationship between components and the flow of information and control throughout the depicted preferred embodiment of the present invention. It will be apparent to one skilled in the art that the invention may be practiced with a variety of different specific components, without detraction or departure from the scope of the present invention, provided to serve the generalized block diagram description. Further, for the purposes of the following discussion, it is to be understood that a transactional operation upon the database is one in which data is added, modified or deleted from the database. Specific statements made with respect to any of these operations are intended to clarify the nature of the operation being performed, but should not be taken as a limitation of the operation should an alternative transactional operation be desired in a substantially similar situation or setting.

It is also to be understood that the objects comprising the preferred embodiment may be coded in a language of preference to the developer without departure from the spirit or teachings of present invention. More specifically, encoding in a particular specific language, such as C, Java, C++, C-Prime, or other language, is not to be seen as restrictive to the scope of the present invention.

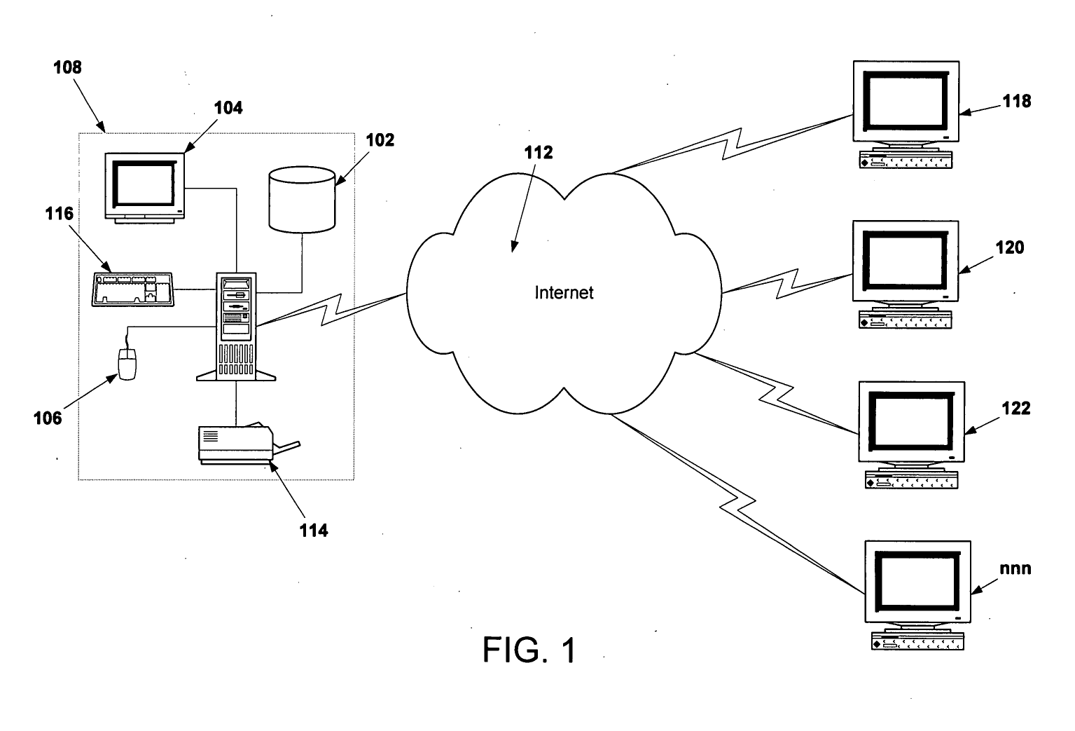

Referring now to FIG. 1, an overview of a preferred embodiment of the present invention is shown. The present invention preferably comprises a computer system server 108. The computer system server 108 comprises input and output devices. For example, the computer system server 108 preferably comprises a display screen or monitor 104, a keyboard 116, a printer 114, a mouse 106, etc. The computer system server 108 further preferably comprises a database 102 for storage of the data and software comprising preferred embodiments of the present invention. The computer system server 108 is preferably connected to the Internet 112 that serves as the presently preferred communications medium using http 130 (hypertext transport protocol) as preferred protocol. The Internet 112, as previously discussed, comprises a global network of networks and computers, public and private. The Internet 112 is the preferable connection method by the users 118, 120, 122 and nnn in preferred embodiments of the present invention.

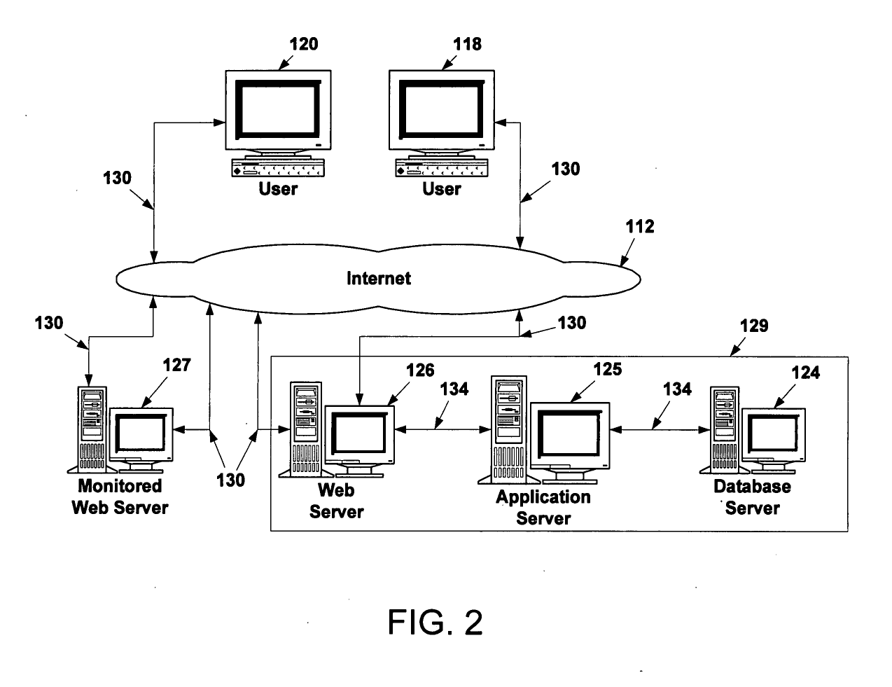

Referring to FIG. 2, a simplified functional diagram of a preferred embodiment of the present invention is shown. This figure shows the preferred relationships between a user 118 (an example of any number of users 118, 120, 122, nnn), the Internet 112, the web server 126, the application server 125 and the database server 124. Under appropriate circumstances, the web server 126, the application server 125 and the database server 124 may be combined into a single-machine combined web server 129. As shown, a user 118 requests a page from the web site of the present invention operating on the combined web server 129. The user 118 is preferably connected via the Internet 112, and the web page request initiates a call to the present invention using http 130. The present invention then makes at least one request to the database server 124, and generates an HTML page for transmission to the user 118 following the database server's completion of the present invention's request and transmission of the requested data back to the web server 126. The web server 126 transmits the completed HTML frame page containing the data requested by the user 118 through the Internet 112 to the user 118. Under appropriate circumstances, the above described database server 124, the web server 126 and the application server 125 may be combined and the above described interactions may be accomplished within the combined web server 129.

This figure also shows the preferred relationships between a user 120 (an example of any number of users 118, 120, 122, nnn), the Internet 112, and the monitored web server 127, the application server 125 and the database server 124 or, under appropriate circumstances a combined web server 129. As shown, a user 120 requests a page from the monitored web site 127. The user 120 is preferably connected via the Internet 112, and the web page request initiates a call to the software operating on the monitored web server 127 using http 130. As shown, the embedded frame on monitored web server 127 is capable of communicating to the web server 126 via Internet 112. The embedded frame on the monitored web site 127 notifies web server 126 when user 120 has accessed a page and, in response web server 126 transmits the count of users presently accessing the requested page and the number of users in an ad hoc chat session initiated from the requested page back to the embedded frame.

Internet-Based Virtual Community

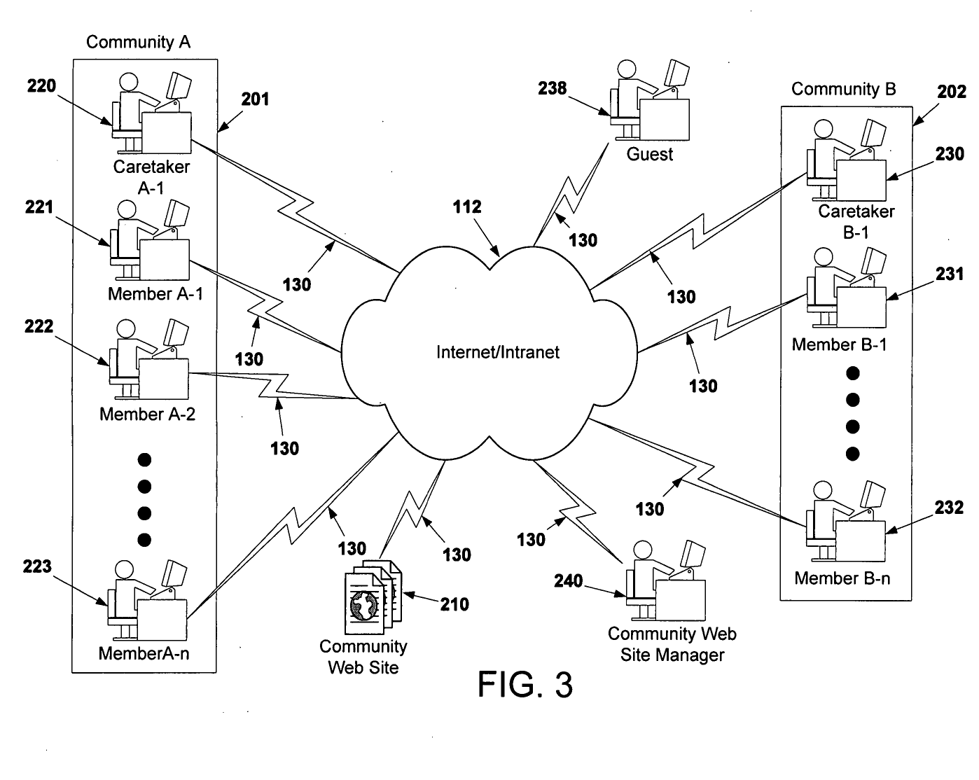

Referring now to FIG. 3, diagrammatical overview of relationship of the present invention and members and non-members of multiple Internet-based virtual communities is shown. According to a preferred embodiment of the present invention the instant system and methods provides a community center for users with similar interests (See Note 160; See Note 147). Preferably, the community web site 210 is established by the community web site manager 240 who is responsible for the overall management of the web site by setting the overall parameters of community web site 210 and Internet-based virtual community rules, and role assignment to members of each of the Internet-based virtual communities, such as Internet-based virtual community A 201 or Internet-based virtual community B 202.

Preferably, each guest 238 coming to community web site 210 is presented with the opportunity to join an existing Internet-based virtual community, such as Internet-based virtual community A 201 or Internet-based virtual community B 202, or establish a new Internet-based virtual community. A founder of a Internet-based virtual community may be granted the caretaker role, such as caretaker A-1 220 or caretaker B-1 230 by the community web site manager 240. Preferably, assignment as a caretaker permits caretaker A-1 220 or caretaker B-1 230 to set the particular rules for operation of Internet-based virtual community A 201 or Internet-based virtual community B 202 respectively (See Note 9; See Note 146).

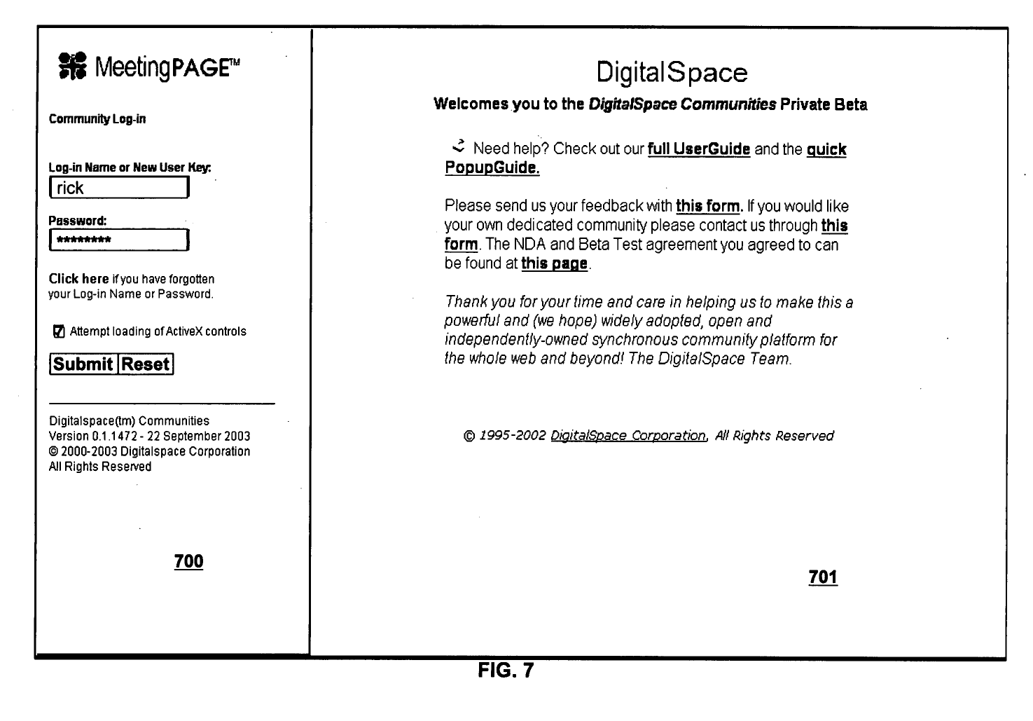

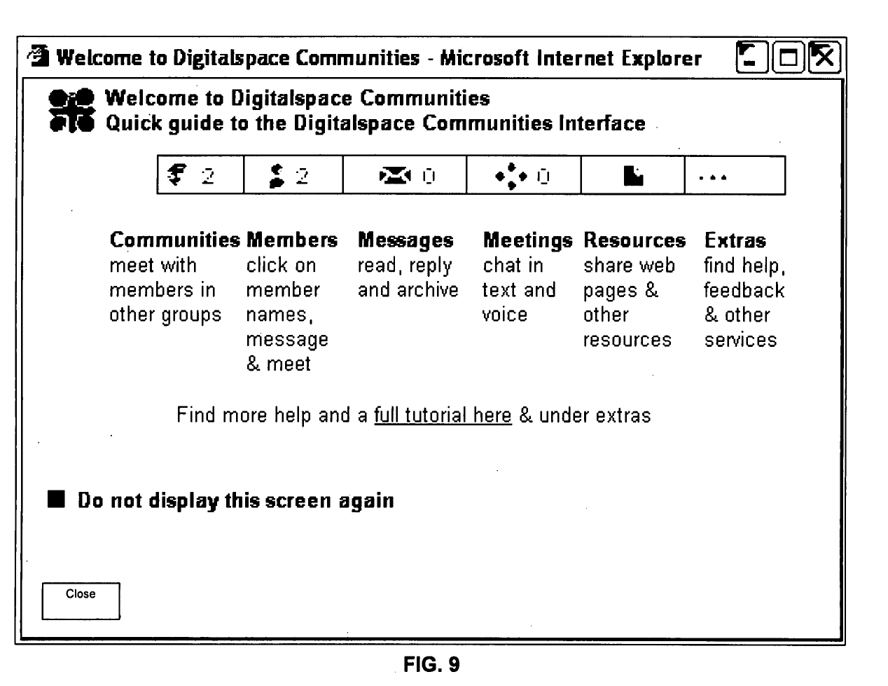

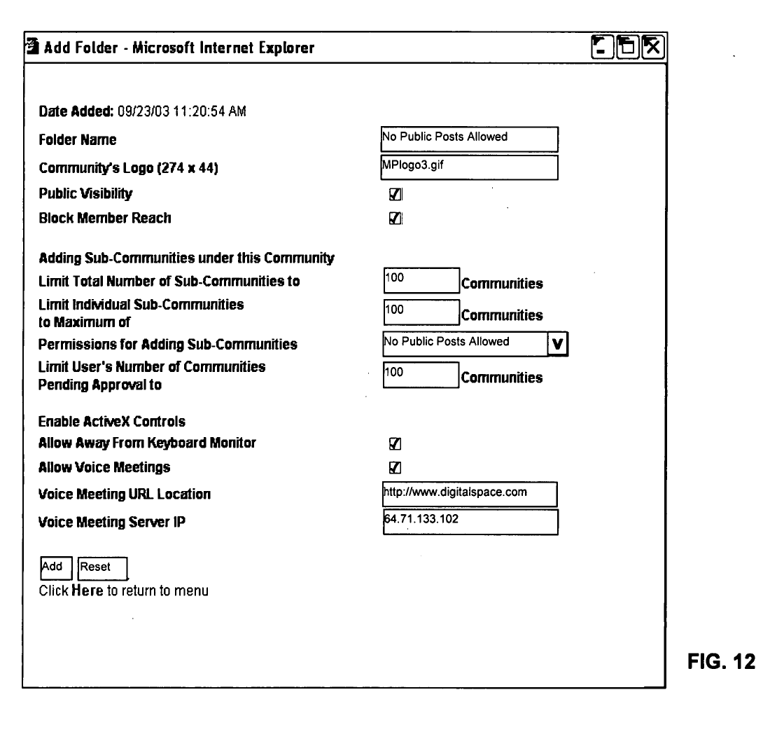

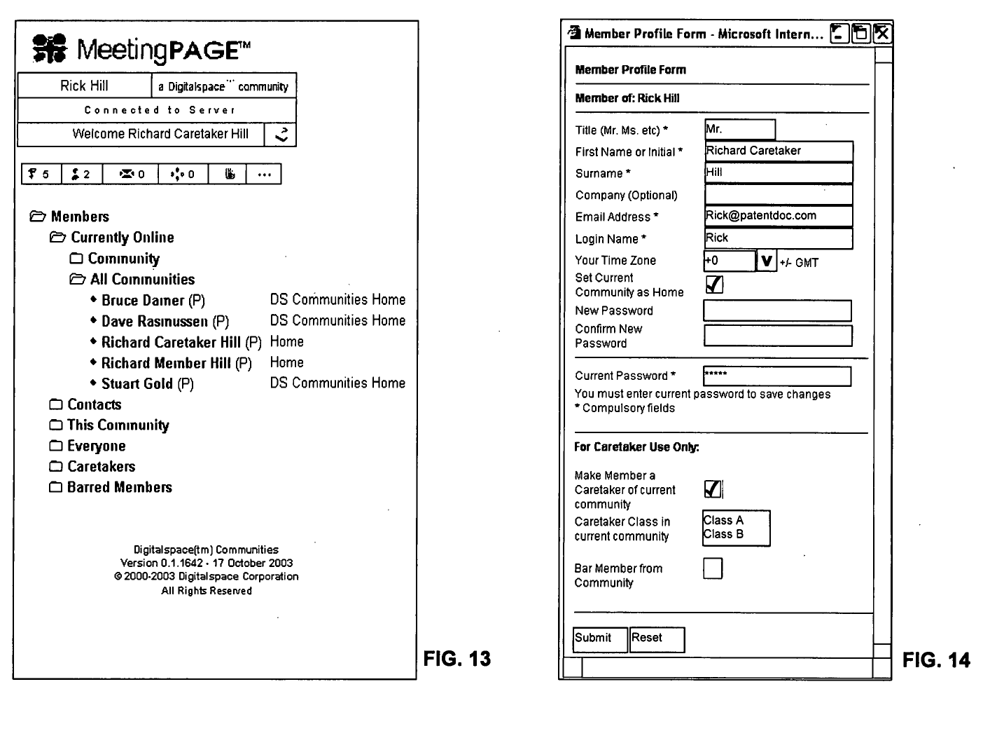

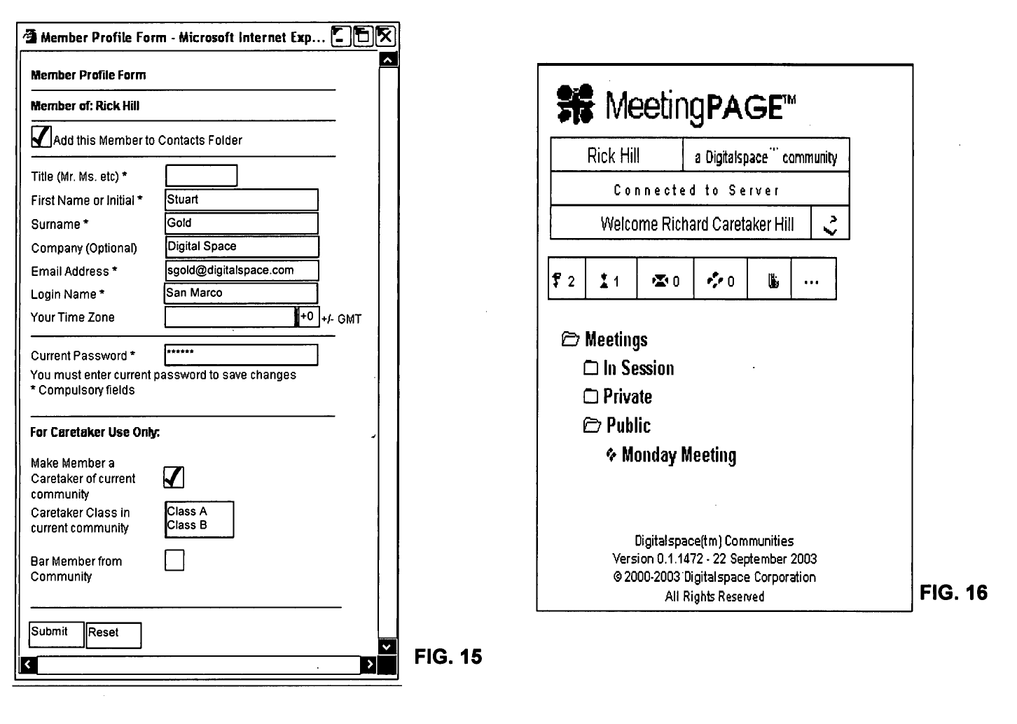

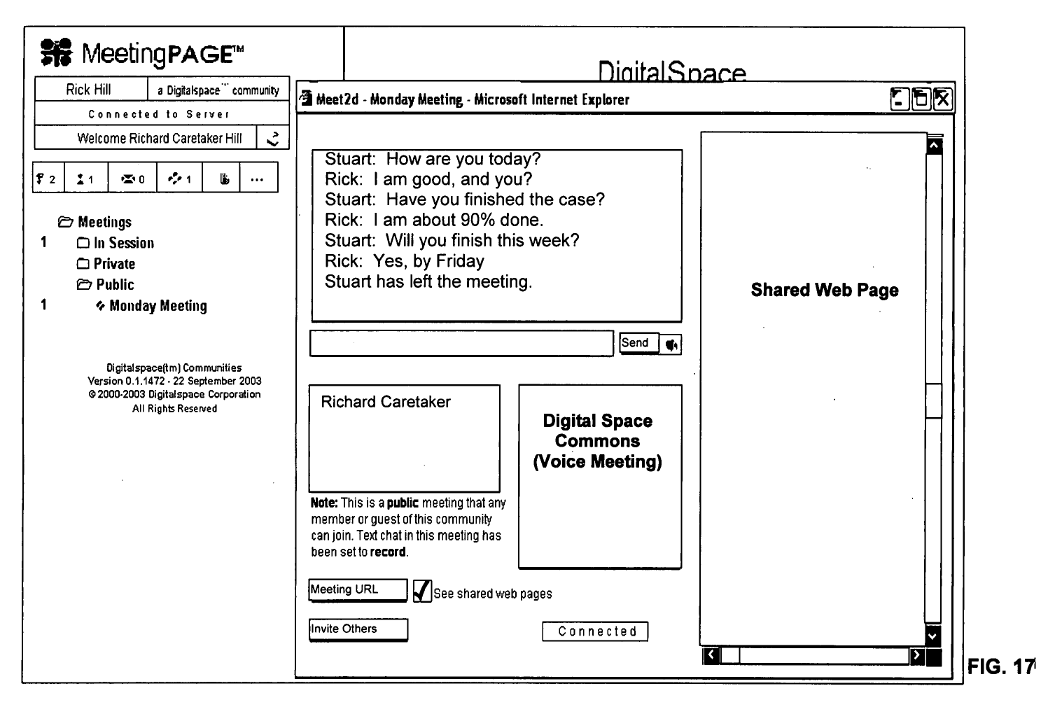

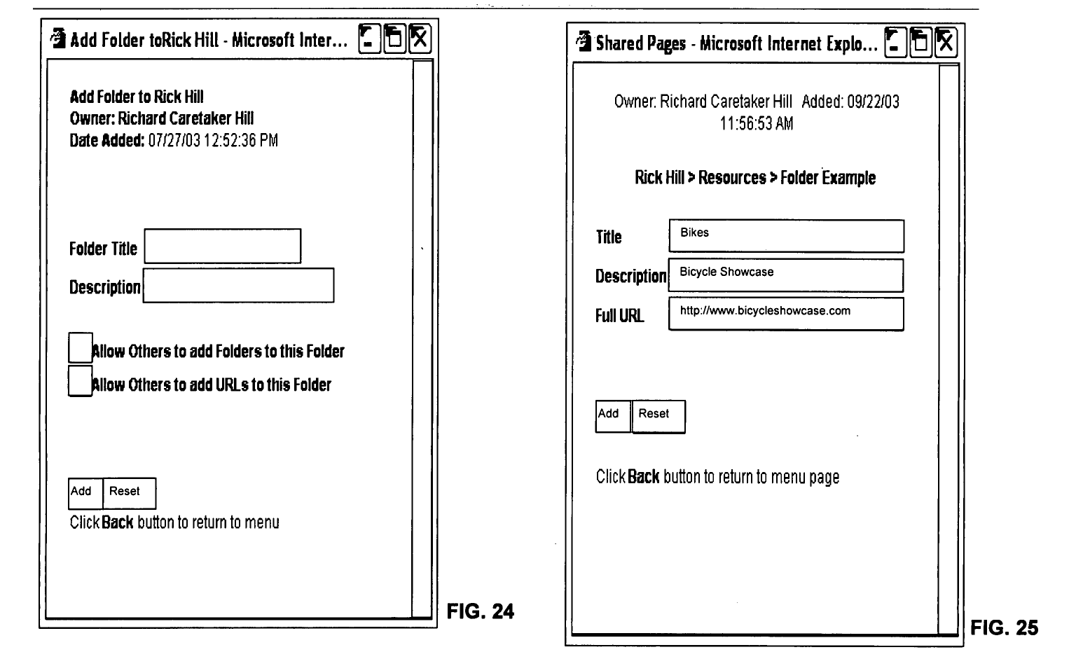

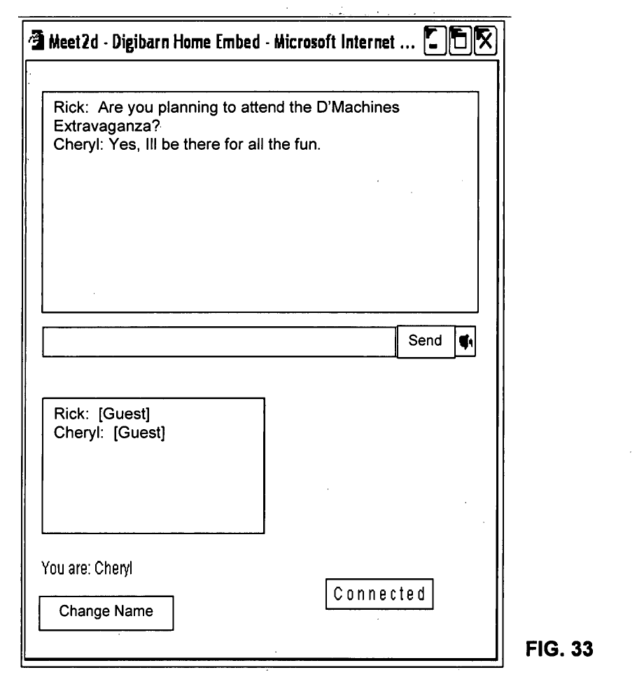

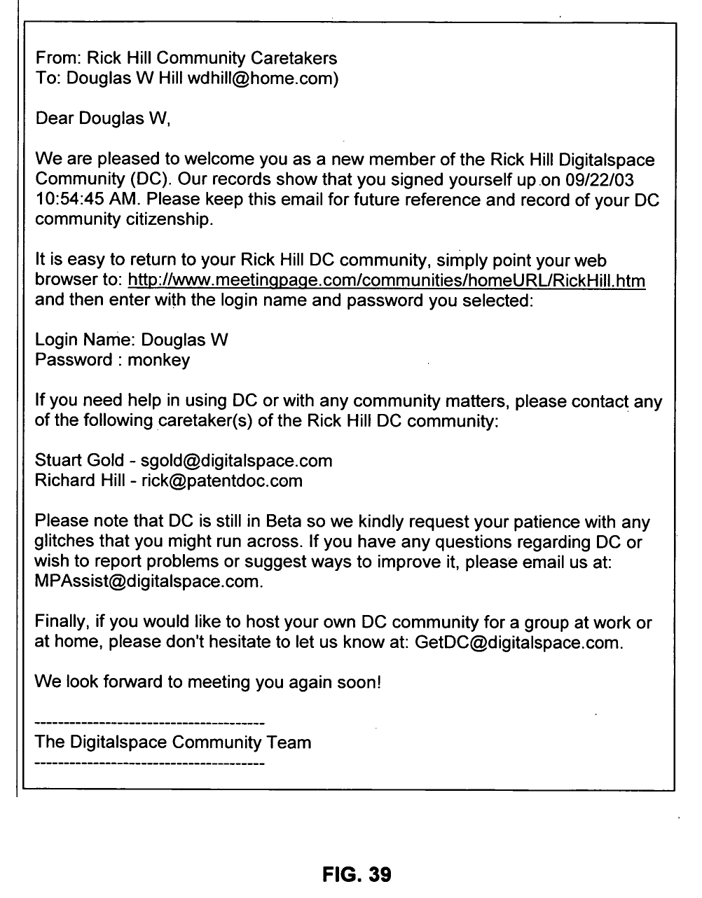

According to a preferred embodiment of the present invention, new members may be invited by an existing member or self register (See Note 68). Each guest 238 is provided an initial login and password in an email message as shown in FIG. 39. Upon receipt of the message the guest 238 may access their Internet-based virtual community as a member A-1 221 (exemplary of any number of members 221, 223, 231, 233). Each member A-1 221 completes a personal profile as presented in FIG. 14 (See Note 13; See Note 14). As can be seen, each member's profile may be accessed by the caretaker A-1 220 to change a member's role or to bar a member from web site access (See Note 6). As shown in FIG. 15, a member A-1 221 may view another member's profile and choose to add any member to the viewing member's contact list. After logging in, the community homepage, as shown in FIG. 8, is presented to each member A-1 221 (See Note 29). As shown, the presentation is preferably divided in two parts, the left side providing single click access to the five primary Internet-based virtual community functions, and the right side presenting the home resource page for the Internet-based virtual community 201 of member A-1 221. In particular, at the top of the left panel a navigation bar 703 is presented. By selecting the first tab of the navigation bar 703, each member A-1 221 may access other communities as shown in FIG. 10. By selecting the second tab of the navigation bar 703, each member A-1 221 may determine other members that are online, what meeting they are attending and what web page resource they are viewing at the moment as shown in FIG. 13. By selecting the third tab of the navigation bar 703, each member A-1 221 may send and receive messages from other members as shown in FIG. 29. By selecting the fourth tab-of the navigation bar 703, each member A-1 221 may set up and attend Internet-based virtual community meetings as shown in FIG. 16 (See Note 62; See Note 87). By selecting the fifth tab of the navigation bar 703, each member A-1 221 identify and share Internet resources as shown in FIG. 21. Preferably, a sixth tab is also available which provides access to a User Guide, a feedback form to report errors or make suggestions, community news items, community rules of conduct, the end user license and a form for requesting permission to establish a new community.

Preferably all Internet-based virtual community functions are provided without requiring the installation of additional software by member A-1 221 (See Note 78; See Note 79).

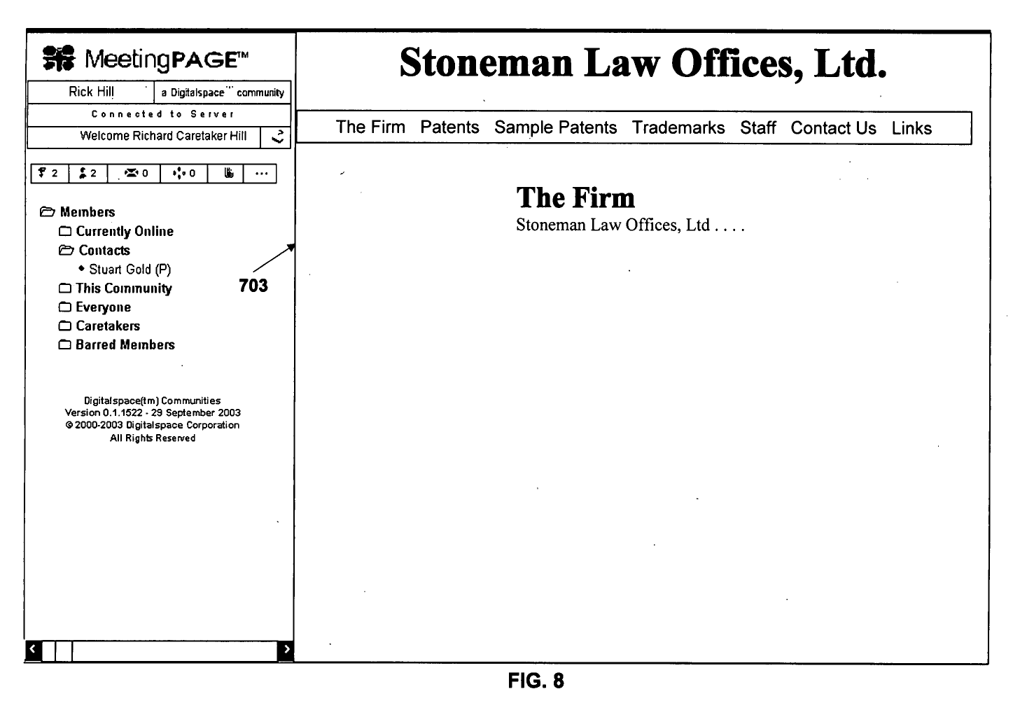

Preferably, unless set otherwise, each member A-1 221 is presented a help screen as shown in FIG. 9. The help screen provides an overview of each of the functional areas available to the member A-1 221.

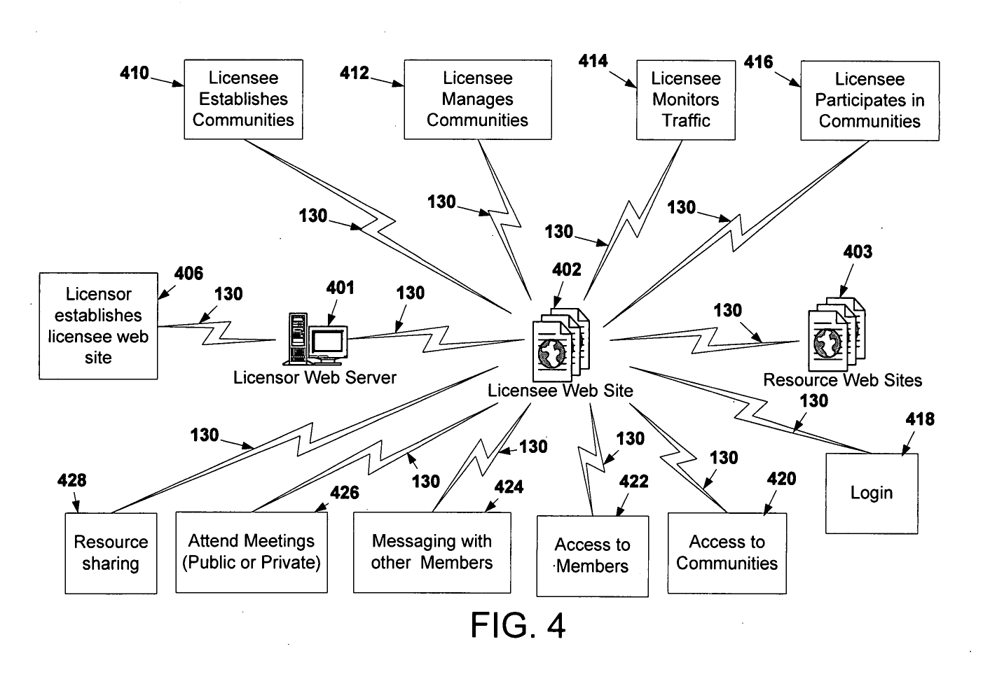

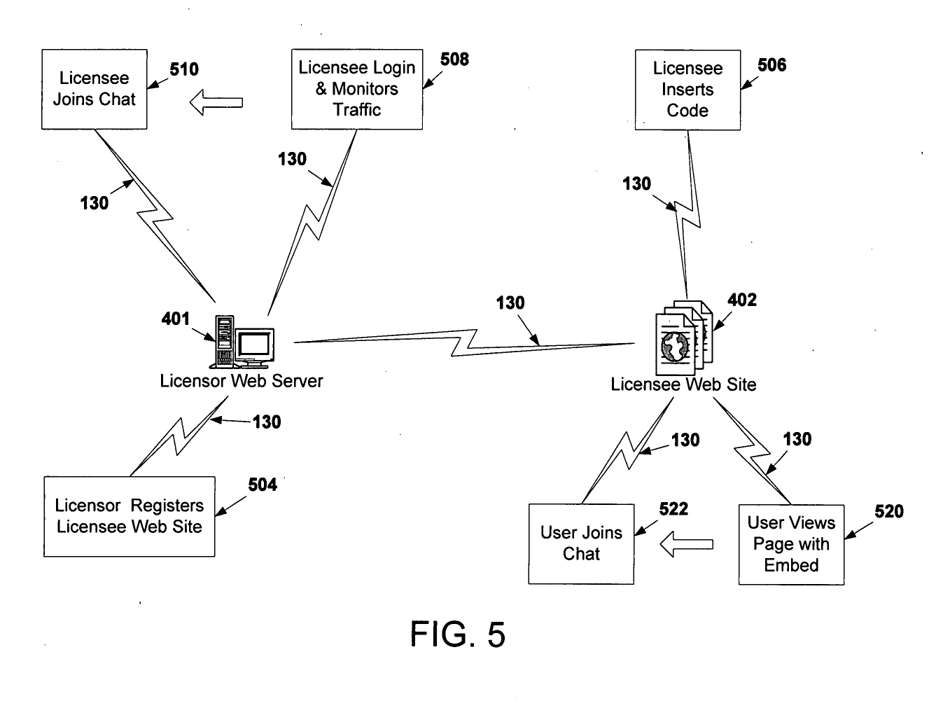

Preferably, two methods of usage of the instant system are provided. The first method as shown in FIG. 4 allows tracking of any page on the Internet but only by direct, registered users of the instant system who invoke those URLs from within the instant system. Preferably, no update to the code of the invoked URLs is required. The second method as shown in FIG. 5 preferably allows tracking of only the web pages that have the code embedded. In this method, the number of visitors at any particular time to the web page containing the embed code is then available to all users visiting the page. Preferably, it is unnecessary for any user to registered user of the instant system. Each of these methods will now be described in greater detail below.

Referring now to FIG. 4, a diagrammatical overview of the set up, management and usage of the instant system for Internet-based virtual communities is presented. As shown in FIG. 4, the preferred communications medium is the Internet using http 130 (hypertext transport protocol) as preferred protocol. Initially, as depicted in the process 406, licensor will preferably set up the Internet-based virtual community system and establish the licensee web site 402 for the licensee as a valid licensee of the instant system. Preferably, the set up, management and usage functions of the instant system may be served directly from the licensor web server 401 to licensee web site 402. Under appropriate circumstances, the instant system may be installed on a web server provided by the licensee and the set up, management and usage functions of the instant system provided as an integral part of licensee web site 402.

Preferably, an entry point URL is hosted on the Licensor web server 401 which calls in the tabs and all data from the database attached to the licensor web server 401. As shown in FIG. 21, right frame 702 is preferably the home page of the Licensee's web site, hosted by Licensee. Preferably, no code is added to any page of the licensee's web site as the instant system tracks visitor usage by knowing that the web page presented in right frame 702 was called by the link in left frame 701. Preferably, this is the method used for all web pages linked in the Resources tab (as shown in FIG. 21 through FIG. 25), which is encompassed in the left frame 701. This method preferably provides links to web pages unrelated to the Licensee, which permits tracking of visits by licensee's registered users to those pages as long as those registered users invoked the web page from the Resources tab in the left frame 701 of the instant system.

Preferably, the instant system utilizes a “heartbeat module” to periodically transmit the database ID of the URL of the web page presented in the right frame 702 back to the database server (this is so if the server goes down, on reinstatement of the server, it can be ‘reminded’ of the page the user was on by virtue of this database ID). Additionally, the heartbeat module preferably communicates any real-time information pertinent to each registered user such as waiting messages, population status of other resources and meetings etc. from the database server for the web page presented in the right pane 701.

Preferably, at completion of the implementation of the Internet-based virtual community system, licensee will establish the parameters and overall rules for management and usage of the communities by members and caretakers in the process Licensee Establishes Communities 410. Once the community parameters and overall rules for management and usage are established, preferably the licensee manages the communities using the same tools in the process Licensee Manages Communities 412. Tools are also available to the licensee to monitor community activity by members in the process Licensee Monitors Traffic 414. Preferably, the licensee may also participate as a member in the activities of the Internet-based communities in the process Licensee Participates in Communities 416 using some or all the member process described below.

While each of the member processes (Access to Communities 420, Access to Members 422, Messaging with other Members 424, Attend Meetings 426, and Resource Sharing 428) is depicted separately and as disconnected, each is available from the navigation bar which is available from all primary member functional screens.

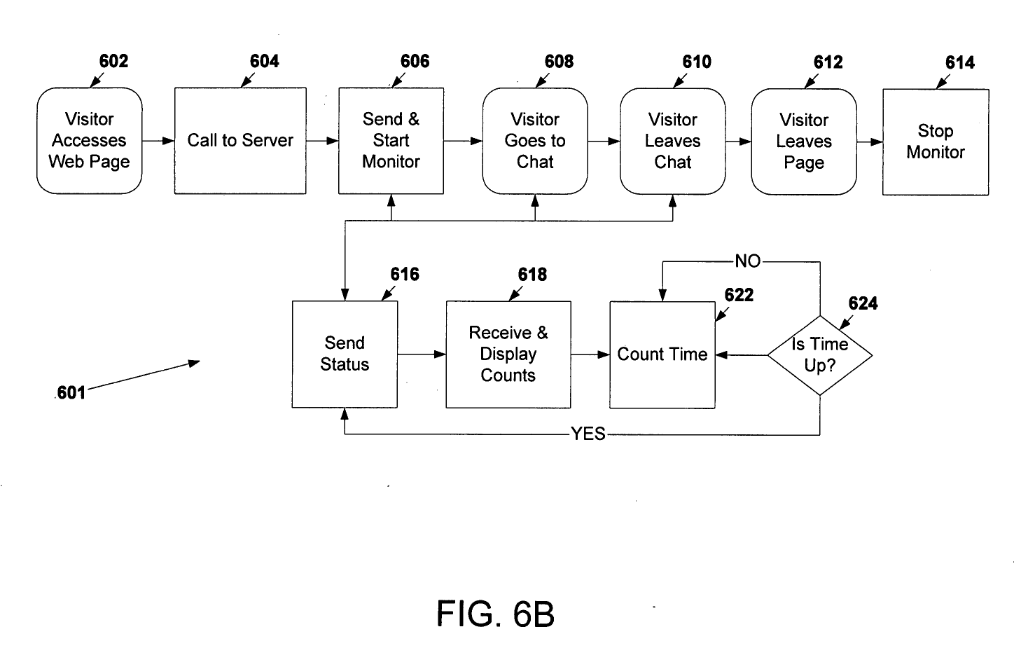

Preferably, in the initial process Login 418 regular members and caretaker members are required to login to the community using a user id and password. As shown in FIG. 7, the login process is started from the primary home page for the community web site.

According to a preferred embodiment of the present invention, to utilize the member process Access to Communities 420, after logging in a member preferably selects the leftmost tab of the navigation bar which is the Communities tab as shown in FIG. 8. This tab brings up a tree view of all of the communities supported on this server as illustrated by FIG. 10. The community to which each member belongs is preferably part of this tree and, based on permissions granted, a member may be able to navigate out of his/her own community and enter other communities as a guest.

Preferably, the top-level folder is labeled “Communities.” Clicking once on the folder preferably presents other community names or folders, which in turn may contain other communities as well as the community to which a member belongs. The number to the left of any folder or community name preferably represents the number of members online in that folder (category) or individual community. Preferably, a member may select a folder and a community name to enter that community. Preferably, as a member selects a community, the home page to the right changes, as well as the community name and logo above the tabs. Selecting any of the Members tabs displays the member list for that community. Similarly, selecting the Meetings tab preferably presents any meetings in progress for that community. Finally, selecting the Resources tab shows the Web Resources for that community. A member of one community traveling the community tree of another community is preferably considered a guest, but given full rights to message, view resources or join public meetings (See Note 124; See Note 125; See Note 126; See Note 127). Preferably, communities may optionally be established which restrict access by guests or optionally permit travel by their own members outside of the community.

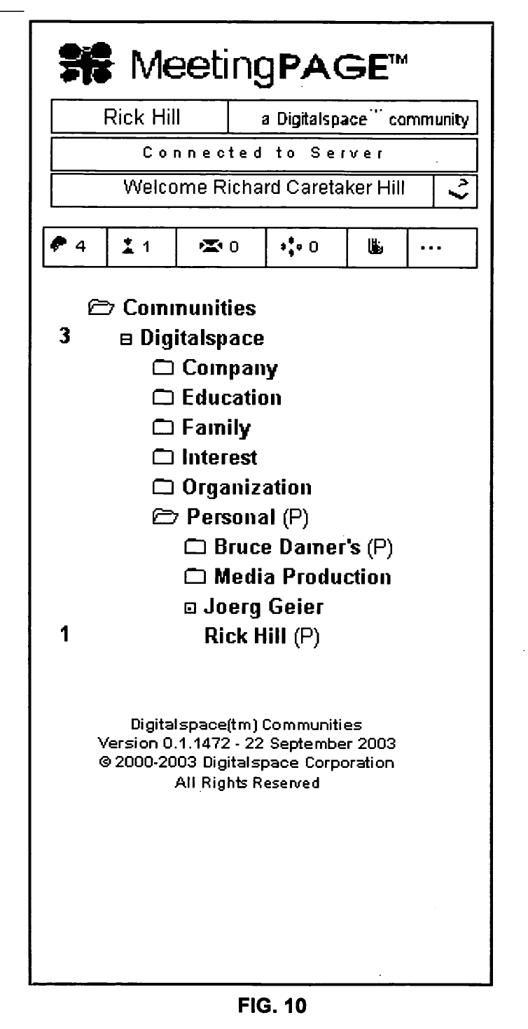

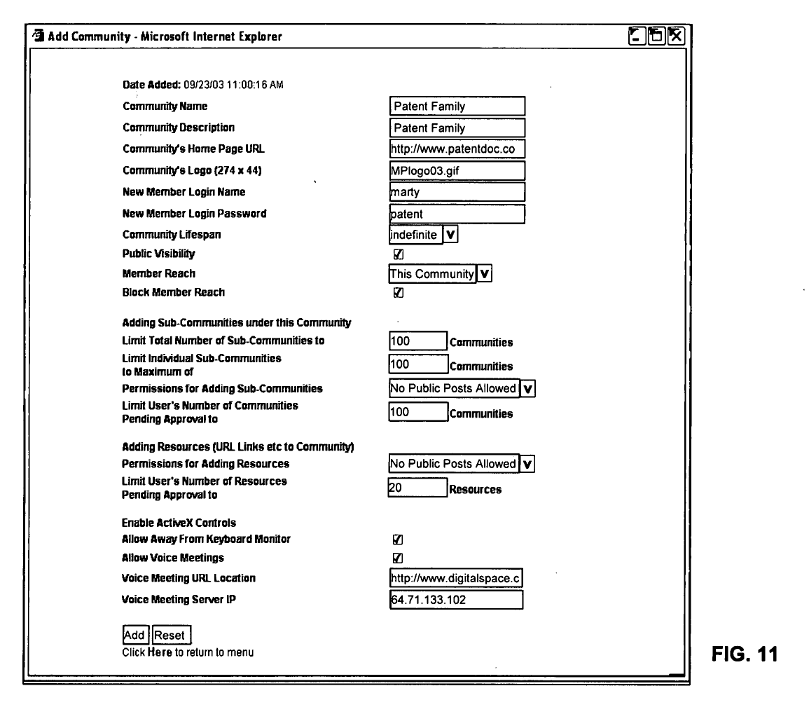

Preferably, members assigned the role of caretaker for a community may perform a variety of functions not available to regular members including inviting new members by email as shown in FIG. 39, add a sub-community as shown in FIG. 11, amend or delete a community using a screen similar to the one shown in FIG. 11, or add a sub-community category as shown in FIG. 12 or approve the addition of a website URL by a member (See Note 4; See Note 5). Preferably, some or all of these functions may also be made available to non-caretaker users (See Note 9; See Note 10; See Note 22; See Note 23).

According to a preferred embodiment of the present invention, to utilize the member process Access to Members 422, a member preferably selects the second tab from the left on the navigation bar as shown in FIG. 13, which is the Members tab. As illustrated in FIG. 13, selecting the Currently Online folder preferably reveals two subfolders Community and All Communities. The Community subfolder lists the members of the community who are currently online and using the system. It also shows what web page they are viewing or what meeting they are participating in at the moment. Preferably, the All Communities folder lists the names of everyone online including people from the entire tree of which the member's community is a part.

Preferably, each member may modify his or her profile by selecting the (P) (“properties”) next to his or her name. As shown in FIG. 14, each member may modify any of the elements not reserved for members in caretaker roles. As shown in FIG. 15, any member may access the public information about any other member by selecting the (P) next to the member's name.

According to a preferred embodiment of the present invention, to utilize the member process Messaging with other Members 424, a member preferably selects the third tab from the left on the navigation bar as shown in FIG. 13 which is the Messages tab. As illustrated in FIG. 29, the Messages tab preferably presents a member's personal messages organized in three folders, “New (in)”, “New (out)” and “Opened” (See Note 66). (Unlike the content presented when selecting the other tabs which is dependent on the selected community messages are preferably only associated with the member.) Preferably, the presence of unread messages is indicated by the flashing envelope icon on the Messages tab.

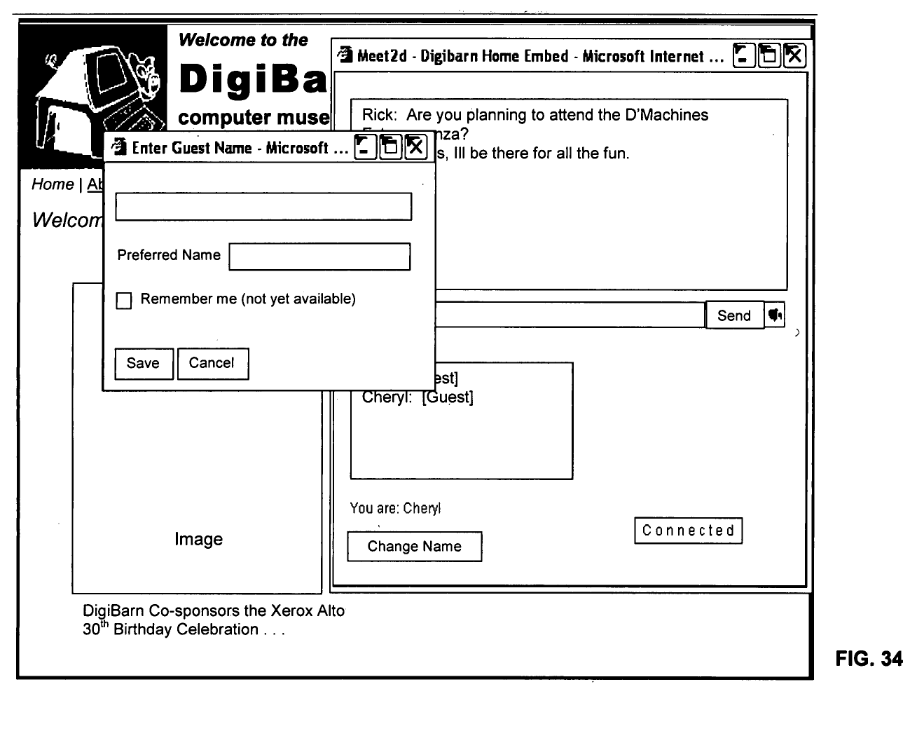

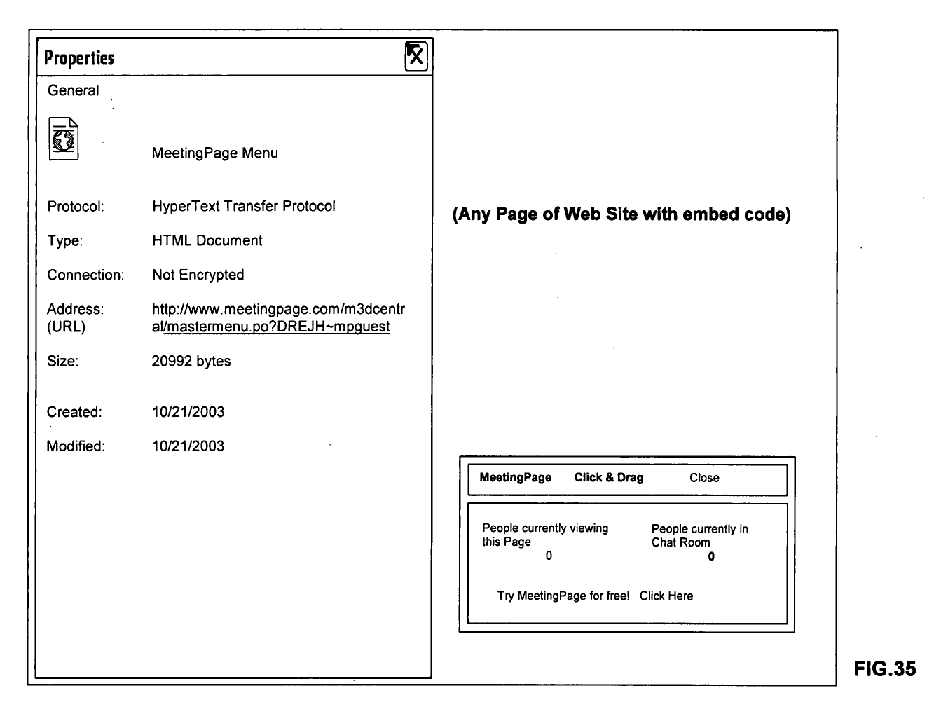

Preferably, selecting a message from the list presents the message to the member as illustrated in FIG. 30. A member may preferably reply to a message with a new message, optionally also sending the reply to the sender's email address, and optionally inviting the sender to an instant meeting, if the sender is currently online. FIG. 31 illustrates the options preferably available to a member when replying to a message.

Preferably, selecting the “New (in)” folder the member is shown all unopened messages. Selecting the sender's name presents the new message as shown in FIG. 30. The amount of time that has passed since the message arrived is preferably displayed to the right of the sender's name. Upon closing the original message, it is automatically move to the member's “Opened” message archive. If the checkbox Remove from “New (in)” mailbox, is turn off opened messages may be kept in the In box.

Preferably the selecting the “New (out)” folder lists all of a member's outgoing messages that have not yet been read by their recipients.

Preferably selecting the “Opened” folder presents sub-folders labeled: “Date”, “Sender/Receiver” and “Subject” as shown in FIG. 29. All messages sent and received by a member are preferably present to the member organized and presented by each in the manner selected by date, by sender/receiver or by subject.

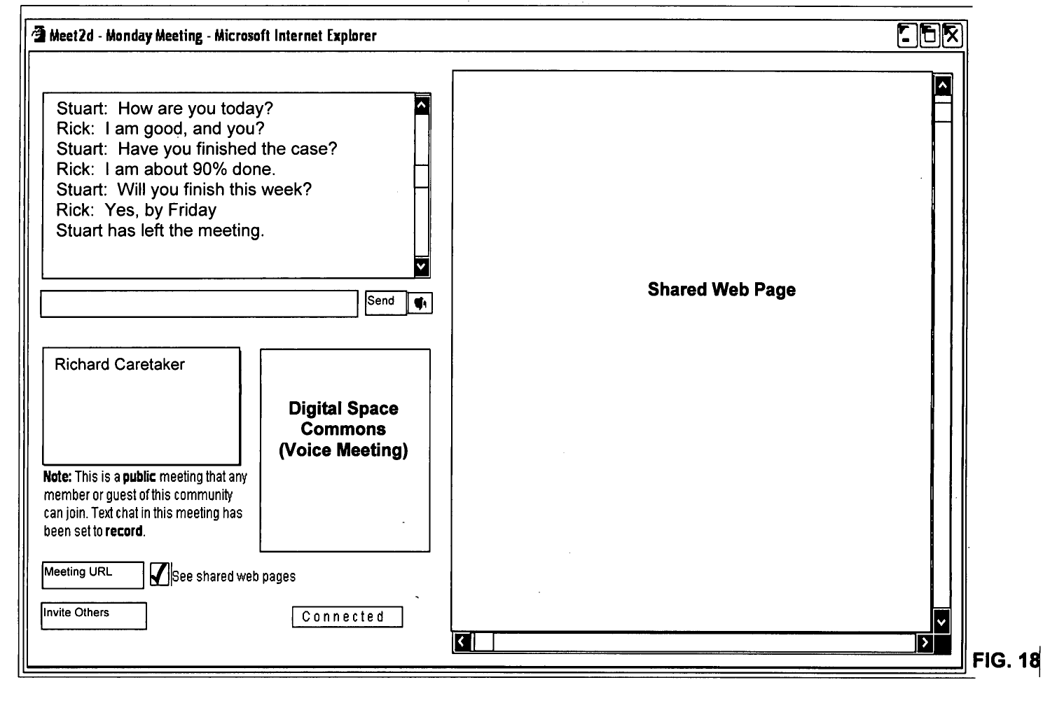

According to a preferred embodiment of the present invention, in the process Attend Meetings 426, a member preferably selects the fourth tab from the left on the navigation bar as shown in FIG. 13 which is the Meetings tab. As illustrated in FIG. 16, folders for Meetings in Session, Private Meetings and Public Meetings are presented to the member. Selecting the Meetings in Session folder presents a list of all meetings in the community that are currently underway. Selecting a meeting listed will preferably allow the member to join the meeting, if it is public as shown in FIG. 17 (See Note 137). Preferably, private meetings are not available to members without a specific invitation via messaging (See Note 63; See Note 64; See Note 91; See Note 92; See Note 108; See Note 123).

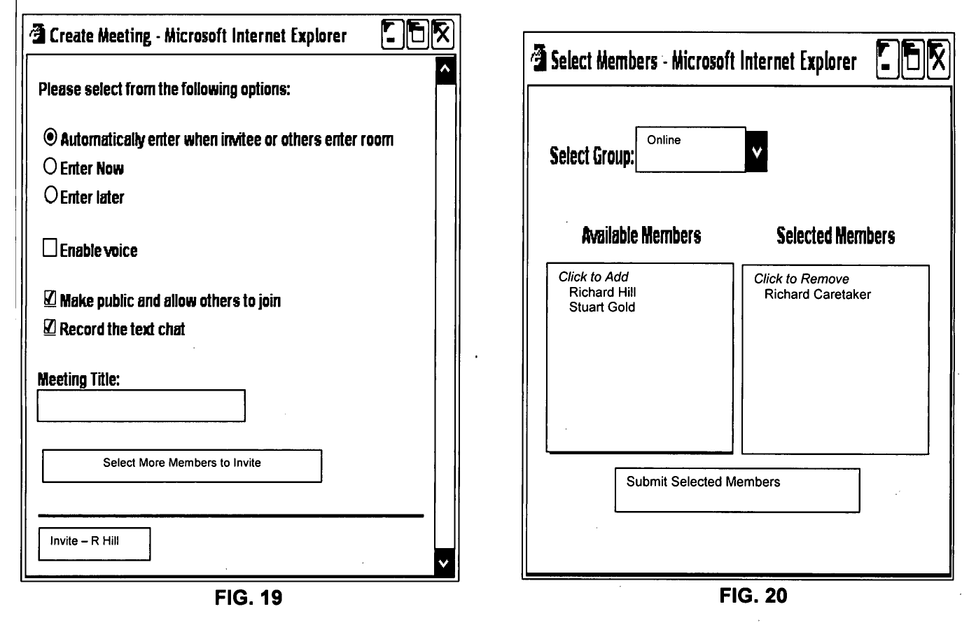

According to a preferred embodiment of the present invention, a private or public chat with another member of the community may be initiated by selecting the name of the member who is shown as “Currently online” under the Members tab. Preferably selecting the member's name initiates the “Send Message” popup. Preferably, the member will then select the “Invite to Meeting” option, fill in the Subject and Message boxes, and select Send. As illustrated in FIG. 18, meetings may be conducted using the voice-over-Internet feature by selecting the “Join Voice Meeting” text link (See Note 99; See Note 100; See Note 101; See Note 102; See Note 103; See Note 104; See Note 105; See Note 111).

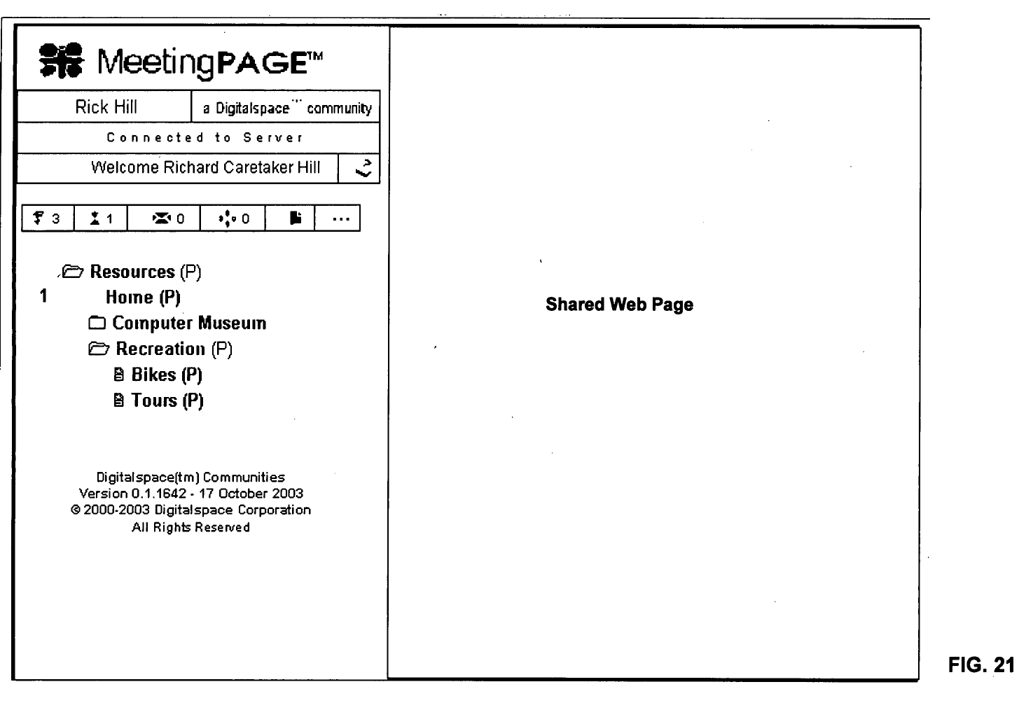

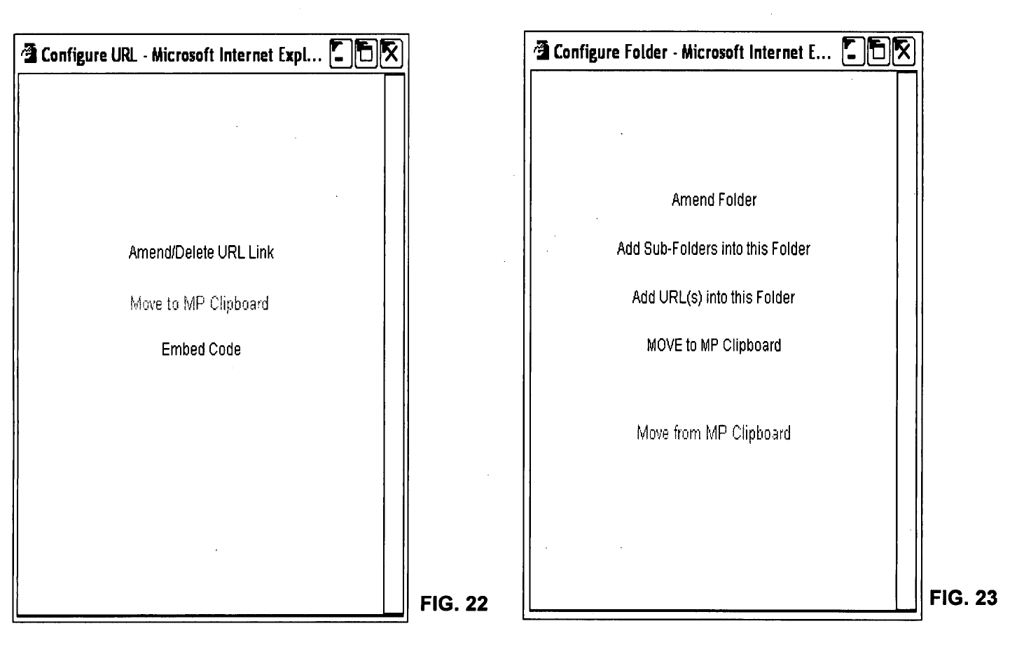

Preferably a member may also establish meeting parameters and identify the members to be invited as illustrated in FIG. 19 and FIG. 20 (See Note 109).

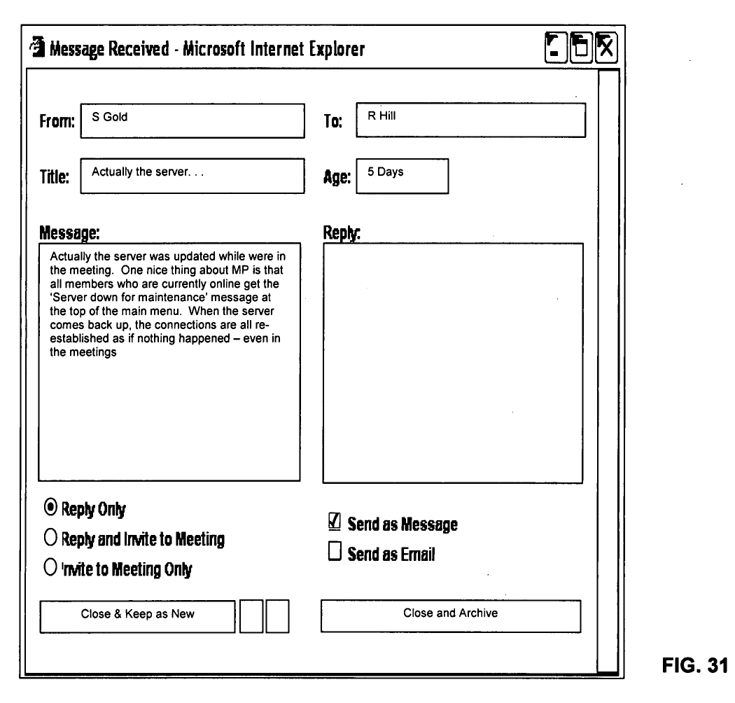

According to a preferred embodiment of the present invention, in the process Resource Sharing 428, a member preferably selects the fifth tab from the left on the navigation bar as shown in FIG. 13 which is the Resources tab. As illustrated in FIG. 21, it is signified with a page icon. Preferably selecting this tab presents the community's shared web-based resources, including monitored and other web pages and other assets (See Note 27). Preferably, this is a large, cooperatively built set of bookmarks to web pages. Preferably, the resources are organized as a hierarchical tree and selecting a desired folder will present other subfolders or resources (See Note 8; See Note 114). Preferably, selecting a resource name will launch that resource in the right hand portion of the screen replacing the member's community home page. Preferably, as noted earlier when a member is “on” a resource, such as a web site, the other online members of the community can tell what the member is viewing and join the member there as illustrated in FIG. 27.

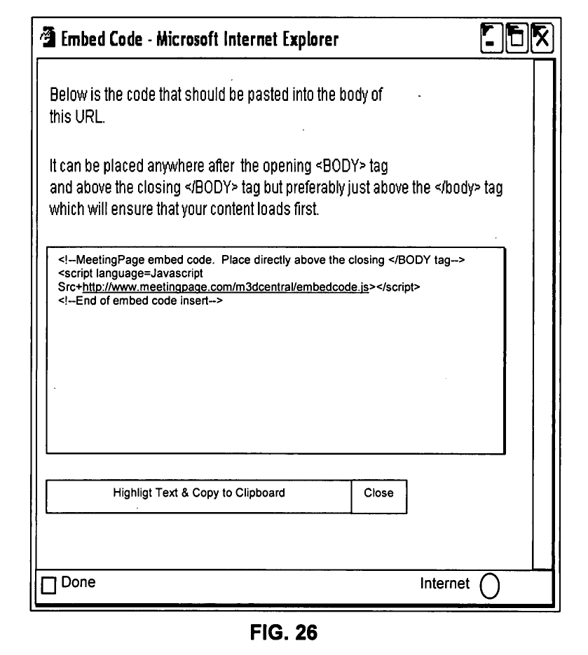

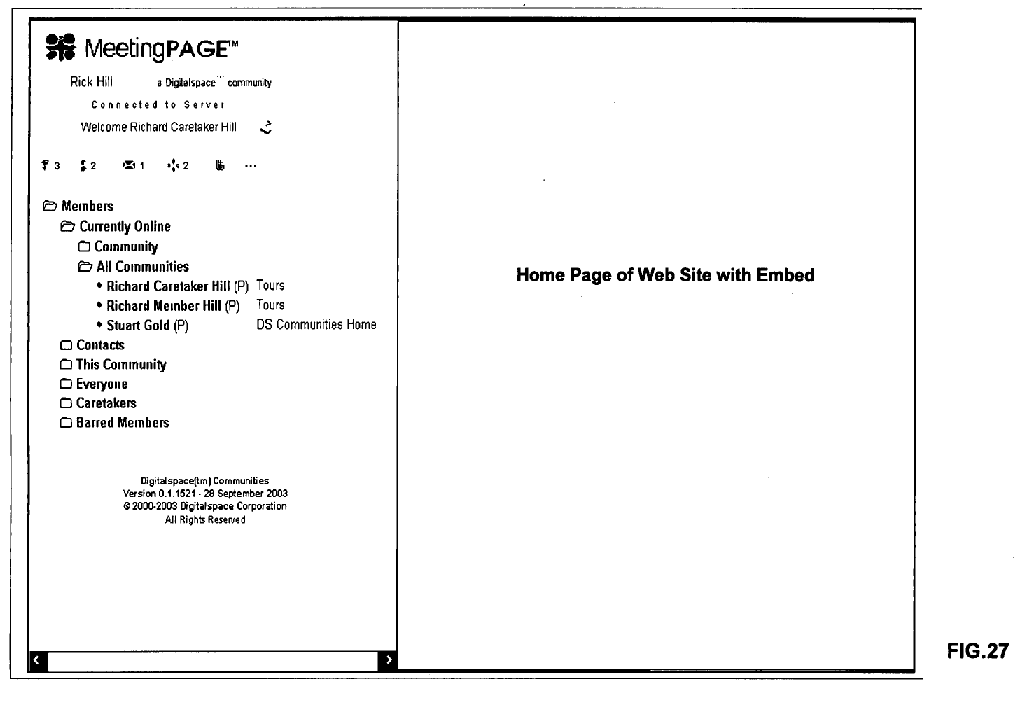

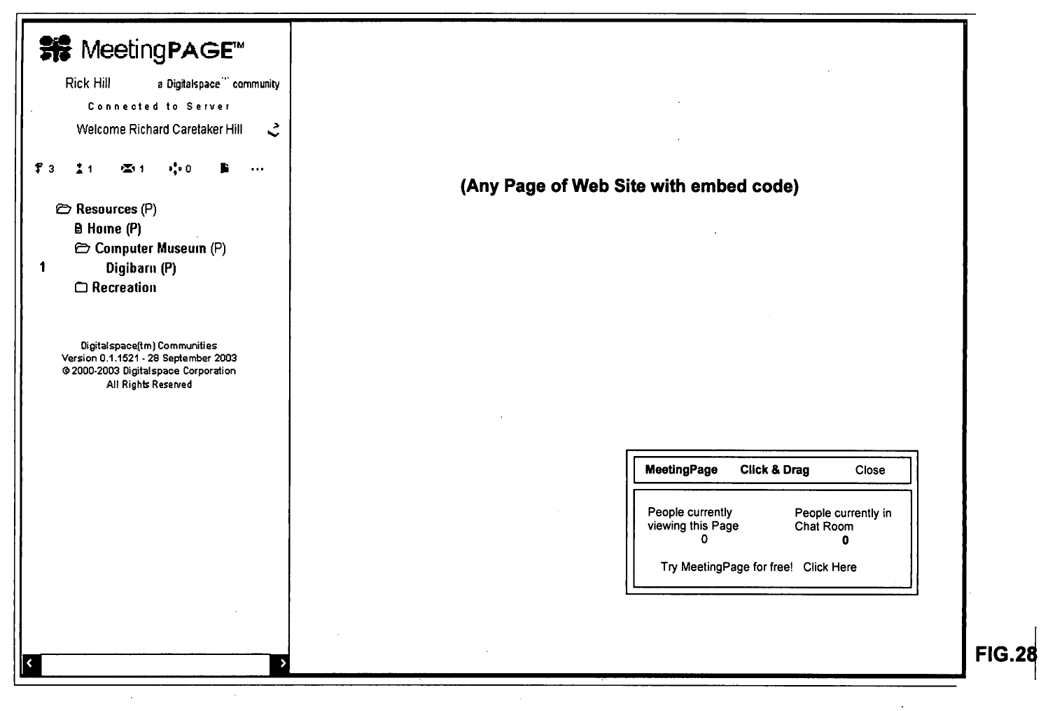

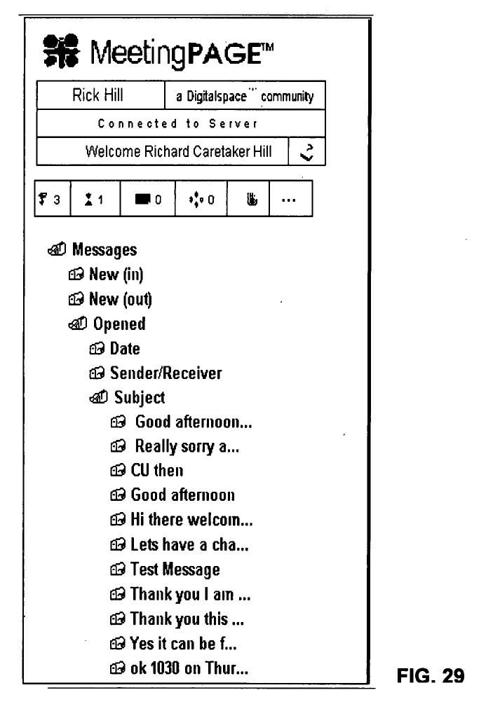

According to a preferred embodiment of the present invention, a member may find, and add, web pages that can be displayed in the right frame. Preferably, selecting the Resources folder displays the Home folder and any subfolders under it, as illustrated in FIG. 21. Preferably, the first subfolder is Member Pages which are preferably organized into subfolders for each member of the community. Preferably, members may add their own subfolder by selecting the (P) next to Member Pages and clicking on “Add Sub-Folders into this Folder” as shown in FIG. 23 and FIG. 24. Once the member's subfolder is created selecting the (P) next to it preferably allows the member to add URLs for Resource Web Sites 403 to the list under the member's subfolder as illustrated in FIG. 22 and FIG. 25 (See Note 11; See Note 12).

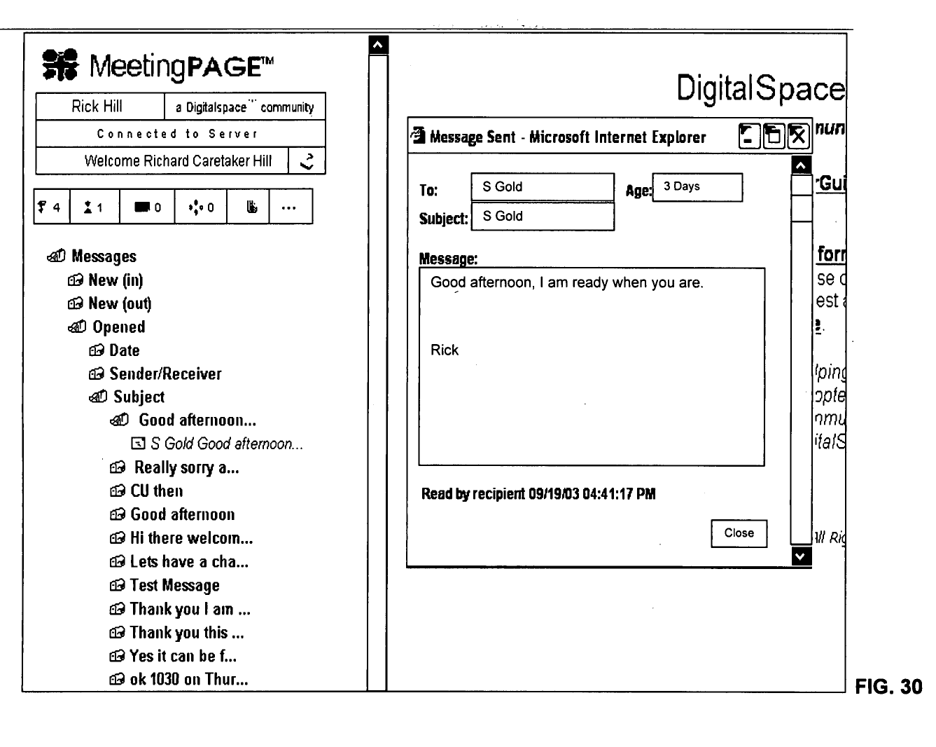

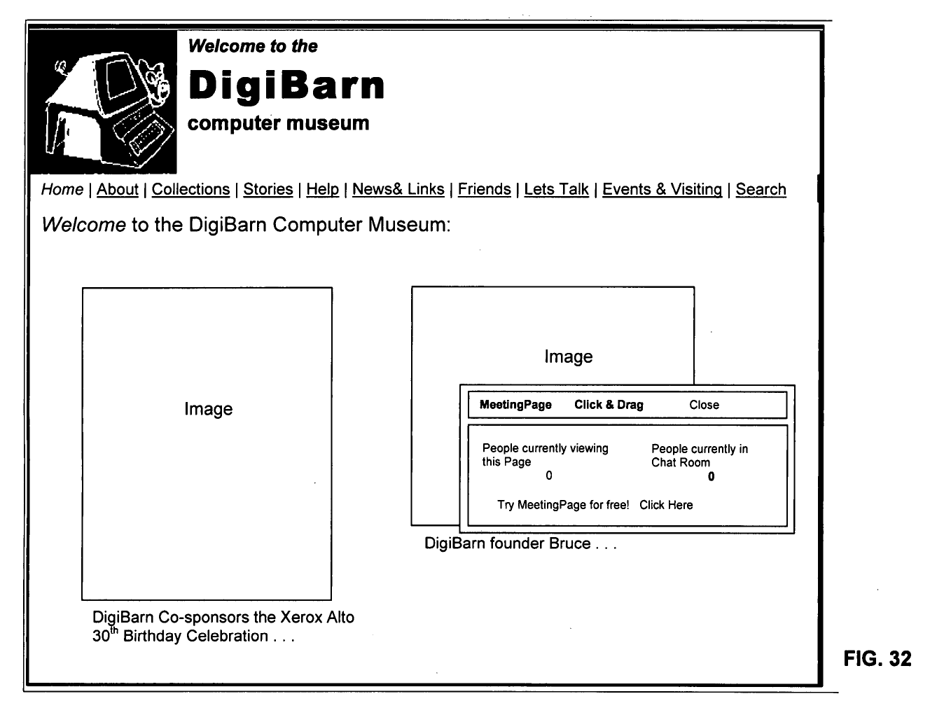

According to a preferred embodiment of the present invention, with permission of the licensee a member who is a caretaker may implement web site monitoring of the member's home page. Preferably, licensee “grants” permission to the requesting member by adding the web site URL into the monitored web sites database of the system. Preferably, the requesting member then will have the option to insert the necessary script, as shown in FIG. 26. The necessary script is available from the Configure URL menu, as shown in FIG. 22, which is accessed by selecting the (P) next to the Home subfolder. Preferably, after the member inserts the required script into one or more web pages of the selected web site the member will be able to monitor visitor activity on the web pages any time the member is logged in to the system, as well as any other visitor to the page. An example of monitoring web page activity is shown in FIG. 28.

Web Site Monitoring

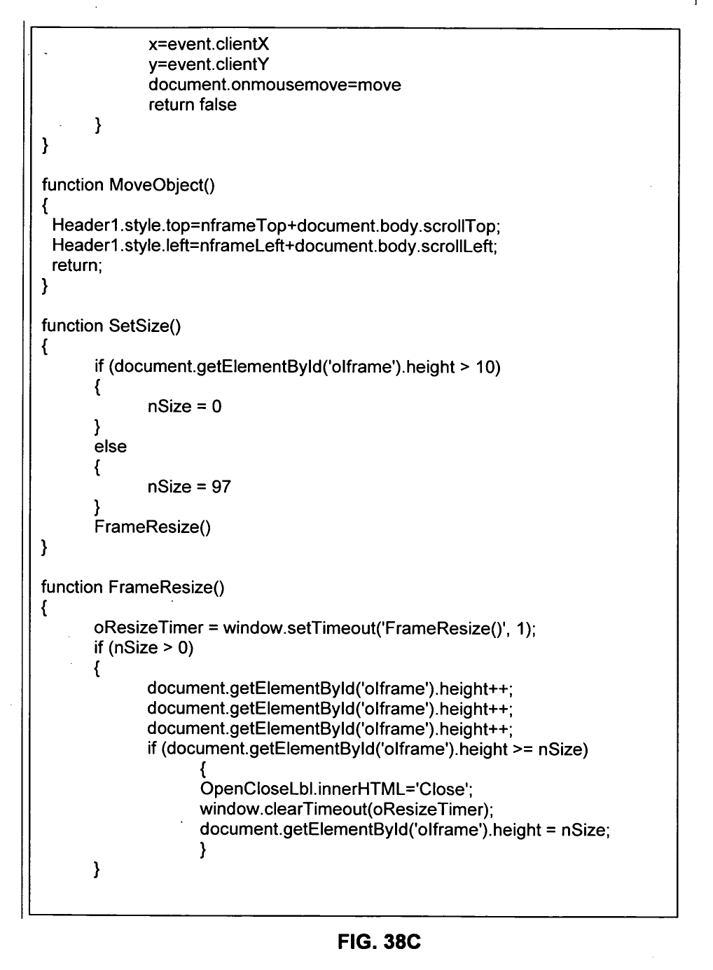

Referring now to FIG. 5, a diagrammatical overview of the set up, management and usage of the instant system for monitoring web site activity is presented. As shown in FIG. 5 the preferred communications medium is the Internet using http 130 (hypertext transport protocol) as preferred protocol. Initially, as depicted in the process Licensor Registers Licensee Web Site 504, preferably, licensor “grants” permission to the web site owner by adding the web site URL into the monitored web sites database of the system after receiving payment from Licensor (See Note 148). The Licensor Registers Licensee Web Site 504 process also includes inviting the licensor to be a community member as described above. Preferably, unless the web site URL is present in the monitored web sites database web site monitoring is not activated. Once the web site URL is added to the database the licensor may preferably add the required script to as many web pages of the web site as desired. An example of the preferred script 801 inserted into an existing web page is shown in FIG. 36 (See Note 69; See Note 70).

Once the licensee is a community member, preferably he or she may login and monitor activity on the “registered” web site in process Licensee Login and Monitor Traffic 508. As described above after logging in the licensee has the same privileges as all other community members. Preferably, subsequent to logging in licensee may join any ad hoc chat session as an anonymous visitor as shown in Licensee Joins Chat 510 (See Note 61; See Note 93; See Note 94; See Note 95; See Note 96; See Note 97; See Note 107). FIG. 28 presents an example of how a licensee may monitor visitor activity on a web page with the embedded script.

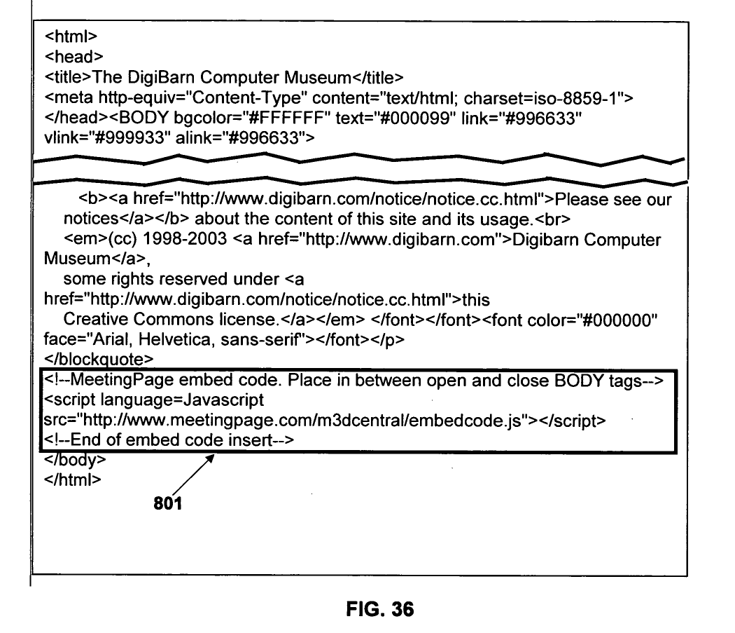

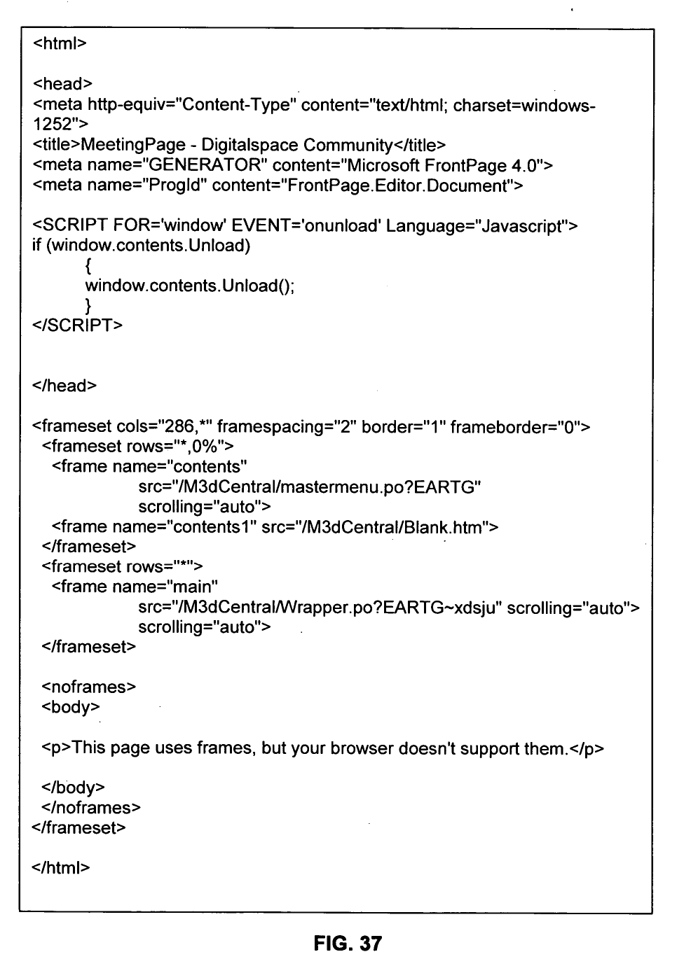

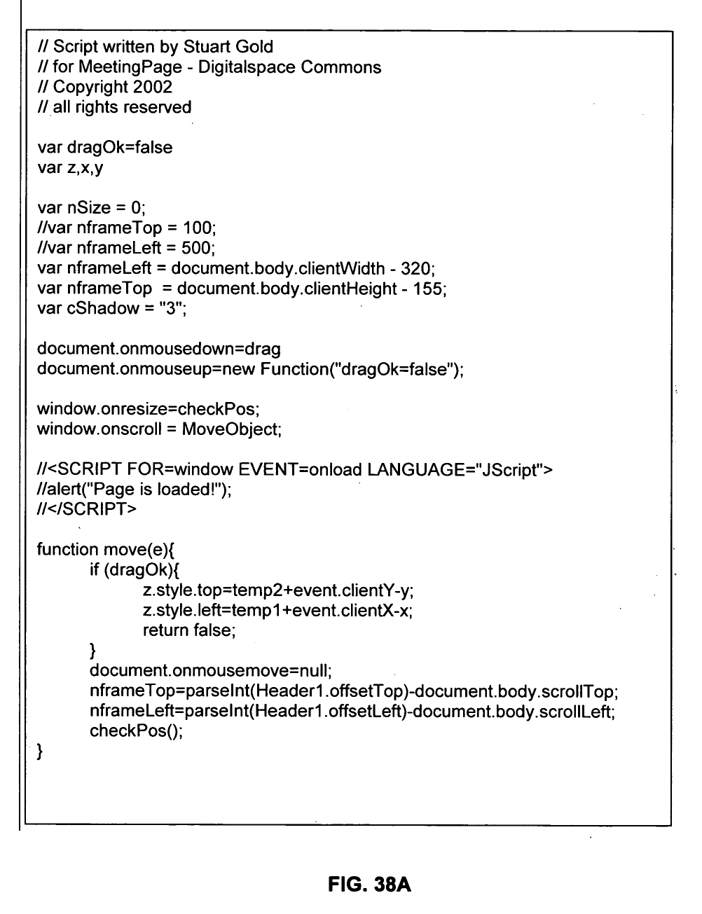

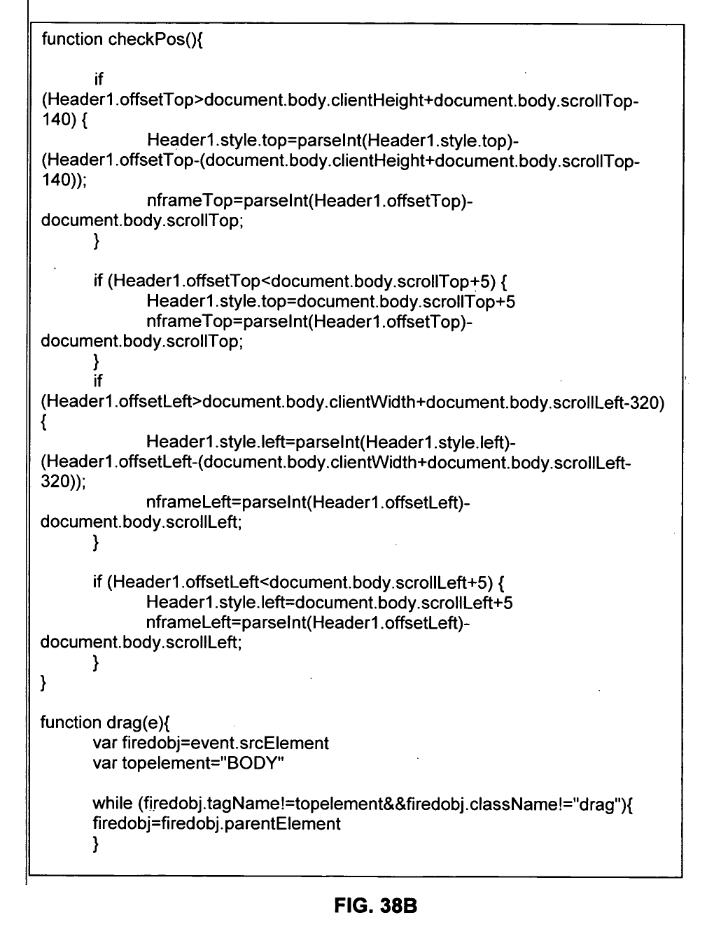

According to a preferred embodiment of the present invention, in the process User Views Page with Embed 520 a visitor to web page with the required script is presented a floating frame (on top of the web page) with real time counts of visitors and the invitation to chat anonymously with other current visitors to the web page as shown in FIG. 32 (See Note 25; See Note 26; See Note 30; See Note 31; See Note 54 See Note 55; See Note 56). In the process User Joins Chat 522, after selecting the count for the number of people currently in an ad hoc chat session the visitor is presented with the chat dialog as shown in FIG. 33. Preferably, the visitor is not required to login or otherwise provide any personal information to participate in the ad hoc chat session. As shown in FIG. 34, a visitor may choose to use “screen name” as a method of identifying himself or herself to the other visitors in the ad hoc chat session.

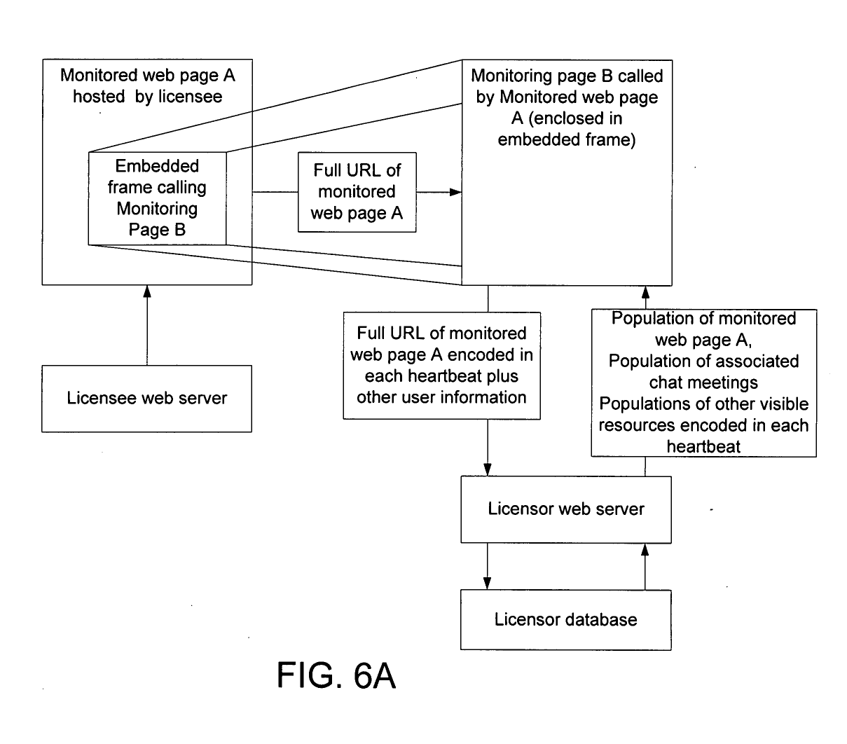

As shown in FIG. 6A, the Licensee's web page calls a script hosted on Licensor web server which then creates the floating frame. The script received from the licensor's web server then validates the URL of the licensee's web page. If the URL is valid and registered in the Licensor's database a “heartbeat cycle” is initiated. The heartbeat cycle manages communication from the licensee's web page to licensor's server using essential user data and the full URL designation of the licensee's calling page (See Note 38). Information provided by Licensor's web server to licensee's page contains any real-time information pertinent to the user such as waiting messages, population status of other resources and meetings. This process is described in more detail below.

Embed Processes

Referring now to FIG. 6B, a schematic overview of the web site monitoring method is presented. Preferably, implementation of web site monitoring, presentation of embedded frame and access to ad hoc anonymous chat sessions is accomplished without installation of software on users' computers or addition of extensive code to monitored web pages. In particular, implementation of monitoring of web pages preferably depends on the insertion of a single line of script 801 (which includes a URL link to the monitoring web site) as shown in FIG. 36 (See Note 59; See Note 60). As depicted in FIG. 6, the active monitoring of a web page begins with step Visitor Accesses Web Page 602 (See Note 77). When the monitored page is viewed by the visitor preferably in step Call to Server 604 a request is made to the Licensor's web server for the floating frame script which is used to communicate with the web server and present the current counts to the visitor (See Note 40; See Note 42).

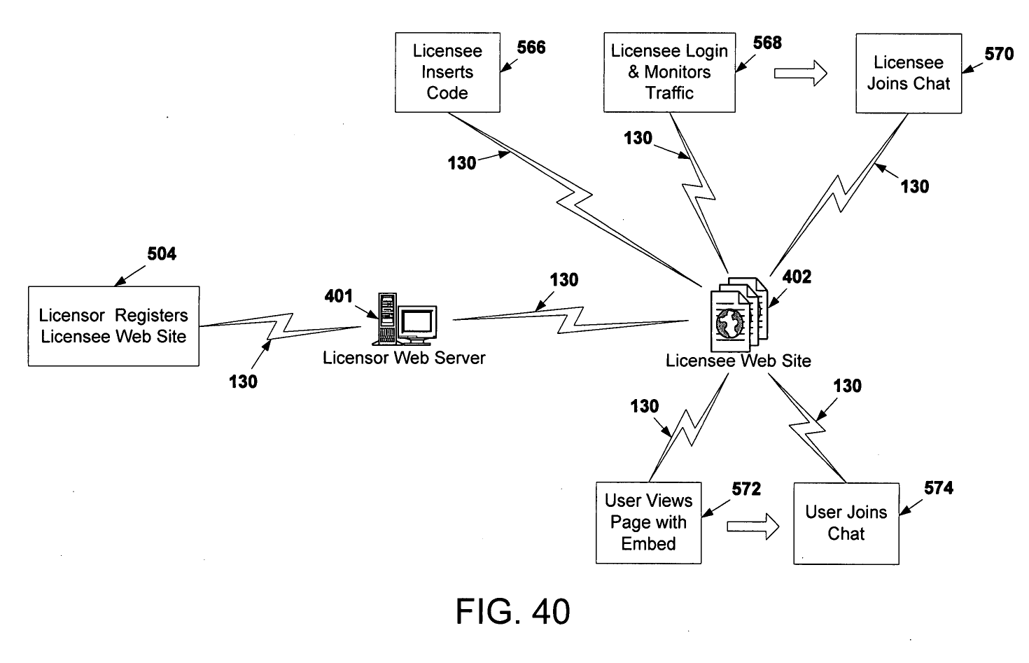

Preferably, when the script is received by the web page the monitor process 601 is started on the user's computer. An example of the preferred script is presented in FIG. 40A through FIG. 40E. Preferably, in step Send & Start Monitor 606 the script invokes a URL call to the licensor's web server which loads a web page into the frame embedded in the Licensee's web page. The URL in the embedded frame preferably sends back the full URL designation of the Licensee web page and communicates that to the Licensor's web server (See Note 43; See Note 44;). The URL designation of the Licensee web page is checked against a database of registered legitimate URLs and if the URL designation is registered the time driven cycle, as depicted by step Send Status 616, step Receive & Display Counts 618, step Count Time 622 and step Is Time UP? 624, will preferably commence in the embedded URL. At set intervals preferably the embedded web page will communicate to the Licensor's web server that the web page is still being viewed by this viewer and, in turn, it will preferably accept a stream of data back from the Licensor's web server relating to the number of other computers with the same Licensee's web page open in their web browsers and the number of users currently in a text chat meeting associated with this page or the overall web site of the Licensee. Preferably, the user can open a URL link to enter the text chat meeting and join any other users that are currently engaged in the same meeting as shown by step Visitor Goes to Chat 610 (See Note 28; See Note 98).

The monitor process 601 is a time driven cycle that sends the web server its current status in the step Send Status 616, then receives the count of all visitors and ad hoc chat participants from the server and displays the values in the floating frame in step Receive & Display Counts 618. Preferably, the process then counts the time since the last completion of the Send Status 616 step in step Count Time 622. In the step Is Time Up? 624, if the time count exceeds the pre-determined limit, usually five seconds, the time count is reset and control is passed to the step Send Status 616.

Preferably, when a visitor selects the chat link from within the frame as in step Visitor Goes to Chat 608 a chat session associated with the web page is started on the web server (See Note 82). Likewise, when the last visitor leaves the chat session, as in step Visitor Leaves Chat 610, it is closed on the web server and the count of participants in chat is reset to zero and the revised counts displayed in the next update cycle of the monitor process 601. Finally, when a visitor leaves the monitored web page, as in step Visitor Leaves Page 612, the monitor process 601 is stopped and removed from memory on the visitor's computer in step Stop Monitor 614 and no further server updates are made. Preferably, the web server resets the counts to zero for the web page after the connection is lost.

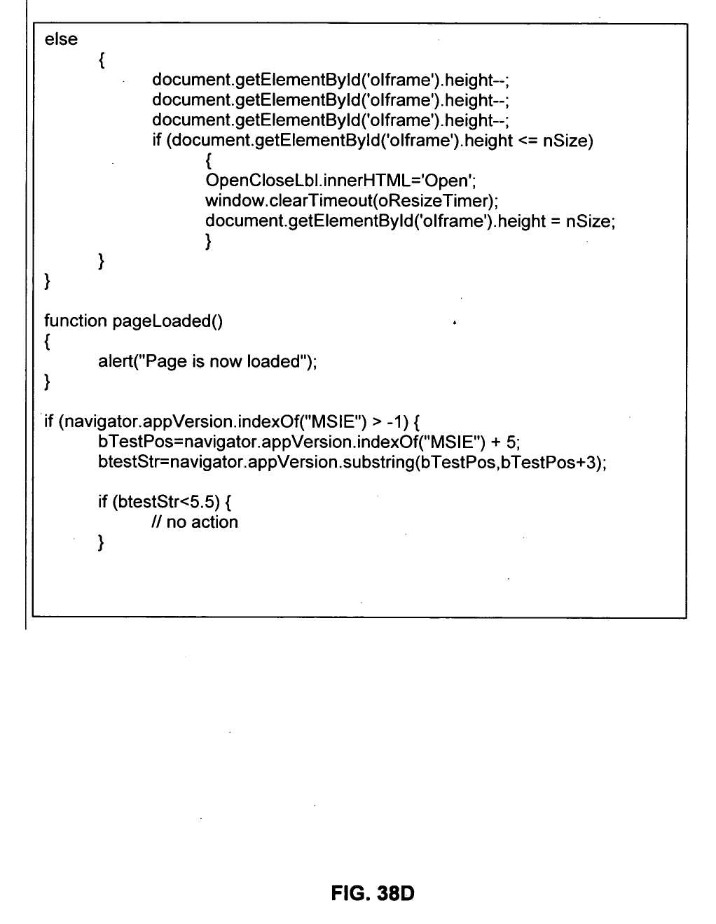

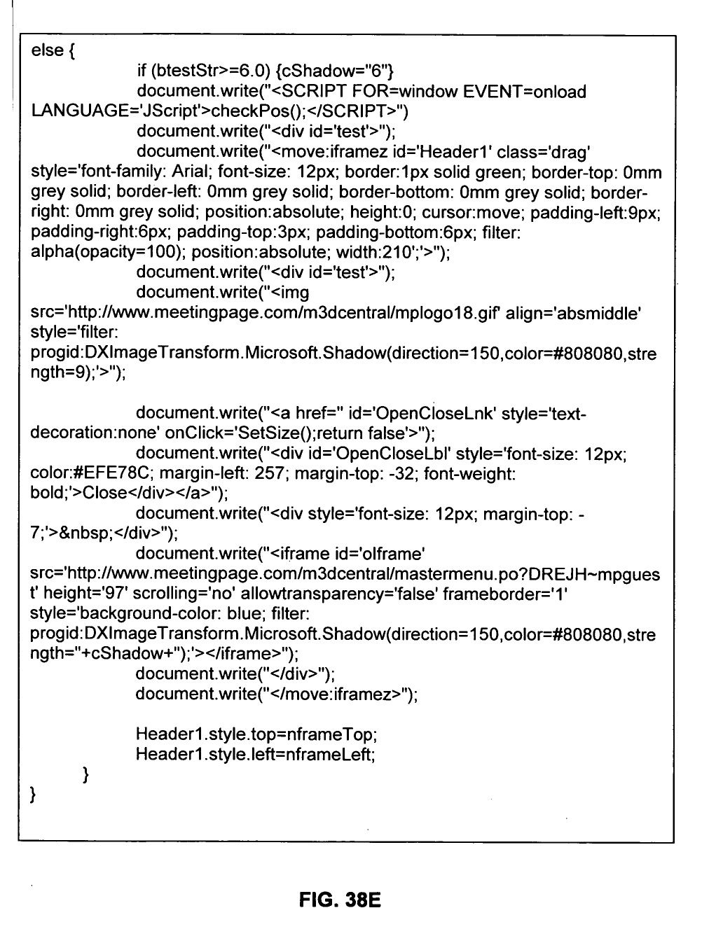

According to a preferred embodiment of the present invention, each instance of a visitor to a monitored web page is identified and tracked in the monitored web site database. An example of the scripting used to provide the required unique information to the monitored website database is shown in FIG. 37. Additionally, statistics regarding visits to each monitored web page are kept to facilitate reporting and analysis of activity on each monitored web page.

### Alternate Preferred Embodiment

In an alternate embodiment, preferably several additional functions are made available to visitors to, and the webmasters of, enabled web sites. In particular, the functions made available to enabled web sites, and therefore visitors to the enabled web pages of the enabled web site, in the above describe preferred embodiment of the present invention, rather than only as part of the community web site 210. These functions and their behaviors are described more fully below. Preferably, the additional functions made available as part of an alternate preferred embodiment rely on the methods and concepts taught and disclosed in the preferred embodiment of the present invention.

Referring to FIG. 40, a diagrammatical overview of the usage and set up of web activity monitoring and ad hoc chat usage using the instant system according to an alternate preferred embodiment of the present invention. As shown in FIG. 40, the preferred communications medium is the Internet using http 130 (hypertext transport protocol) as preferred protocol. Initially, as depicted in the process Licensor Registers Licensee Web Site 504, preferably, licensor “grants” permission to the web site owner by adding the web site URL into the monitored web sites database of the system located on the Licensor Web Server 401. Preferably, unless the web site URL is present in the monitored web sites database web site monitoring is not activated. Once the web site URL is added to the database the licensor may preferably add the requited script to as many web pages of the web site as desired as shown in step licensee inserts code 566. An example of the preferred script 801 inserted into an existing web page is shown in FIG. 36.

Once the licensee (or designated web site operators or managers) is registered, web site monitoring activated and the preferred code is inserted into one or more web pages of the licensed web site, preferably he or she may login and monitor activity on the “registered” web site in process Licensee Login and Monitor Traffic 568. As described above after logging in the licensee may monitor web site activity, join a chat session, request a chat session with a selected visitor, respond to request for chat from a visitor or access the maintenance and management tools associated with the licensed web site (See Note 33; See Note 85). Preferably, subsequent to logging in licensee may join any ad hoc chat session as shown in Licensee Joins Chat 570. FIG. 28 presents an example of how a licensee will monitor visitor activity on any web page with the embedded script. According to an alternate preferred embodiment of the present invention preferably, licensee monitoring will access the maintenance and monitoring tools from licensee's web site 402 through a URL link to the monitoring tools page (See Note 35; See Note 51). Preferably, the maintenance and monitoring tools reside on the licensor web server 401

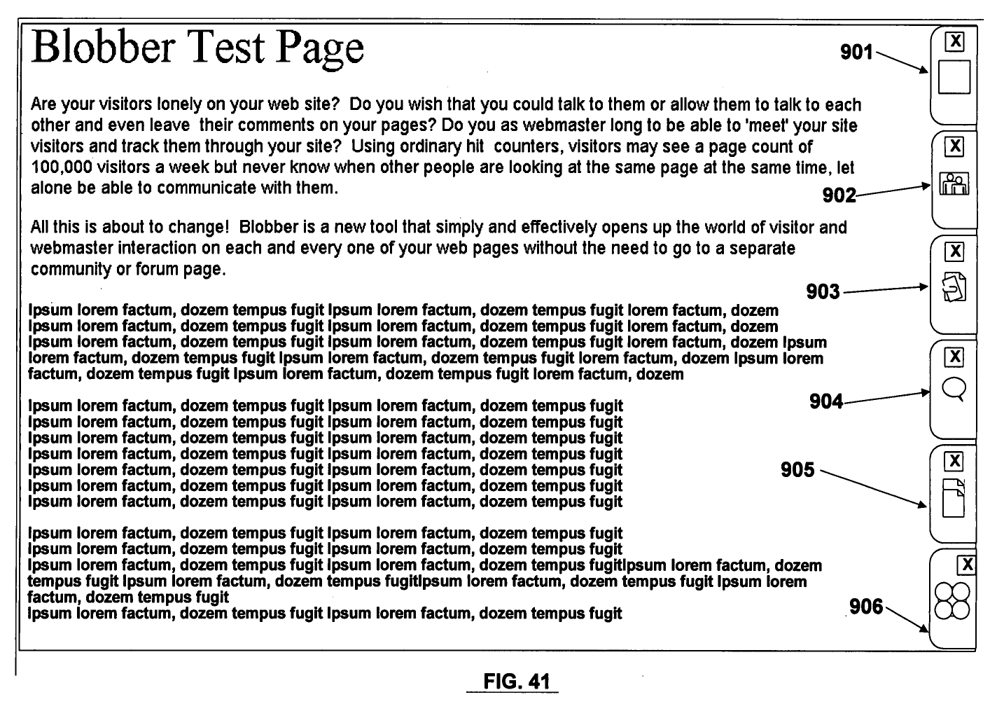

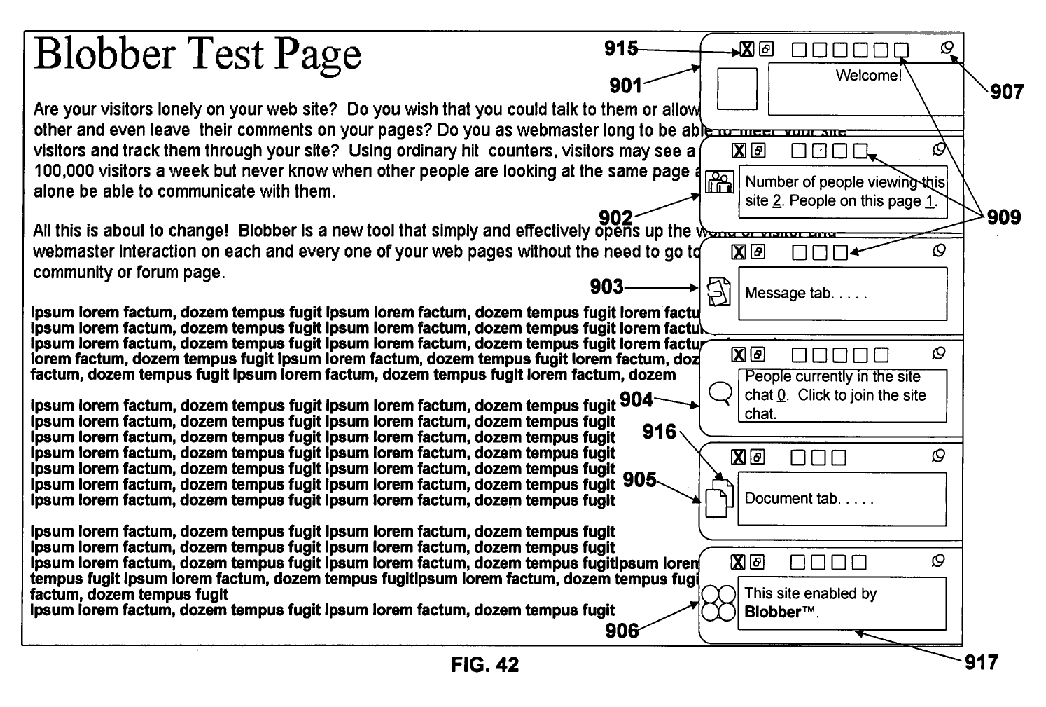

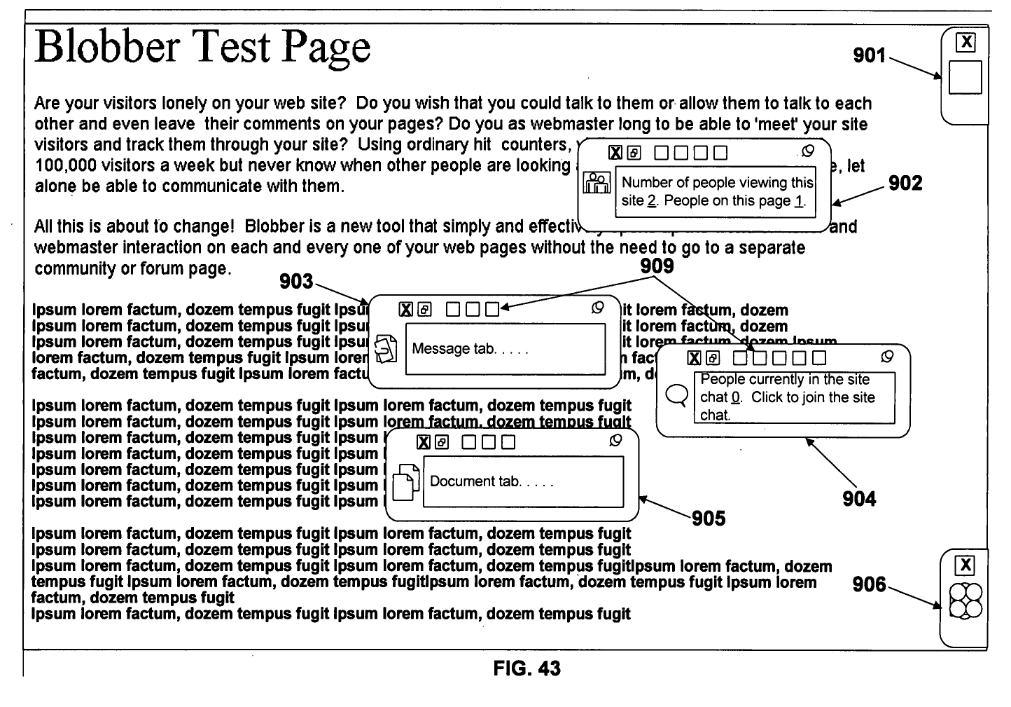

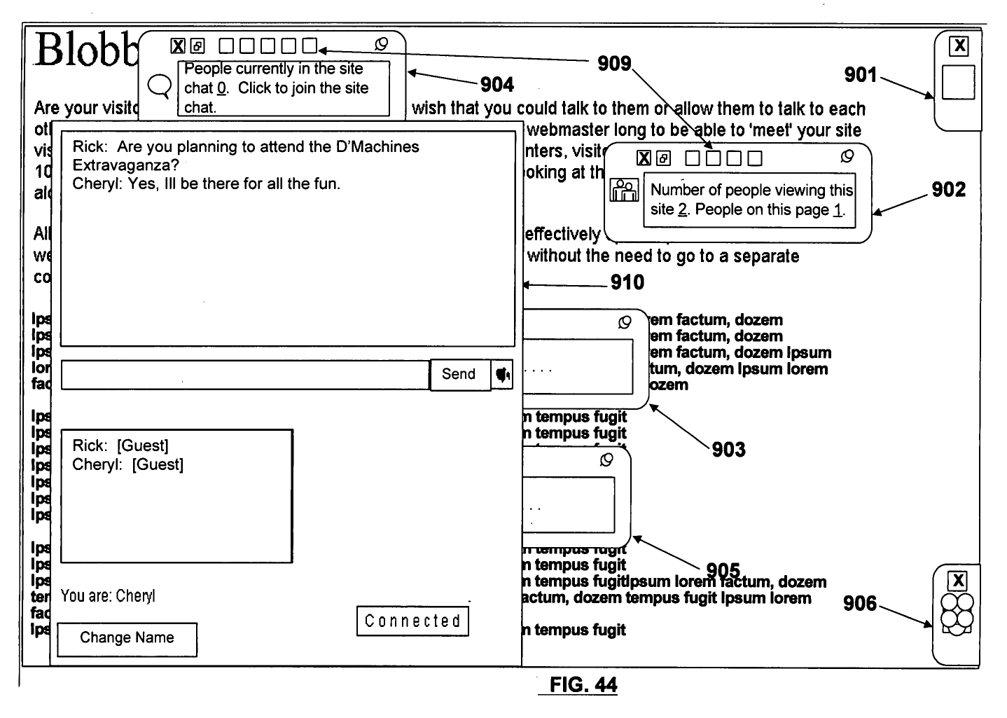

According to a preferred embodiment of the present invention, in the process User Views Page with Embed 572 a visitor to web page with the required script is presented with one or more tabs (or windows) which are contained the overlay the web page (See Note 52; See Note 83; See Note 84). Preferably, from one to six tabs may be present in one of three states as decided by the licensee. Preferably, first, any visible tab may be minimized to the screen margin; second. Any visible tab may be maximized, but at the screen margin; or, third, any tab may be maximized, but “floating” at any location on the web page. Examples of these three states are shown in FIG. 41, FIG. 42 and FIG. 43 respectively. In the process User Joins Chat 574, preferably the user selects the count for the number of people currently in an ad hoc chat session (which is also the URL for the ad hoc chat session) which is shown on Chat Tab 904 (see FIG. 42 and FIG. 43) and is presented with the chat dialog as shown in FIG. 44 (See Note 53). Preferably, the visitor is not required to login or otherwise provide any personal information to participate in the ad hoc chat session. Preferably, any visitor may choose to use “screen name” as a method of identifying himself or herself to the other visitors in the ad hoc chat session by selecting the Change Name button. FIG. 34 presents a preferred example of the Change Name dialog.

As shown in FIG. 6A, preferably the Licensee's web page calls a script hosted on Licensor web server which validates the URL of the licensee's web page. If the URL is valid and registered in the Licensor's database, preferably a “heartbeat cycle” is initiated and then the tabs are displayed on the visitor's screen on top of the web page being viewed by the visitor. The heartbeat cycle preferably manages communication from the licensee's web page to licensor's server using essential user data and the full URL designation of the licensee's calling web page. Information provided by Licensor's web server to licensee's page contains any real-time information pertinent to the user such as waiting messages, population status of other resources and meetings or other information as determined by the licensee through the maintenance and management functions. This process is described in more detail with reference to FIG. 6B.

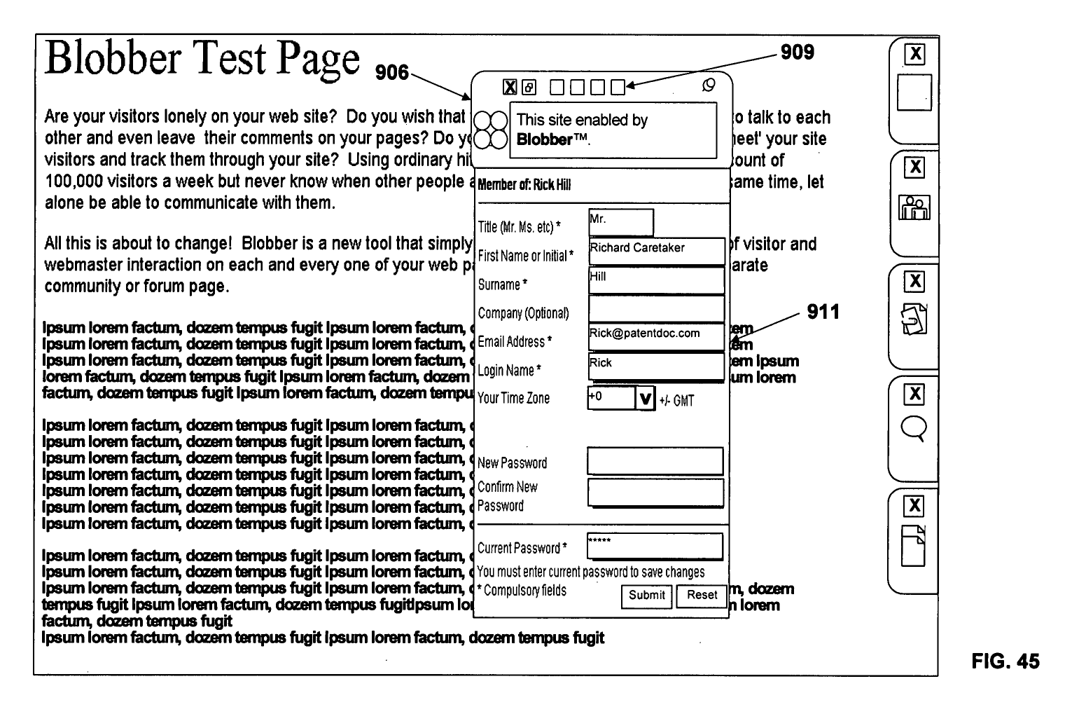

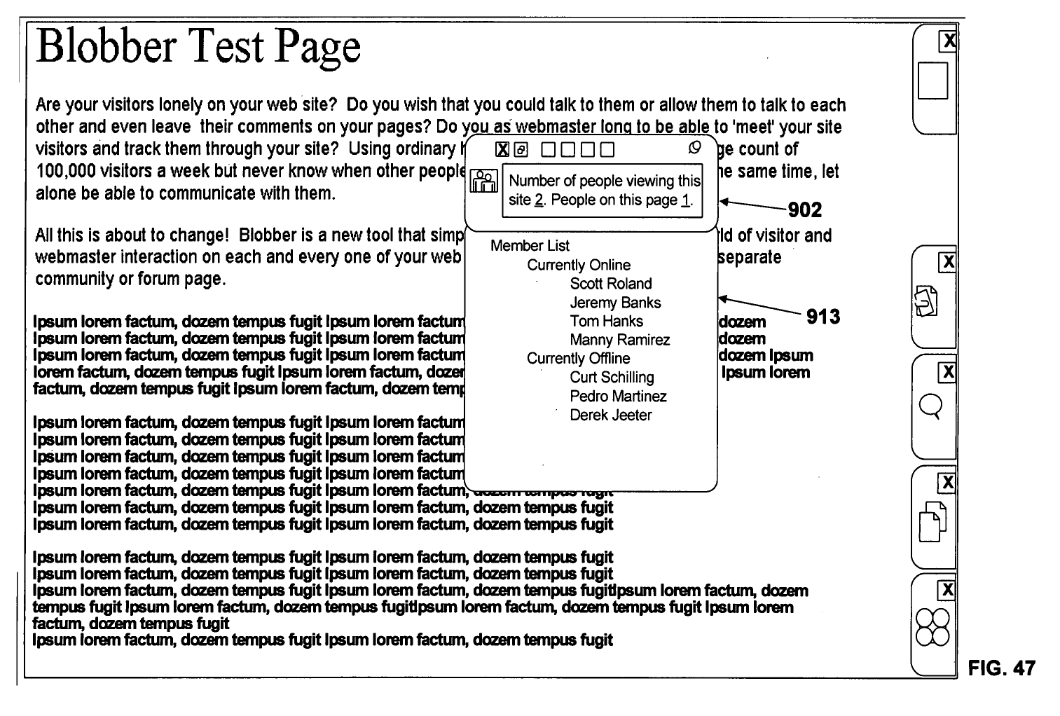

Referring to FIG. 41, a diagrammatical view of the preferred embedded tabs screen providing selectable tabs to a visitor to an enabled web site, according to an alternate preferred embodiment of the present invention, is demonstrated. According to an alternate preferred embodiment of the present invention, a visitor to an enabled web site will be presented with the underlying display of the enabled web site overlaid with from one to six tabs displayed at one of the margin of the page. Preferably each tab is dedicated to a specific function which is more completely described with reference to FIG. 42. Preferably, general tab behaviors include, but are not limited to:
Each tab is preferably positioned by default in the right hand margin of the screen.
Each tab is preferably translucent until the mouse pointer is placed over it, (the opacity level will preferably be customizable by an authorized web site manager or operator).
Each tab will preferably become opaque when the mouse pointer is over it.
Each tab will preferably slide out partway onto the page into the “open position” when selected.
Each tab in the “open position” may preferably be ‘pinned’ into the “open position” by selecting the push pin 907 which stops the tab from sliding back into the margin when the mouse cursor moves away.
Each tab will preferably contain information pertaining to its function.
Each tab will preferably contain one or more of function buttons 909 along the top.
Each function button 909, when selected, preferably will force the tab to detach from the margin, reposition itself on the visitor's screen and cause a dialog box to appear below it, as illustrated in FIG. 44, FIG. 45 and FIG. 47. Each function button is preferably related to different dialog containing the specific information or feature relating to the function button 909 selected.
Each tab in the “open position may be repositioned to any location on the screen by the visitor.
Each tab in the “open position can preferably be repositioned at the screen margin by selecting the minimize button or by repositioning the tab at the screen margin.

According to an alternate preferred embodiment of the present invention, all enabled web site visitors are preferably anonymous and given sequential names such as guest-1 and guest-2, etc. (See Note 149). Preferably, an alternate preferred embodiment supports a membership mode option which enables people to opt in and become registered users of the enabled web site; in which case they will preferably either have to sign in each time or be remembered using a site cookie (See Note 150). All membership information will preferably be stored in a database associated with the licensee's web site on licensor web server 401 according to an alternate preferred embodiment of the present invention and preferably does not require any special functions on the enabled web site.

According to an alternate preferred embodiment of the present invention, the alternate preferred interface (as shown in FIG. 41, FIG. 42, and FIG. 43) has features that preferably leverage interactivity between visitors and between visitors and site operators. Preferably, each tab has five definable states that can be defined and stored as defaults in the database associated with licensee's web site and which are used to initially present the tabs to a visitor on initial viewing of the web page (See Note 24). Preferably the first four states can be altered by the visitor when viewing the web page (See Note 36; See Note 110):
1. Tab parked (minimized) at screen margin as shown in FIG. 41 (See Note 73; See Note 112).
2. Tab open (maximized temporarily) at screen margin as shown in FIG. 42 (See Note 76; See Note 106).
3. Tab open (maximized “pinned” open) at screen margin as shown in FIG. 42 (See Note 86).
4. Open tab floats to any screen location selected by user as shown in FIG. 43 (See Note 113; See Note 138).
5. Tab fixed and variable content may be changed (See Note 74; See Note 75).

According to this alternate preferred embodiment of the present invention, these states will preferably be programmed by the web site operator using web forms or wizards that enable rules to be preferably stored in a database which is preferably accessed by rules engine that is preferably used to control how each tab behaves when a visitor is on a selected web page (See Note 80; See Note 81; See Note 135; See Note 136).

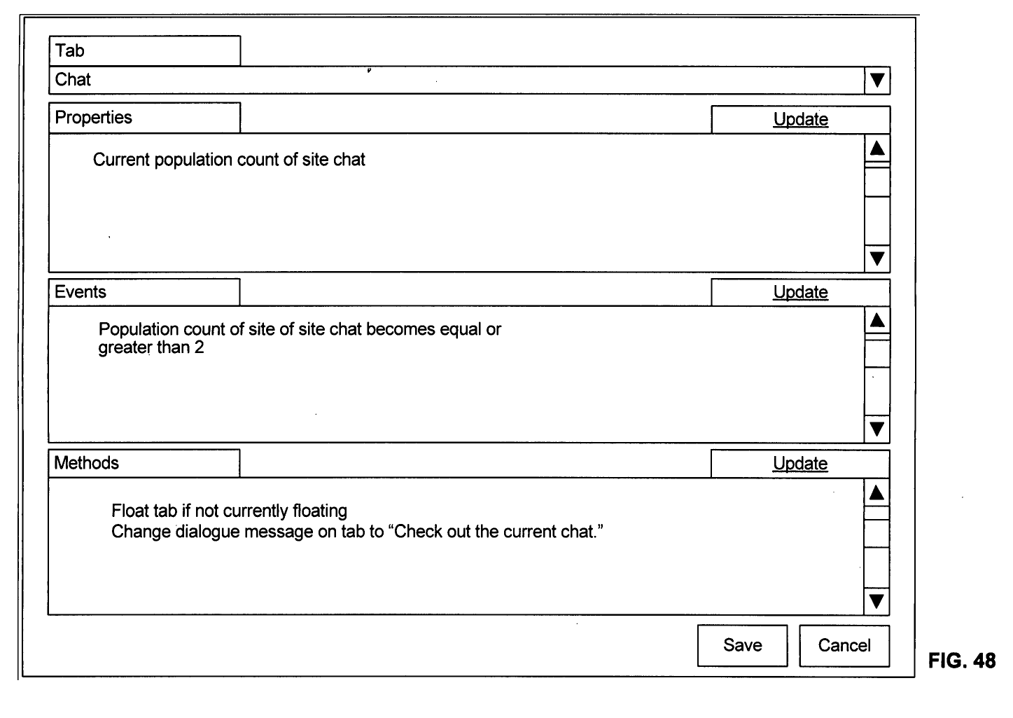

According to an alternate preferred embodiment of the present invention, the rules engine and related database will preferably control each tabs behavior by referencing Properties, Events and Methods related to each tabs overall purpose as described with reference to FIG. 42. Properties, Events and Methods related to each tab preferably will be exposed to each authorized site operator via the relevant web forms or wizards (see FIG. 48 for an example). Preferably by building a list of rules from the Properties, Events and Methods related to each tab a site operator will program the behavior and content of each tab for different situations and save them to the database (See Note 89; See Note 90; See Note 115; See Note 116; See Note 117; See Note 118; See Note 119; See Note 120; See Note 121; See Note 122; See Note 158; See Note 159).

Examples of Properties for rule design preferably include, but are not limited to:
Elapsed time a visitor is on the web site and/or enabled web page
Number of previous visits by a member to web site and/or enabled web page
Accumulate and display the current count of visitors to monitored web site and/or enabled web page (See Note 1; See Note 3; See Note 32)
Accumulate and display the current count of visitors engaged in web site chat or enable web page chat (See Note 2)
Accumulate and display previous web page and web site visits (See Note 165)
Current time and date
Type of visitor (anonymous or member)
Presence of web site operator on web site and/or enabled web page
Presence of web site operator in site web site chat or enabled web page chat
Number of messages posted to site
Tab opacity level when closed
Tab visibility (See Note 71; See Note 72)

Examples of Events for rule design preferably include, but are not limited to:
Visitor's first visit to web site and/or enabled web page
Visitor's subsequent visit to web site and/or enabled web page
Elapsed time on web site and/or enabled web page greater than x seconds (See Note 57; See Note 58)
Population count of web site and/or enabled web page becomes equal or greater than x (a value that is modifiable)
Population count of web site chat and/or enabled web page chat becomes equal or greater than xx (a value that is modifiable)
Web site previously visited is one included in a stored list)
A web site operator is on web site and/or enabled web page
A web site operator enters web site and/or enabled web page
Current date/time is equal to or greater than x (a value that is modifiable) (See note 50)
New message posted to web site and/or enabled web page
Number of messages posted to web site and/or enabled web page is equal or greater than x (a value that is modifiable)
One or more members are on the web site and/or enabled web page

Examples of Methods for rules design preferably include, but are not limited to:
Open tab if not currently open (parked at screen margin)
Force tab to stay open if not currently open
Reposition open tab away from screen margin, if not currently repositioned
Change dialogue message on tab to xxxx (a value that is modifiable) (See Note 21)
Hide one or more tabs
Show one or more tabs
Produce a sound (See Note 143)
Change image in Web Master tab 901 (See Note 39)
Send messages, Emails or Instant Messages (IMs) to web site operator or member (See Note 155; See Note 156; See Note 157)

According to an alternate preferred embodiment of the present invention, examples of rules that could be programmed include, but are not limited to:
On entering a site for the first time, the database instructs the Web Master tab 901 to slide into the open position with appropriate welcome text for a new visitor.
For a return visitor the tab doesn't open or it opens with an appropriate message.
When the number of visitors to the web site and/or a selected enabled web page reaches a pre-determined number, the Web Master tab 901 opens with appropriate message or the Chat tab 904 opens with a message encouraging the current visitors to join the web site chat and/or enabled web page chat.
When a web site operator enters a web site, the Web Master tab 901 opens with an appropriate message on the screens of all visitors currently on that enabled web page. In addition, the graphic image changes in real-time to show the picture or other representation of the site operator.
When a new message is posted to a web site and/or enabled web page the Message tab 903 opens with an appropriate message describing the event.
When a web site operator enters a chat session, the URL link on the chat tab becomes active enabling current site visitors to join the chat session. (This function can be enabled if it is decided that all public chat sessions must be moderated by a web site operator.
Chat function is enabled for pre-defined times or days.
When a visitor is on an enabled web page for longer than a pre-determined time, the Web Master tab 901 opens with an appropriate message.

In addition, a site operator or manager of the selected web site may preferably initiate chat session exclusively with one or more visitors to the web site or web page by completing a web form with a text announcement that will preferably appear immediately in the Web Master Tab 901 on the screens of current visitors to the enabled web site or web page (See Note 132; See Note 133; See Note 134). Additionally, a site operator will preferably be able to instruct the Web Master Tab 901 to open, stay pinned open or to float in the center of the browser window of all visitors to the enabled web site or web page.

Referring to FIG. 42, a diagrammatical view of the preferred embedded tabs screen with each tab fully displayed according to an alternate preferred embodiment of the present invention is shown. As shown, each tab is preferably comprised of five areas: 1) push pin 907 which permits the visitor to force the tab to stay open, 2) function buttons 909 which permit the visitor to select a function associated with a tab, for example to join a chat session, 3) tab control buttons 915 which permits a visitor to open or close a tab, 4) tab images 916 which provide an icon for the tab or an image of the web site operator and 5) tab message area 917 which displays fixed or variable information depending on the behavior rules selected.

Preferably each of the tabs is assigned a particular function. Preferably the tabs and their assigned functions are:
Web Master Tab 901. This tab preferably presents a welcome message, web site status information, support available and presence of site operators. Preferred associated dialog boxes include, but are not limited to:
   Information about site operators and whether each is currently on or offline (See Note 151)
   Private messaging with site operators dialog (See Note 128)
   Private chat with site operators dialog
   Feedback dialog
   Web site information, news & events
   Mailing list signup dialog
   Site management functions (accessible only by authorized site operators)
People Tab 902. This tab preferably presents current real-time population count of monitored web site and monitored webpage visitors (See Note 48; See Note 49). Preferred associated dialog boxes include, but are not limited to:
   Visitor statistics for the web site and for each selected web page (See Note 46; See Note 152; See Note 153; See Note 160; See Note 161, ; See Note 164; See Note 166)
   Personal contact list (membership mode only) (See Note 65; See Note 88)
   Membership directory 913 (membership mode only) (See Note 145)
   Directory of site operators
Message Tab 903. This tab preferably presents a current real-time count of site messages and personal messages that are waiting to be read. Preferred associated dialog boxes include, but are not limited to:
   Count of Comments 912 left on web site or web page (See Note 45)
   Personal messages from other users or site operators (membership mode only)
   Message creation dialog
   View previous messages posted (See Note 129)
Chat Tab 904. This tab preferably presents real-time count of people engaged in chat sessions and URL links to current in progress chat sessions (See Note 42; See Note 47). Preferred associated dialog boxes include, but are not limited to:
   Chat dialog 910
   Information on members and anonymous guests currently engaged in each active chat session (See Note 162; See Note 163)
   List of URLs posted to chat (See Note 130)
   URL of an archive of previous meeting and chat text (See Note 37; See Note 67; See Note 131)
Page Tab 905. This tab preferably presents a hierarchical listing of web pages of the web site and a current real-time count of visitors viewing each enabled page (See Note 34). Preferred associated dialog boxes include, but are not limited to:
   Web site web page hierarchy, each web page entry is preferably a URL link to the target web page
   Community web page hierarchy of web pages posted by members, each web page entry is preferably a link to the target web pages
   Page visit statistics
Blobber Tab 906. This tab preferably presents background and promotional information about an alternate preferred embodiment of the present invention. Preferred associated dialog boxes include, but are not limited to:
   Membership sign-up dialog 911
   Description of the primary functions and capabilities of an alternate preferred embodiment of the present invention
   Feedback dialog
   Site operator login dialog (See Note 154)

Referring to FIG. 43, a diagrammatical view of the preferred embedded tabs screen with tabs placed at user's discretion according to an alternate preferred embodiment of the present invention is presented. Preferably any tab may be repositioned to a new location on the screen for the convenience of the user by using typical method of placing the mouse pointer on the desired tab holding the left mouse button down and moving the mouse to re-position the tab. As illustrated, preferably the number of tabs opened and their placement are at the discretion of the visitor.

Referring to FIG. 44, a diagrammatical view of the preferred embedded tabs screen with tabs placed at user's discretion and a chat dialog 910, after a user's request to chat with other visitors according to an alternate preferred embodiment of the present invention is illustrated. As shown a visitor has selected the function button 909 associated with a chat session on the Chat Tab 904 and the chat dialog 910 preferably has been opened over the other tabs and the enabled web page and visitor is able to chat with other visitors to the enabled web page or the web site.

Referring to FIG. 45, a diagrammatical view of the preferred embedded tabs screen with the Blobber Tab 906 exposed and the membership registration dialog open according to an alternate preferred embodiment of the present invention is shown. In this illustration, a visitor has selected the appropriate function button 909 on the Blobber Tab 906 and may complete the membership sign-up dialog 911.

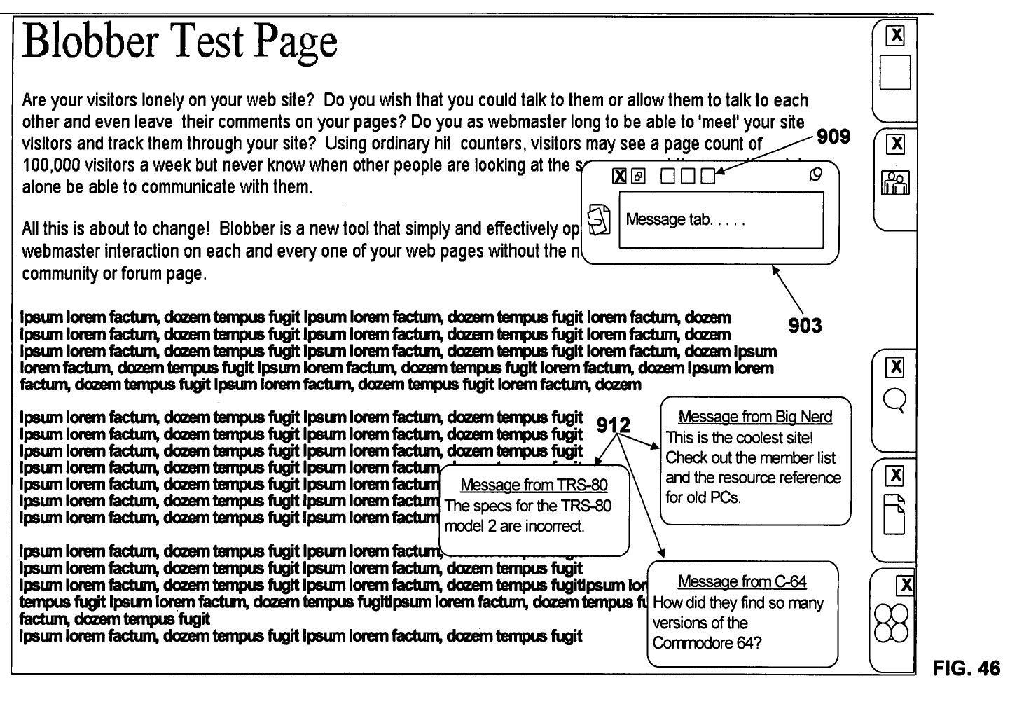

Referring to FIG. 46, a diagrammatical view of the preferred embedded tabs screen with the message tab 903 exposed with the option selected to display messages, left by other visitors, which are related to the underlying web page according to an alternate preferred embodiment of the present invention is shown. As illustrated, the visitor has selected the function button 909 associated with viewing Comments 912 which have been posted by other visitors to the web site and/or enabled web page. Preferably, any visitor may post messages for viewing and response by other visitors or the web site operator. Preferably a visitor or web site operator may respond to a previous comment by selecting the comment and entering their response. Preferably, each comment and related responses would be available to other visitors for viewing and further comment thus creating a “mini” discussion thread regarding specific aspects of the web site and/or enabled web page.

Referring to FIG. 47, a diagrammatical view of the preferred embedded tabs screen with the People Tab 902 exposed with the option selected to display a membership directory 913 of other members of the virtual community associated with the underlying web site according to an alternate preferred embodiment of the present invention is shown. In this example, a visitor has selected the function button 909 associated with the membership directory 913 for the virtual community to which the visitor belongs. As a registered member the visitor will also have access the other virtual community functions described above including a personal directory maintained by the visitor.

Referring to FIG. 48, a diagrammatical view of an example of a management screen for maintaining the behaviors and contents of each of the embedded tabs associated with a selected web page or web site according to an alternate preferred embodiment of the present invention is shown. In this example, an authorized web site operator has accessed this screen after logging in from the Blobber Tab 906 and then selecting the appropriate function button 909 under the Web Master Tab 901. Further, as shown, preferably the authorized web site operator selects the tab which is to be modified and reviews each area—properties, events and methods. Preferably, selection of the update button for any one of the areas will permit the web site operator to access relevant web forms or wizards to facilitate the desired changes. Preferably by building and maintaining the list of rules for each area for each tab the Webmaster is able to program the behavior of each tabs for different situations without the necessity of learning a programming language, such as Java, or C++. Additionally, web site operators are able to manage and configure the instant invention to perform and behave in specific ways which best meets the needs of the licensee.

### Other Alternate Embodiments

In another alternate preferred embodiment, where the system is used in conjunction with non-public systems, such as company-based intranets or web sites where user identification is required, it is preferable to support ad hoc chat sessions from monitored web pages in which each visitor is identified to all other participants. Preferably, this is accomplished through an XML/SOAP interface to the user login and identification system used to control access. As with anonymous ad hoc chat sessions preferably no login would be required of participants, and, once the last participant leaves the session it is closed and no additional work is required.

In one other alternate preferred embodiment, preferably each community member will be permitted to provide a graphic to be displayed during community-based meetings. Additionally, the graphic may be an avatar, image or a static, dynamic or animated graphic. And, the avatar, image or a static, dynamic or animated graphic may be two dimensional or three dimensional (See Note 15; See Note 16; See Note 17; See Note 1; See Note 19; See Note 20).

In an additional alternate preferred embodiment, preferably the system will prepare an index tree of all monitored pages within a web site. Preferably, the index tree would be prepared by analysis of the relationships of the monitored web pages on a web site by software initiated by the monitoring web site. Preferably, the index tree would then optionally be displayed within the floating frame presented to visitors when they access a monitored web page (See Note 139; See Note 140; See Note 141; See Note 142). Additionally, the index tree will preferably permit a visitor to navigate to any of the other indexed pages on the web site. Additionally, each reference to a monitored web page in the index tree will preferably display the number of visitors currently on the web page. Preferably, the index tree of monitored web pages will also be available to a licensee, as a URL within the Resources area of the member's community to permit viewing visitor activity levels on all monitored web pages simultaneously.

In another alternate preferred embodiment, preferably the instant system will permit the use of web-based three dimensional stage set generation tools, such as Adobe Atmosphere, in conjunction with the meeting functions described above to support presentations to multiple participants in a business meeting or classroom type setting. Preferably, support for streaming video and audio would be provided (See Note 7).

In yet another alternate preferred embodiment, preferably the system will optionally provide access to community-based functions as part of the floating frame presented on monitored web pages. Preferably, the community functions to be made available would include the Resources tree and other functions as may be appropriate in the licensee's environment.

In still another alternate embodiment the floating frame may be an inline frame which maintains a fixed position on the web page.

Notes

Each of the Notes listed below refer to embodied claim language below and are appropriately placed in the DETAILED DESCRIPTION OF THE BEST MODE AND PREFERRED EMBODIMENTS OF THE INVENTION section of this specification.
1. accumulating a plurality of such communicated first counts of such users visiting such at least one monitored web page
2. accumulating a plurality of such communicated second counts of such users participating in at such least one Internet-based chat session
3. accumulating such communicated user counts
4. approving addition of at least one sub-community, within such at least one Internet-based virtual community
5. approving addition of at least one web site universal resource locator address, within such at least one Internet-based virtual community
6. assigning at least one role of a plurality of user roles to each such at least one registered user within such at least one Internet-based virtual community
7. assisting combining such at least one virtual meeting with at least one three-dimensional interactive stage set
8. assisting establishing at least one subject hierarchy, using such at least one Internet-based virtual community hierarchical control structure, relating to such at least one Internet-based virtual community by at least one registered user
9. assisting management of such at least one Internet-based virtual community by such at least one user-manager
10. assisting management of such at least one Internet-based virtual community by at least one registered user
11. assisting recording at least one web site universal resource locator address by such at least one registered user
12. assisting recording of at least one universal resource locator address of at least one other web site by such at least one registered user
13. assisting registration of user profile data relating to at least one of such plurality of users to provide at least one registered user
14. assisting registration on such at least one monitoring web site server of user profile data relating to such at least one of user visiting such at least one monitored web page to provide at least one registered user to provide at least one Internet-based virtual community
15. assisting use of avatars to identify each such at least one registered user
16. assisting use of avatars to identify each such at least one user of such at least one monitored web site
17. assisting use of images to identify each such at least one registered user,
18. assisting use of images to identify each such at least one user of such at least one monitored web site
19. assisting use of three-dimensional images to identify each such at least one registered user,
20. assisting use of three-dimensional images to identify each such at least one user of such at least one monitoring web site
21. at least one behavior related to at least one variable
22. at least one caretaker role in which such at least one registered user may manage changes within such at least one Internet-based virtual community
23. at least one caretaker role in which such at least one registered user may manage changes within such at least one Internet-based virtual community
24. at least one default behavior of such at least one visual overlay web page
25. at least one first count of at least two users visiting such at least one monitored web page,
26. at least one first count of such users visiting such at least one monitored web page
27. at least one hierarchical listing of such at least one monitored web page of such at least one monitored web site
28. at least one universal resource locator address of such least one Internet-based chat session
29. at least one member role in which such at least one registered user may utilize all such Internet-based virtual community communication functions
30. at least one second count of at least one subset (of such at least two users) engaged in at such least one Internet-based chat session
31. at least one second count of at least one subset (of such users) engaged in at such least one Internet-based chat session
32. at least one third count of such users visiting such at least one monitored web site
33. at least one universal resource locator address of at least one Internet-based chat session activated by such at least one user-manager
34. at least one universal resource locator address of at least one web page of such at least one monitored web site
35. at least one universal resource locator address of least one monitoring web page of such at least one monitoring web site
36. at least one user-selectable behavior of such at least one visual overlay web page
37. at least universal resource locator address of at least one archive web page containing text of at least one previous Internet-based chat session
38. automatically transmitting to such at least one monitoring web site server universal resource locator address of each such monitored web page of such at least one monitored web site containing such at least one universal resource locator address of such at least one monitoring web site server
39. changing at least one image within such at least one visual overlay web page
40. communicating to such at least one monitoring web site server from such at least one visual overlay web page presence of such at least one user visiting such at least one monitored web page
41. communicating to such at least one monitoring web site server from such at least one web page frame presence of such at least one user on such at least one monitored web page
42. communicating to such at least one monitoring web site server participation of each of such visiting users in such at least one Internet-based chat session
43. communicating to such at least one visual overlay web page such at least one count of users visiting such at least one monitored web page from such at least one monitoring web site server
44. communicating to such at least one web page frame from such at least one monitoring web site server
45. count of messages posted to such at least one monitored web site
46. count of previous visits to such at least one monitored web site by such at least one user
47. count of such users participating in such at least one Internet-based chat session
48. count of such users visiting such at least one monitored web page
49. count of such users visiting such at least one monitored web site
50. current time and date
51. displaying at least one monitoring web page
52. displaying at least one visual overlay web page from such at least one monitoring web site server on top of such at least one monitored web page
53. displaying at least one universal resource locator address within such at least one visual overlay web page
54. displaying at least one web page frame from such at least one monitoring web site server on such at least one monitored web page
55. displaying content within each such overlay web page
56. displaying such at least one monitoring web page frame on such at least one monitored web page
57. elapsed time such at least one user has visited such at least one monitored web page
58. elapsed time such at least one user has visited such at least one monitored web site
59. embedding into such at least one monitored web page at least one universal resource locator address of at least one monitoring web site server
60. embedding, in such at least one monitored web page, at least one universal resource locator reference to monitoring software operating on such at least one monitoring web site server by such at least one operator of such at least one monitored web site
61. facilitating conducting at least one Internet-based chat session between a plurality of such registered users
62. facilitating conducting at least one virtual meeting between a plurality of such registered users
63. facilitating conducting such at least one closed virtual meeting between a plurality of invited such registered users
64. facilitating conducting such at least one open virtual meeting between a plurality of uninvited such registered users
65. facilitating creation of at least one personal directory of selected registered users by such at least one registered user
66. facilitating messaging between a plurality of such registered users,
67. facilitating optionally recording the content of at least one such at least one virtual meeting
68. facilitating participation, as a guest, in at least one other such Internet-based virtual community by such at least one registered user
69. inserting into such at least one monitored web page at least one universal resource locator address of at least one monitoring web site server
70. linking each such visual overlay web page with such at least one monitored web page
71. making such at least one visual overlay web page invisible to such at least one user
72. making such at least one visual overlay web page visible to such at least one user
73. minimizing such at least one visual overlay web page
74. modifying displayed content of such at least one visual overlay web page
75. modifying text content of such at least one visual overlay web page
76. momentarily expanding such at least one visual overlay web page
77. monitoring such at least one monitored web page for presence of such at least one visitor by such monitoring software
78. no application software relating to such Internet system is required to be permanently resident on the computer of such at least one user
79. no application software relating to such Internet system is required to be permanently resident on the computer of such at least one user-manager
80. obtaining such stored behavior selections from such at least one data base related to performing such monitored behaviors within such at least one visual overlay web page displayed on top of such at least one monitored web page
81. obtaining such stored selections from such at least one data base related to displaying such monitored content within each monitored at least one such version of such at least one visual overlay web page to be displayed on top of such at least one monitored web page
82. operating at least one monitoring web site server adapted to permit Internet-based chat between such at least two visitors to such at least one monitored web page of such at least one monitored web site
83. overlaying at least one monitoring web page sent from such monitoring software on such on at least one monitoring web site server on top of such at least one monitored web page when the presence of at least one visitor is detected
84. overlaying such at least one monitored web page with at least one quantity of overlay web pages
85. participation by such at least one user-manager in such at least one Internet-based chat session
86. permanently expanding such at least one visual overlay web page
87. permitting conducting at least one virtual meeting between a plurality of such registered users
88. permitting creation of at least one personal directory of selected registered users by such at least one registered user
89. permitting definition of at least one behavior rule relating to such at least one visual overlay web page by at least one user-manger
90. permitting definition of at least one content rule relating to such at least one visual overlay web page by such at least one user-manager
91. permitting designation of at least one such virtual meeting as open to uninvited other such registered users
92. permitting designation of such at least one virtual meeting as closed to uninvited other such registered users
93. permitting each of such at least two users of such at least one monitored web page to activate such at least one Internet-based chat session
94. permitting each of such at least two users of such at least one monitored web page not already joined in to join such at least one active Internet-based chat session
95. permitting each of such users visiting such at least one monitored web page to participate in such at least one Internet-based chat session
96. permitting each of such visiting users of such at least one monitored web page to activate such at least one Internet-based chat session
97. permitting each of such visiting users of such at least one monitored web page not already joined in to join such at least one active Internet-based chat session
98. permitting each such at least one user joined in such at least one active Internet-based chat session to select text-based communications
99. permitting each such at least one user joined in such at least one active Internet-based chat session to select voice-based communications
100. permitting each such at least one user of such at least one monitored web page joined in such at least one active Internet-based chat session to select text-based communications
101. permitting each such at least one user of such at least one monitored web page joined in such least one active Internet-based chat session to select voice-based communications
102. permitting each such at least one user-manager joined in such at least one active Internet-based chat session to select text-based communications
103. permitting each such at least one user-manager joined in such least one active Internet-based chat session to select voice-based communications
104. permitting each such at least one user-manager of such at least one monitoring site joined in such at least one active Internet-based chat session to select text-based communications
105. permitting each such at least one user-manager of such at least one monitoring site joined in at such least one active Internet-based chat session to select voice-based communications
106. permitting expansion of such at least one visual overlay web page by such at least one user
107. permitting Internet-based chat between such at least two visitors to such at least one monitored web page using at least one Internet-based chat tool operating on such at least one monitoring web site server
108. permitting invitation of at least one other such registered user to such at least one closed virtual meeting by such at least one registered user
109. permitting invitation of at least one other such uninvited registered user to such at least one open virtual meeting by such at least one uninvited registered user
110. permitting manipulation of each such visual overlay web page by such at least one user
111. permitting messaging between a plurality of such registered users
112. permitting minimization of such at least one visual overlay web page by such at least one user
113. permitting placement of such at least one visual overlay web page at a location within such at least one monitored web page by such at least one user
114. permitting recording of at least one universal resource locator address of such at least one monitoring web site server as at least one resource in such at least one Internet-based virtual community
115. permitting selection of at least one such version of such at least one visual overlay web page for display on top of such at least one monitored web page
116. permitting selection of behaviors to be displayed within such at least one visual overlay web page
117. permitting selection of content to be displayed within each monitored at least one such version of such at least one visual overlay web page to be displayed on such at least one monitored web page
118. permitting selection of such at least one behavior rule relating to such at least one visual overlay web page
119. permitting storing such at least one behavior rule selection in such at least one data base on such on at least one monitoring web site server
120. permitting storing such at least one content rule selection in such at least one data base on such on at least one monitoring web site server
121. permitting storing such behavior selections in at least one data base on such at least one monitoring web site server
122. permitting storing such selections in at least one data base on such at least one monitoring website server
123. permitting such at least one invited registered user to join such at least one closed virtual meeting
124. permitting such at least one other uninvited registered user to join such at least one open virtual meeting
125. permitting such at least one user of such at least one monitoring web site to activate such at least one Internet-based chat session
126. permitting such at least one user of such at least one monitoring web site to join such at least one active Internet-based chat session
127. permitting such at least one user visiting such at least one monitored web page to input at least one message relating to such at least one monitored web page
128. permitting such at least one user visiting such at least one monitored web page to request information from such at least one user-manager of such at least one monitored web site
129. permitting such at least one user visiting such at least one monitored web page to view such at least one message left by at least one other user relating to such at least one monitored web page
130. permitting such at least one user visiting such at least one monitored web page to view at least one universal resource locator address inputted during at least one Internet-based chat session
131. permitting such at least one user visiting such at least one monitored web page to view saved text of at least one Internet-based chat session
132. permitting such at least one user-manager visiting such at least one monitoring web page to participate in such at least one Internet-based chat session
133. permitting such at least one user-manager visiting such at least one monitoring web page to activate such at least one Internet-based chat session
134. permitting such at least one user-manager visiting such at least one monitoring web page to join such at least one active Internet-based chat session
135. permitting such at least one user-manger to selectively apply such at least one behavior rule to such at least one visual overlay web page
136. permitting such at least one user-manger to selectively apply such at least one content rule to such at least one visual overlay web page
137. permitting such uninvited other registered users to join such at least one open virtual meeting without invitation
138. placing such at least one visual overlay web page at a location within such at least one monitored web page
139. preparing at least one hierarchical index of all such monitored web pages containing such at least one universal resource locator address of such at least one monitoring web site server
140. preparing at least one hierarchical index of all web pages containing such at least one site universal resource locator address of such at least one monitored web site
141. presenting such at least one hierarchical index in such at least one visual overlay web page to such at least one user visiting such at least one monitored web page containing such at least one universal resource locator address of such at least one monitoring web site server
142. presenting such at least one hierarchical index in such at least one web page frame to such at least one user visiting such at least one web pages containing such at least one site universal resource locator address of such at least one monitoring web site server
143. producing a sound,
144. providing a plurality of Internet-based virtual community communication functions
145. providing at least one directory of such registered users
146. providing at least one Internet-based virtual community hierarchical control structure
147. providing at least one plurality of Internet-based virtual community communication functions
148. receiving payment from at least one operator of such at least one monitored web site by at least one monitoring web site operator
149. recognition of such at least one user visiting such at least one monitored web page as anonymous
150. recognition of such at least one user visiting such at least one monitored web page as not anonymous
151. recognition that such at least one user-manager is visiting monitored such at least one monitored web page
152. reporting in real time to a such at least one registered user that at least one other registered user is logged in to such Internet system
153. reporting, in real time, to a such at least one registered user that at least one other registered user is logged in to such Internet system,
154. requiring at least one user-manger visiting such at least one monitoring web page to login as user-manager
155. sending at least one message to such at least one user
156. sending at least one email to such at least one user
157. sending at least one instant message to such at least one user
158. storing such at least one behavior rule relating to such at least one visual overlay web page in at least one database on at least one monitoring web site server
159. storing such at least one content rule relating to such at least one visual overlay webpage in such at least one database on at least one monitoring web site server
160. such at least one first count of such at least two users visiting such at least one monitored web page
161. such at least one first count of such users visiting such at least one monitored web page
162. such at least one second count of at least one subset (of such at least two users) engaged in such at least one Internet-based chat session
163. such at least one second count of at least one subset (of such visiting users) participating in at such least one Internet-based chat session
164. such at least one third count of such users visiting such at least one monitored web site
165. universal resource locator address last such at least one monitored web page visited by such at least one user
166. at least one third count of such users visiting such at least one monitored web site Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

1) An Internet system, relating to assisting participation in at least one Internet-based chat session between at least two users visiting at least one monitored web page of at least one monitored web site, comprising the steps of:
a) embedding into such at least one monitored web page at least one universal resource locator address of at least one monitoring web site server;
b) displaying at least one visual overlay web page from such at least one monitoring web site server on top of such at least one monitored web page;
c) wherein such at least one visual overlay web page comprises at least one universal resource locator address of at least one Internet-based chat session;
d) communicating to such at least one monitoring web site server from such at least one visual overlay web page presence of such at least one user visiting such at least one monitored web page;
e) permitting each of such users visiting such at least one monitored web page to participate in such at least one Internet-based chat session; and
f) communicating to such at least one monitoring web site server participation of each of such visiting users in such at least one Internet-based chat session.

2) The Internet system according to claim 1 wherein such at least one visual overlay web page further comprises at least one first count of such users visiting such at least one monitored web page.

3) The Internet system according to claim 2 wherein such at least one visual overlay web page further comprises at least one second count of at least one subset (of such visiting users) participating in at such least one Internet-based chat session.

4) The Internet system according to claim 1 wherein such at least one visual overlay web page further comprises at least one second count of at least one subset (of such visiting users) participating in at such least one Internet-based chat session.

5) The Internet system according to claim 1 further comprising the step of:
a) communicating to such at least one visual overlay web page from such at least one monitoring web site server comprising
i) such at least one first count of such users visiting such at least one monitored web page, and
ii) such at least one second count of at least one subset (of such visiting users) participating in at such least one Internet-based chat session.

6) The Internet system according to claim 5, wherein the step of communicating to such at least one visual overlay web page from such at least one monitoring web site server further comprises at least one third count of such users visiting such at least one monitored web site.

7) The Internet system according to claim 1 wherein the step of permitting each of such visiting users of such at least one monitored web page to participate in such at least one Internet-based chat session comprises the steps of:
a) permitting each of such visiting users of such at least one monitored web page to activate such at least one Internet-based chat session; and
b) permitting each of such visiting users of such at least one monitored web page not already joined in to join such at least one active Internet-based chat session.

8) The Internet system according to claim 1 further comprising the steps of:
a) displaying at least one monitoring web page; and
b) requiring at least one user-manger visiting such at least one monitoring web page to login as user-manager;
c) permitting such at least one user-manager visiting such at least one monitoring web page to participate in such at least one Internet-based chat session.

9) The Internet system according to claim 8 wherein such at least one monitoring web page is displayed from such at least one monitoring web site.

10) The Internet system according to claim 8 wherein the step of permitting at least one user-manager visiting such at least one monitoring web page to participate in such at least one Internet-based chat session comprises the steps of:
a) permitting such at least one user-manager visiting such at least one monitoring web page to activate such at least one Internet-based chat session; and
b) permitting such at least one user-manager visiting such at least one monitoring web page to join such at least one active Internet-based chat session.

11) The Internet system according to claim 8 further comprising the steps of:
a) permitting each such at least one user joined in such at least one active Internet-based chat session to select text-based communications; and
b) permitting each such at least one user-manager joined in such at least one active Internet-based chat session to select text-based communications.

12) The Internet system according to claim 8 further comprising the steps of:
a) permitting each such at least one user joined in such at least one active Internet-based chat session to select voice-based communications; and
b) permitting each such at least one user-manager joined in such least one active Internet-based chat session to select voice-based communications.

13) The Internet system according to claim 1 further comprising the steps of:
a) accumulating a plurality of such communicated first counts of such users visiting such at least one monitored web page; and
b) accumulating a plurality of such communicated second counts of such users participating in at such least one Internet-based chat session.

14) The Internet system according to claim 13 wherein the step of accumulating a plurality of such communicated first counts of such users visiting such at least one monitored web page comprises the step of accumulating a plurality of all such communicated first counts of all such users visiting each such at least one monitored web page as such at least one third count of such users visiting such at least one monitored web site.

15) The Internet system according to claim 1 further comprising the steps of:
a) automatically transmitting to such at least one monitoring web site server universal resource locator address of each such monitored web page of such at least one monitored web site containing such at least one universal resource locator address of such at least one monitoring web site server;
b) preparing at least one hierarchical index of all such monitored web pages containing such at least one universal resource locator address of such at least one monitoring web site server; and
c) presenting such at least one hierarchical index in such at least one visual overlay web page to such at least one user visiting such at least one monitored web page containing such at least one universal resource locator address of such at least one monitoring web site server.

16) The Internet system according to claim 1, wherein such at least one visual overlay web page further comprises:
a) such at least one third count of such users visiting such at least one monitored web site;
b) at least one universal resource locator address of at least one Internet-based chat session activated by such at least one user-manager; and
c) at least one universal resource locator address of at least one web page of such at least one monitored web site.

17) The Internet system according to claim 16 wherein such at least one Internet-based chat session activated by such at least one user-manager comprises at least one Internet-based chat session including at least one user visiting such at least one monitored web page.

18) The Internet system according to claim 1 wherein such at least one visual overlay web page comprises at least one plurality of visual versions of at least one window each such visual version having different versions of content.

19) The Internet system according to claim 18 wherein such content comprises:
a) at least one type of information; and
b) at least one universal resource locator address of at least one other web page.

20) The Internet system according to claim 19 comprising the steps of:
a) permitting selection of at least one such visual version of such at least one window within such at least one visual overlay web page for display on top of such at least one monitored web page;
b) permitting selection of content to be displayed within each visual version of such at least one window within such at least one visual overlay web page to be displayed on top of such at least one monitored web page;
c) permitting storing such selections in at least one data base on such at least one monitoring website server;
d) obtaining such stored selections from such at least one data base related to displaying such selected content within each such visual version of such at least one window within such at least one visual overlay web page to be displayed on top of such at least one monitored web page.

21) The Internet system according to claim 19 wherein such at least one type of information comprises at least two members selected from the set comprising:
a) at least one first count of such users visiting such at least one monitored web page;
b) at least one second count of at least one subset (of such users) engaged in at such least one Internet-based chat session;
c) at least one third count of such users visiting such at least one monitored web site; and
d) at least one hierarchical listing of such at least one monitored web page of such at least one monitored web site.

22) The Internet system according to claim 19 wherein such at least one at least one universal resource locator address of at least one other web page comprises at least two members selected from the set comprising:
a) at least one universal resource locator address of least one other monitoring web page of such at least one monitoring web site;
b) at least one universal resource locator address of such least one Internet-based chat session;
c) at least one universal resource locator address of such least one Internet-based chat session activated by such at least one user-manager; and
d) at least universal resource locator address of at least one archive web page containing text of at least one previous Internet-based chat session.

23) The Internet system according to claim 19 further comprising the steps of:
a) permitting selection of behaviors relating to each such at least one visual version of such at least one window within such at least one visual overlay web page;
b) wherein such behaviors comprise at least four members selected from the set comprising
i) momentarily expanding such at least one visual version of such at least one window within such at least one visual overlay page,
ii) permanently expanding such at least one visual version of such at least one window within such at least one visual overlay web page,
iii) minimizing such at least one visual version of such at least one window within such at least one visual overlay web page,
iv) placing such at least one visual version of such at least one window within such at least one visual overlay web page at a location within such at least one monitored web page,
v) modifying text content of such at least one visual version of such at least one window within such at least one visual overlay web page,
vi) making such at least one visual version of such at least one window within such at least one visual overlay web page visible to such at least one user,
vii) making such at least one visual version of such at least one window within such at least one visual overlay web page invisible to such at least one user,
viii) producing a sound,
ix) changing at least one image within such at least one visual version of such at least one window within such at least one visual overlay web page,
x) sending at least one message to such at least one user,
xi) sending at least one email to such at least one user, and
xii) sending at least one instant message to such at least one user.
c) permitting storing such behavior selections in at least one data base on such at least one monitoring web site server;
d) obtaining such stored behavior selections from such at least one data base related to performing such selected behaviors within such at least one visual version of such at least one window within at least one visual overlay web page displayed on top of such at least one monitored web page.

24) The Internet system according to claim 1 further comprising the steps of:
a) assisting registration on such at least one monitoring web site server of user profile data relating to such at least one of user visiting such at least one monitored web page to provide at least one registered user to provide at least one Internet-based virtual community;
b) providing a plurality of Internet-based virtual community communication functions;
c) wherein such plurality of Internet-based virtual community communication functions comprises
i) reporting, in real time, to a such at least one registered user that at least one other registered user is logged in to such Internet system,
ii) permitting messaging between a plurality of such registered users,
iii) permitting conducting at least one virtual meeting between a plurality of such registered users,
iv) permitting creation of at least one personal directory of selected registered users by such at least one registered user,
v) providing at least one directory of such registered users, and
vi) assisting recording of at least one universal resource locator address of at least one other web site by such at least one registered user; and
d) assisting management of such at least one Internet-based virtual community by such at least one user-manager.

25) The Internet system according to claim 1 further comprising the steps of:
a) permitting such at least one user visiting such at least one monitored web page to input at least one message relating to such at least one monitored web page;
b) permitting such at least one user visiting such at least one monitored web page to request information from such at least one user-manager of such at least one monitored web site;
c) permitting such at least one user visiting such at least one monitored web page to view such at least one message left by at least one other user relating to such at least one monitored web page;
d) permitting such at least one user visiting such at least one monitored web page to view at least one universal resource locator address inputted during at least one Internet-based chat session; and
e) permitting such at least one user visiting such at least one monitored web page to view saved text of at least one Internet-based chat session.

26) The Internet system according claim 1 in which:
a) no application software relating to such Internet system is required to be permanently resident on the computer of such at least one user; and
b) no application software relating to such Internet system is required to be permanently resident on the computer of such at least one user-manager.

27) A computer system, relating to an Internet system, relating to assisting participation in at least one Internet-based chat session between at least two users visiting at least one monitored web page of at least one monitored web site, comprising:
a) computer interface means relating to displaying at least one visual overlay web page from such at least one monitoring web site server on top of such at least one monitored web page;
b) wherein such at least one visual overlay web page comprises at least one universal resource locator address of at least one Internet-based chat session;
c) computer communication means relating to communicating to such at least one monitoring web site server from such at least one visual overlay web page presence of such at least one user visiting such at least one monitored web page;
d) computer processor means relating to permitting each of such users visiting such at least one monitored web page to participate in such at least one Internet-based chat session; and
e) computer communication means relating to communicating to such at least one monitoring web site server participation of each of such visiting users in such at least one Internet-based chat session.

28) The computer system according to claim 27 wherein such at least one visual overlay web page further comprises at least one first count of such users visiting such at least one monitored web page.

29) The computer system according to claim 28 wherein such at least one visual overlay web page further comprises at least one second count of at least one subset (of such visiting users) participating in at such least one Internet-based chat session.

30) The computer system according to claim 27 wherein such at least one visual overlay web page further comprises at least one second count of at least one subset (of such visiting users) participating in at such least one Internet-based chat session.

31) The computer system according to claim 27 further comprising:
a) computer communication means relating to communicating to such at least one visual overlay web page from such at least one monitoring web site server comprising
i) such at least one first count of such users visiting such at least one monitored web page, and
ii) such at least one second count of at least one subset (of such visiting users) participating in at such least one Internet-based chat session.

32) The computer system according to claim 31, wherein computer communication means relating to communicating to such at least one visual overlay web page from such at least one monitoring web site server further comprises at least one third count of such users visiting such at least one monitored web site.

33) The computer system according to claim 27 wherein computer processor means relating to permitting each of such visiting users of such at least one monitored web page to participate in such at least one Internet-based chat session comprising:
a) computer processor means relating to permitting each of such visiting users of such at least one monitored web page to activate such at least one Internet-based chat session; and
b) computer processor means relating to permitting each of such visiting users of such at least one monitored web page not already joined in to join such at least one active Internet-based chat session.

34) The computer system according to claim 27 further comprising:
a) computer interface means relating to displaying at least one monitoring web page; and
b) computer processor means relating to requiring at least one user-manger visiting such at least one monitoring web page to login as user-manager;
c) computer processor means relating to permitting such at least one user-manager visiting such at least one monitoring web page to participate in such at least one Internet-based chat session.

35) The computer system according to claim 34 wherein such at least one monitoring web page is displayed from such at least one monitoring web site.

36) The computer system according to claim 34 wherein computer processor means relating to permitting at least one user-manager visiting such at least one monitoring web page to participate in such at least one Internet-based chat session further comprising:
a) computer processor means relating to permitting such at least one user-manager visiting such at least one monitoring web page to activate such at least one Internet-based chat session; and
b) computer processor means relating to permitting such at least one user-manager visiting such at least one monitoring web page to join such at least one active Internet-based chat session.

37) The computer system according to claim 34 further comprising:
a) computer processor means relating to permitting each such at least one user joined in such at least one active Internet-based chat session to select text-based communications; and
b) computer processor means relating to permitting each such at least one user-manager joined in such least one active Internet-based chat session to select text-based communications.

38) The computer system according to claim 35 further comprising:
a) computer processor means relating to permitting each such at least one user joined in such at least one active Internet-based chat session to select voice-based communications; and
b) computer processor means relating to permitting each such at least one user-manager joined in such least one active Internet-based chat session to select voice-based communications.

39) The computer system according to claim 27 further comprising:
a) computer processor means relating to accumulating a plurality of such communicated first counts of such users visiting such at least one monitored web page; and
b) computer processor means relating to accumulating a plurality of such communicated second counts of such users participating in at such least one Internet-based chat session.

40) The computer system according to claim 39 wherein computer processor means relating to accumulating a plurality of such communicated first counts of such users visiting such at least one monitored web page comprises computer processor means relating to accumulating a plurality of all such communicated first counts of all such users visiting each such at least one monitored web page as such at least one third count of such users visiting such at least one monitored web site.

41) The computer system according to claim 27 further comprising:
a) computer processor means relating to automatically transmitting to such at least one monitoring web site server universal resource locator address of each such monitored web page of such at least one monitored web site containing such at least one universal resource locator address of such at least one monitoring web site server;
b) computer processor means relating to preparing at least one hierarchical index of all such monitored web pages containing such at least one universal resource locator address of such at least one monitoring web site server; and
c) computer interface means relating to presenting such at least one hierarchical index in such at least one visual overlay web page to such at least one user visiting such at least one monitored web page containing such at least one universal resource locator address of such at least one monitoring web site server.

42) The computer system according to claim 27, wherein such at least one visual overlay web page further comprises:
a) such at least one third count of such users visiting such at least one monitored web site;
b) at least one universal resource locator address of at least one Internet-based chat session activated by such at least one user-manager; and
c) at least one universal resource locator address of at least one web page of such at least one monitored web site.

43) The computer system according to claim 42 wherein such at least one Internet-based chat session activated by such at least one user-manager comprises such at least one Internet-based chat session including at least one user visiting such at least one monitored web page.

44) The computer system according to claim 27 wherein such at least one visual overlay web page comprises at least one plurality of visual versions of at least one window each such visual version having different versions of content.

45) The computer system according to claim 44 wherein such content comprises:
a) at least one type of information; and
b) at least one universal resource locator address of at least one other web page.

46) The computer system according to claim 45 comprising:
a) computer processor means relating to permitting selection of at least one such visual version of such at least one window within such at least one visual overlay web page for display on top of such at least one monitored web page;
b) computer processor means relating to permitting selection of content to be displayed within each visual version of such at least one window within such at least one visual overlay web page to be displayed on top of such at least one monitored web page;
c) computer storage means relating to storing such selections in at least one data base on such at least one monitoring website server;
d) computer processor means relating to obtaining such stored selections from such at least one data base related to displaying such selected content within each such visual version of such at least one window within such at least one visual overlay web page to be displayed on top of such at least one monitored web page.

47) The computer system according to claim 45 wherein such at least one type of information comprises at least two members selected from the set comprising:
a) at least one first count of such users visiting such at least one monitored web page;
b) at least one second count of at least one subset (of such users) engaged in at such least one Internet-based chat session;
c) at least one third count of such users visiting such at least one monitored web site; and
d) at least one hierarchical listing of such at least one monitored web page of such at least one monitored web site.

48) The computer system according to claim 45 wherein such at least one at least one universal resource locator address of at least one other web page comprises at least two members selected from the set comprising:
a) at least one universal resource locator address of least one other monitoring web page of such at least one monitoring web site;
b) at least one universal resource locator address of such least one Internet-based chat session;
c) at least one universal resource locator address of such least one Internet-based chat session activated by such at least one user-manager; and
d) at least universal resource locator address of at least one archive web page containing text of at least one previous Internet-based chat session.

49) The computer system according to claim 45 further comprising the steps of:
a) computer processor means relating to permitting selection of behaviors relating to each such at least one visual version of such at least one window within such at least one visual overlay web page;
b) wherein such content comprises at least four members selected from the set comprising
i) momentarily expanding such at least one visual version of such at least one window within such at least one visual overlay page,
ii) permanently expanding such at least one visual version of such at least one window within such at least one visual overlay web page,
iii) minimizing such at least one visual version of such at least one window within such at least one visual overlay web page,
iv) placing such at least one visual version of such at least one window within such at least one visual overlay web page at a location within such at least one monitored web page,
v) modifying text content of such at least one visual version of such at least one window within such at least one visual overlay web page,
vi) making such at least one visual version of such at least one window within such at least one visual overlay web page visible to such at least one user,
vii) making such at least one visual version of such at least one window within such at least one visual overlay web page invisible to such at least one user,
viii) producing a sound,
ix) changing at least one image within such at least one visual version of such at least one window within such at least one visual overlay web page,
x) sending at least one message to such at least one user,
xi) sending at least one email to such at least one user, and
xii) sending at least one instant message to such at least one user;
c) computer processor means relating to permitting storing such behavior selections in at least one data base on such at least one monitoring website server;
d) computer processor means relating to obtaining such stored behavior selections from such at least one data base related to performing such selected behaviors within such at least one visual version of such at least one window within at least one visual overlay web page displayed on top of such at least one monitored web page.

50) The computer system according to claim 27 further comprising the steps of:
a) computer processor means relating to assisting registration of user profile data relating to such at least one of user visiting such at least one monitored web page to provide at least one registered user to provide at least one Internet-based virtual community;
b) computer processor means relating to providing a plurality of Internet-based virtual community communication functions;
c) wherein such plurality of Internet-based virtual community communication functions comprises
i) computer processor means relating to reporting, in real time, to a such at least one registered user that at least one other registered user is logged in to such Internet system,
ii) computer processor means relating to permitting messaging between a plurality of such registered users,
iii) computer processor means relating to permitting conducting at least one virtual meeting between a plurality of such registered users,
iv) computer processor means relating to permitting creation of at least one personal directory of selected registered users by such at least one registered user,
v) computer processor means relating to providing at least one directory of such registered users, and
vi) computer processor means relating to assisting recording of at least one universal resource locator address of at least one other web site by such at least one registered user; and
d) computer processor means relating to assisting management of such at least one Internet-based virtual community by such at least one user-manager.

51) The computer system according to claim 27 further comprising:
a) computer processor means relating to permitting such at least one user visiting such at least one monitored web page to input at least one message relating to such at least one monitored web page;
b) computer processor means relating to permitting such at least one user visiting such at least one monitored web page to request information from such at least one user-manager of such at least one monitored web site;
c) computer processor means relating to permitting such at least one user visiting such at least one monitored web page to view such at least one message left by at least one other user relating to such at least one monitored web page;
d) computer processor means relating to permitting such at least one user visiting such at least one monitored web page to view at least one universal resource locator address inputted during at least one Internet-based chat session; and
e) computer processor means relating to permitting such at least one user visiting such at least one monitored web page to view saved text of at least one Internet-based chat session.

52) The computer system according claim 27 in which:
a) no application software relating to such Internet system is required to be permanently resident on the computer of such at least one user; and
b) no application software relating to such Internet system is required to be permanently resident on the computer of such at least one user-manager.

53) An Internet system, relating to assisting at least one plurality of users having at least one common interest to provide at least one Internet-based virtual community, comprising the steps of:
a) assisting registration of user profile data relating to at least one of such plurality of users to provide at least one registered user;
b) providing at least one plurality of Internet-based virtual community communication functions;
c) wherein such at least one plurality of Internet-based virtual community communication functions comprises
i) reporting, in real time, to a such at least one registered user that at least one other registered user is logged in to such Internet system,
ii) facilitating conducting at least one Internet-based chat session between a plurality of such registered users,
iii) facilitating messaging between a plurality of such registered users,
iv) facilitating conducting at least one virtual meeting between a plurality of such registered users,
v) assisting recording at least one web site universal resource locator address by such at least one registered user,
vi) providing at least one directory of such registered users, and
vii) providing at least one Internet-based virtual community hierarchical control structure;
d) assisting establishing at least one subject hierarchy, using such at least one Internet-based virtual community hierarchical control structure, relating to such at least one Internet-based virtual community by at least one registered user; and
e) assisting management of such at least one Internet-based virtual community by at least one registered user.

54) The Internet system according to claim 53, wherein the step of assisting management of such at least one Internet-based virtual community by at least one registered user comprises the steps of:
a) assigning at least one role of a plurality of user roles to each such at least one registered user within such at least one Internet-based virtual community;
b) wherein such plurality of user roles comprises
i) at least one member role in which such at least one registered user may utilize all such Internet-based virtual community communication functions, and
ii) at least one caretaker role in which such at least one registered user may manage changes within such at least one Internet-based virtual community
(1) wherein such at least one caretaker role comprises
(a) approving addition of at least one sub-community, within such at least one Internet-based virtual community, and
(b) approving addition of at least one web site universal resource locator address within such at least one Internet-based virtual community.

55) The Internet system according to claim 53 further comprising the step of facilitating participation, as a guest, in at least one other such Internet-based virtual community by such at least one registered user.

56) The Internet system according to claim 53 further comprising the step of facilitating creation of at least one personal directory of selected registered users by such at least one registered user.

57) The Internet system according to claim 53 further comprising the step of facilitating optionally recording the content of at least one such at least one virtual meeting.

58) The Internet system according to claim 53, wherein the step of facilitating conducting such at least one virtual meeting between such plurality of such registered users comprises the steps of;
a) permitting designation of such at least one virtual meeting as closed to uninvited other such registered users;
b) permitting invitation of at least one other such registered user to such at least one closed virtual meeting by such at least one registered user;
c) permitting such at least one invited registered user to join such at least one closed virtual meeting; and
d) facilitating conducting such at least one closed virtual meeting between a plurality of invited such registered users.

59) The Internet system according to claim 53 further comprising the steps of:
a) permitting designation of at least one such virtual meeting as open to uninvited other such registered users;
b) permitting such uninvited other registered users to join such at least one open virtual meeting without invitation;
c) permitting invitation of at least one other such uninvited registered user to such at least one open virtual meeting by such at least one uninvited registered user;
d) permitting such at least one other uninvited registered user to join such at least one open virtual meeting; and
e) facilitating conducting such at least one open virtual meeting between a plurality of uninvited such registered users.

60) The Internet system according to claim 53 further comprising the steps of;
a) inserting into at least one monitored web page at least one universal resource locator address of at least one monitoring web site server;
b) displaying at least one web page frame from such at least one monitoring web site server on such at least one monitored web page;
c) wherein such at least one web page frame comprises
i) at least one first count of at least two users visiting such at least one monitored web page,
ii) at least one second count of at least one subset (of such at least two users) engaged in at such least one Internet-based chat session, and
iii) at least one universal resource locator address of such least one Internet-based chat session;
d) communicating to such at least one monitoring web site server from such at least one web page frame presence of such at least one user on such at least one monitored web page;
e) communicating to such at least one web page frame from such at least one monitoring web site server
i) such at least one first count of such at least two users visiting such at least one monitored web page, and
ii) such at least one second count of at least one subset (of such at least two users) engaged in such at least one Internet-based chat session;
f) permitting each of such at least two users of such at least one monitored web page to activate such at least one Internet-based chat session;
g) permitting each of such at least two users of such at least one monitored web page not already joined in to join such at least one active Internet-based chat session; and
h) permitting recording of at least one universal resource locator address of such at least one monitoring web site server as at least one resource in such at least one Internet-based virtual community.

61) The Internet system according to claim 60 further comprising the steps of:
a) displaying such at least one monitoring web page frame on such at least one monitored web page;
b) permitting such at least one user of such at least one monitoring web site to activate such at least one Internet-based chat session; and
c) permitting such at least one user of such at least one monitoring web site to join such at least one active Internet-based chat session.

62) The Internet system according to claim 60 further comprising the steps of:
a) permitting each such at least one user of such at least one monitored web page joined in such at least one active Internet-based chat session to select text-based communications; and
b) permitting each such at least one user-manager of such at least one monitoring site joined in such at least one active Internet-based chat session to select text-based communications.

63) The Internet system according to claim 60 further comprising the steps of:
a) permitting each such at least one user of such at least one monitored web page joined in such least one active Internet-based chat session to select voice-based communications; and
b) permitting each such at least one user-manager of such at least one monitoring site joined in at such least one active Internet-based chat session to select voice-based communications.

64) The Internet system according to claim 60 further comprising the steps of:
a) accumulating a plurality of such communicated first counts of users visiting such at least one monitored web page; and
b) accumulating a plurality of such communicated second counts of such users engaged in at such least one Internet-based chat session.

65) The Internet system according to claim 60 further comprising the steps of;
a) automatically transmitting to such at least one monitoring web site server universal resource locator address of each such web page of such at least one monitored web site containing such at least one site universal resource locator address of such at least one monitoring web site server;
b) preparing at least one hierarchical index of all web pages containing such at least one site universal resource locator address of such at least one monitored Web site; and
c) presenting such at least one hierarchical index in such at least one web page frame to such at least one user visiting such at least one web pages containing such at least one site universal resource locator address of such at least one monitoring web site server.

66) The Internet system according to claim 60 further comprising the steps of:
a) assisting use of avatars to identify each such at least one registered user;
b) assisting use of avatars to identify each such at least one user of such at least one monitored web site;
c) assisting use of images to identify each such at least one registered user,
d) assisting use of images to identify each such at least one user of such at least one monitored web site;
e) assisting use of three-dimensional images to identify each such at least one registered user,
f) assisting use of three-dimensional images to identify each such at least one user of such at least one monitoring web site; and
g) assisting combining such at least one virtual meeting with at least one three-dimensional interactive stage set.

67) An Internet system relating to assisting at least one plurality of users having at least one common interest to provide at least one Internet-based virtual community, comprising:
a) computer interface means relating to assisting registration of user profile data relating to at least one of such plurality of users to provide at least one registered user;
b) computer processor means relating to providing at least one plurality of Internet-based virtual community communication functions;
c) wherein such at least one plurality of Internet-based virtual community communication functions comprises:
i) computer processor means relating to reporting, in real time, to a such at least one registered user that at least one other registered user is logged in to such Internet system,
ii) computer processor means relating to facilitating messaging between a plurality of such registered users,
iii) computer processor means relating to facilitating conducting at least one virtual meeting between a plurality of such registered users,
iv) computer storage means relating to assisting recording at least one web site universal resource locator address by such at least one registered user,
v) computer processor means relating to providing at least one directory of such registered users, and
vi) computer processor means relating to providing at least one virtual community hierarchical control structure;
d) computer processor means relating to assisting establishing at least one subject hierarchy, using such at least one Internet-based virtual community hierarchical control structure, relating to such at least one Internet-based virtual community by at least one registered user; and
e) computer processor means relating to assisting management of such at least one Internet-based virtual community by at least one registered user.

68) The Internet system according to claim 67, wherein computer processor means relating to assisting management of such at least one Internet-based virtual community by at least one registered user comprises:
a) computer processor means relating to assigning at least one role of a plurality of user roles to each such at least one registered user within such at least one Internet-based virtual community;
b) wherein such plurality of user roles comprises:
i) at least one member role in which such at least one registered user may utilize all such Internet-based virtual community communication functions, and
ii) at least one caretaker role in which such at least one registered user may manage changes within such at least one Internet-based virtual community
(1) wherein such at least one caretaker role comprises;
(a) approving addition of at least one sub-community, within such at least one Internet-based virtual community, and
(b) approving addition of at least one web site universal resource locator address, within such at least one Internet-based virtual community.

69) The Internet system according to claim 67 further comprising computer processor means relating to facilitating participation, as a guest, in at least one other such Internet-based virtual community by such at least one registered user.

70) The Internet system according to claim 67 further comprising computer processor means relating to facilitating creation of at least one personal directory of selected registered users by such at least one registered user.

71) The Internet system according to claim 67 further comprising computer database means relating to facilitating optionally recording the content of at least one of such at least one virtual meeting.

72) The Internet system according to claim 67, wherein computer processor means relating to facilitating conducting such at least one virtual meeting between such plurality of such registered users further comprising;
a) computer processor means relating to permitting designation of such at least one virtual meeting as closed to uninvited other such registered users;
b) computer processor means relating to permitting invitation of at least one other such registered user to such at least one closed virtual meeting by such at least one registered user;
c) computer processor means relating to permitting such at least one invited registered user to join such at least one closed virtual meeting; and
d) computer processor means relating to facilitating conducting such at least one closed virtual meeting between a plurality of invited such registered users.

73) The Internet system according to claim 67 further comprising;
a) computer processor means relating to permitting designation of at least one such virtual meeting as open to uninvited other such registered users;
b) computer processor means relating to permitting such other uninvited registered users to join such at least one open virtual meeting without invitation;
c) computer processor means relating to permitting invitation of at least one other such uninvited registered user to such at least one open virtual meeting by such at least one uninvited registered user; and
d) computer processor means relating to permitting such at least one other uninvited registered user to join such at least one open virtual meeting.

74) The Internet system according to claim 67 further comprising;
a) computer processor means relating to inserting into at least one monitored web page at least one universal resource locator address of at least one monitoring web site server;
b) computer interface means relating to displaying at least one web page frame from such at least one monitoring web site server on such at least one monitored web page;
c) wherein such at least one web page frame comprises
i) at least one first count of at least two users visiting such at least one monitored web page,
ii) at least one second count of at least one subset (of such at least two users) engaged in at such least one Internet-based chat session, and
iii) at least one universal resource locator address of such least one Internet-based chat session;
d) computer communication means relating to communicating to such at least one monitoring web site server from such at least one web page frame presence of such at least one user on such at least one monitored web page;
e) computer communication means relating to communicating to such at least one web page frame from such at least one monitoring web site server
i) such at least, one first count of such at least two users visiting such at least one monitored web page, and
ii) such at least one second count of at least one subset (of such at least two users) engaged in such at least one Internet-based chat session;
f) computer processor means relating to permitting each of such at least two users of such at least one monitored web page to activate such at least one Internet-based chat session;
g) computer processor means relating to permitting each of such at least two users of such at least one monitored web page not already joined in to join such at least one active Internet-based chat session; and
h) computer database means relating to permitting recording of at least one universal resource locator address of such at least one monitoring web site server as at least one resource in such at least one Internet-based virtual community.

75) The Internet system according to claim 74 further comprising:
a) computer interface means relating to displaying such at least one monitoring web page frame on such at least one monitored web page;
b) computer processor means relating to permitting such at least one user of such at least one monitoring web site server to activate such at least one Internet-based chat session; and
c) computer processor means relating to permitting such at least one user of such at least one monitoring web site to join such at least one active Internet-based chat session.

76) The Internet system according to claim 74 further comprising:
a) computer processor means relating to permitting each such at least one user of such at least one monitored web page joined in such at least one active Internet-based chat session to select text-based communications; and
b) computer processor means relating to permitting each such user of such at least one monitoring site joined in such at least one active Internet-based chat session to select text-based communications;

77) The Internet system according to claim 74 further comprising:
a) computer processor means relating to permitting each such at least one user of such at least one monitored web page joined in such least one active Internet-based chat session to select voice-based communications; and
b) computer processor means relating to permitting each such at least one user of such at least one user-manager engaged in at such least one active Internet-based chat session to select voice-based communications.

78) The Internet system according to claim 74 further comprising:
a) computer storage means relating to accumulating a plurality of such communicated counts of users visiting such at least one monitored web page; and
b) computer storage means relating to accumulating a plurality of such communicated counts of such users engaged in at such least one Internet-based chat session.

79) The Internet system according to claim 74 further comprising;
a) computer transmission means relating to automatically transmitting to such at least one monitoring web site server universal resource locator address of each such web page of such at least one monitored web site containing such at least one universal resource locator address of such at least one monitoring web site server;
b) computer processor means relating to preparing at least one hierarchical index of all web pages containing such at least one universal resource locator address of such at least one monitored web site; and
c) computer interface means relating to presenting such at least one hierarchical index in such at least one web page frame to such at least one user visiting such at least one web page containing such at least one universal resource locator address of such at least one monitoring web site.

80) The Internet system according to claim 74 further comprising:
a) computer interface means relating to assisting use of avatars to identify each such at least one registered user;
b) computer interface means relating to assisting use of avatars to identify each such at least one user of such at least one monitored web site;
c) computer interface means relating to assisting use of images to identify each such at least one registered user,
d) computer interface means relating to assisting use of images to identify each such at least one user of such at least one monitored web site;
e) computer interface means relating to assisting use of three dimensional images to identify each such at least one registered user,
f) computer interface means relating to assisting use of three dimensional images to identify each such at least one user of such at least one monitored web site; and
g) computer interface means relating to assisting combining such at least one virtual meeting with at least one three-dimensional interactive stage set.

81) An Internet system relating to assisting reporting at least one visit to at least one monitored web page of at least one monitored web site by at least one user comprising the steps of:
a) inserting into such at least one monitored web page at least one universal resource locator address of at least one monitoring web site server;
b) displaying at least one visual overlay web page from such at least one monitoring web site server on top of such at least one monitored web page;
c) wherein such at least one visual overlay web page comprises at least one count of users visiting such at least one monitored web page;
d) communicating to such at least one monitoring web site server from such at least one visual overlay web page presence of such at least one user visiting such at least one monitored web page;
e) communicating to such at least one visual overlay web page such at least one count of users visiting such at least one monitored web page from such at least one monitoring web site server; and
f) accumulating such communicated user counts.

82) An Internet system relating to assisting reporting at least one visit to at least one monitored web page of at least one monitored web site by at least one user comprising:
a) computer processor means relating to inserting into such at least one monitored web page at least one universal resource locator address of at least one monitoring web site server;
b) computer interface means relating to displaying at least one visual overlay web page from such at least one monitoring web site server on top of such at least one monitored web page;
c) wherein such at least one visual overlay web page comprises at least one count of users visiting such at least one monitored web page;
d) computer communication means relating to communicating to such at least one monitoring web site server from such at least one visual overlay web page presence of such at least one user visiting such at least one monitored web page;
e) computer communication means relating to communicating to such at least one visual overlay web page such at least one count of users visiting such at least one monitored web page from such at least one monitoring web site server; and
f) computer database means relating to accumulating such communicated user counts.

83) A computer-based display system relating to presenting information to at least one user of at least one monitored web page comprising the steps of:
a) overlaying such at least one monitored web page with at least one visual overlay web page comprising at least one quantity of windows;
b) linking each such visual overlay web page with such at least one monitored web page;
c) displaying content within each such window within such at least one visual overlay web page;
d) displaying at least one universal resource locator address within such at least one window within such at least one visual overlay web page; and
e) permitting manipulation of each such at least one window within such at least one visual overlay web page by such at least one user.

84) The computer-based display system according to claim 83 further comprising the steps of:
a) permitting definition of at least one behavior rule relating to such at least one window within such at least one visual overlay web page by at least one user-manger;
b) wherein such at least one behavior rule comprises
i) at least one default behavior of such at least one visual overlay web page,
ii) at least one behavior related to at least one variable, and
iii) at least one user-selectable behavior of such at least one visual overlay web page,
c) permitting selection of such at least one behavior rule relating to such at least one visual overlay web page;
d) storing such at least one behavior rule relating to such at least one visual overlay web page in at least one database on at least one monitoring web site server;
e) permitting definition of at least one content rule relating to such at least one visual overlay web page by such at least one user-manager; and
f) storing such at least one content rule relating to such at least one visual overlay webpage in such at least one database on at least one monitoring web site server.

85) The computer-based display system according to claim 84 wherein such at least one content rule relating to such at least one visual overlay page comprises at least three members selected from the set comprising:
a) at least one first count of such users visiting such at least one monitored web page;
b) at least one second count of at least one subset (of such users) engaged in at least one Internet-based chat session;
c) at least one third count of such users visiting such at least one monitored web site,
d) at least one hierarchical listing of such at least one monitored web page of such at least one monitored web site;
e) at least one universal resource locator address of least one monitoring web page of such at least one monitoring web site;
f) at least one universal resource locator address of such least one Internet-based chat session;
g) at least one universal resource locator address of such least one Internet-based chat session activated by such at least one user-manager; and
h) at least universal resource locator address of at least one archive web page containing text of at least one previous Internet-based chat session.

86) The computer-based display system according to claim 83 wherein such behavior rules comprises at least five members selected from the set comprising:
a) momentarily expanding such at least one visual version of such at least one window within such at least one visual overlay page;
b) permanently expanding such at least one visual version of such at least one window within such at least one visual overlay web page;
c) minimizing such at least one visual version of such at least one window within such at least one visual overlay web page;
d) placing such at least one visual version of such at least one window within such at least one visual overlay web page at a location within such at least one monitored web page;
e) modifying text content of such at least one visual version of such at least one window within such at least one visual overlay web page;
f) making such at least one visual version of such at least one window within such at least one visual overlay web page visible to such at least one user;
g) making such at least one visual version of such at least one window within such at least one visual overlay web page invisible to such at least one user;
h) producing a sound;
i) changing at least one image within such at least one visual version of such at least one window within such at least one visual overlay web page;
j) sending at least one message to such at least one user;
k) sending at least one email to such at least one user; and
l) sending at least one instant message to such at least one user.

87) The computer-based display system according to claim 83 wherein such at least one variable comprises at least one member selected from the set comprising:
a) elapsed time such at least one user has visited such at least one monitored web page;
b) elapsed time such at least one user has visited such at least one monitored web site;
c) count of previous visits to such at least one monitored web page by such at least one user;
d) count of previous visits to such at least one monitored web site by such at least one user;
e) count of such users visiting such at least one monitored web page;
f) count of such users visiting such at least one monitored web site;
g) count of such users participating in such at least one Internet-based chat session;
h) universal resource locator address last such at least one monitored web page visited by such at least one user;
i) current time and date;
j) recognition of such at least one user visiting such at least one monitored web page as anonymous;
k) recognition of such at least one user visiting such at least one monitored web page as not anonymous;
l) recognition that such at least one user-manager is visiting monitored such at least one monitored web page;
m) participation by such at least one user-manager in such at least one Internet-based chat session;
n) count of messages posted to such at least one monitored web site.

88) The computer-based display computer-based display system according to claim 83, wherein the step of permitting user manipulation of such at least one window within such at least one visual overlay page comprises the steps of:
a) permitting expansion of such at least one window within such at least one visual overlay web page by such at least one user;
b) permitting minimization of such at least one window within such at least one visual overlay web page by such at least one user; and
c) permitting placement of such at least one window within such at least one visual overlay web page at a location within such at least one monitored web page by such at least one user.

89) The computer-based display system according to claim 83 further comprising the steps of:
a) permitting such at least one user-manger to selectively apply such at least one behavior rule to such at least one window within such at least one visual overlay web page;
b) permitting storing such at least one behavior rule selection in such at least one data base on such on at least one monitoring web site server;
c) permitting such at least one user-manger to selectively apply such at least one content rule to such at least one window within such at least one visual overlay web page; and
d) permitting storing such at least one content rule selection in such at least one data base on such on at least one monitoring web site server.

90) A method, relating to assisting participation in Internet-based communication between at least two visitors to at least one monitored web page of at least one monitored web site, comprising the steps of:
a) operating at least one monitoring web site server adapted to permit Internet-based chat between such at least two visitors to such at least one monitored web page of such at least one monitored web site;
b) receiving payment from at least one operator of such at least one monitored web site by at least one monitoring web site operator;
c) embedding, in such at least one monitored web page, at least one universal resource locator reference to monitoring software operating on such at least one monitoring web site server by such at least one operator of such at least one monitored web site;
d) monitoring such at least one monitored web page for presence of such at least one visitor by such monitoring software;
e) overlaying at least one monitoring web page sent from such monitoring software on such on at least one monitoring web site server on top of such at least one monitored web page when the presence of at least one visitor is detected;
f) permitting Internet-based communication between such at least two visitors to such at least one monitored web page using at least one Internet-based communication tool operating on such at least one monitoring web site server; and
g) wherein such at least one Internet-based communication tool comprises Internet-based chat.

91) The method according to claim 90 wherein such at least one Internet-based communication tool comprises Internet-based messaging.

92) The method according to claim 90 wherein such at least one Internet-based communication tool comprises Email.

93) The method according to claim 90 wherein such at least one visitor comprises at least one user-manager of such at least one monitored web site.
